(19) United States
(12) Patent Application Publication
(10) Pub. No.: US 2026/0205284 A1
(43) Pub. Date: Jul. 16, 2026

(54) ESTATE PLANNING PLATFORM WITH VERSION CONTROL AND ZERO TRUST SECURITY

(71) Applicant: Nulia.US Corp., Cheyenne, WY (US)

(72) Inventors: Nir Haim Arad, Snoqualmie, WA (US); Oleksandr Terpelovskyy, Vinnytsia (UA); Oleksii Gudz, Vinnytsia (UA); Serhiy Savienko, Vinnytsia (UA)

(21) Appl. No.: 19/441,377

(22) Filed: Jan. 6, 2026

Related U.S. Application Data
(60) Provisional application No. 63/744,783, filed on Jan. 13, 2025.

(51) Int. Cl. H04L 9/08; G06Q 50/18; H04L 9/32; G06K 19/06

(52) U.S. Cl. CPC H04L 9/0877; G06Q 50/186; H04L 9/321; G06K 19/06037

(57) ABSTRACT

A system is directed to secure data storage that integrates version control with zero-trust principles. The system is designed to enhance the privacy and security of stored data, particularly when managed through a collaborative and distributed environment. The system architecture allows for the seamless integration of encryption protocols with version control functionalities, ensuring that while the collaborative features of version control systems (VCS) are preserved, the data remains inaccessible to unauthorized users, including the system administrators.

### CROSS-REFERENCE TO RELATED APPLICATION

This application claims the benefit of U.S. Provisional Patent Application No. 63/744,783, filed January 13, 2025, which is incorporated by reference herein in its entirety.

### TECHNICAL FIELD

This disclosure relates generally to secure estate planning platforms, data storage systems, and more particularly to methods and systems for secure data storage that integrate version control mechanisms with zero-trust security principles.

### BACKGROUND

Version control systems, such as Global Information Tracker (GIT), have been used to manage changes to documents, computer programs, websites, and other collections of information. These systems enable multiple users to work on a set of data simultaneously, tracking and merging changes and maintaining the history of every modification. While these systems can manage versions and facilitate collaborative work, they are not designed to provide security and/or privacy for the stored data.

### BRIEF DESCRIPTION OF FIGURES

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments shown, but are provided for explanation and understanding.

FIG. 1 illustrates a cloud service provider system hosting repositories for multiple users, configured in accordance with various embodiments of the present technology.

FIG. 2 is a flow diagram illustrating a method of data storage and access in a secure data storage system, in accordance with various embodiments of the present technology.

FIG. 3 is a flow diagram illustrating a method of data objects and encryption management, in accordance with various embodiments of the present technology.

FIG. 4 is a flow diagram illustrating a method of data sharing in a secure repository system, in accordance with various embodiments of the present technology.

FIG. 5 is a flow diagram illustrating a method of fine grain access control implementation, in accordance with various embodiments of the present technology.

FIG. 6 illustrates a user management system architecture for secure data storage, configured in accordance with various embodiments of the present technology.

FIG. 7 illustrates a use case diagram of a version control system with zero trust principles, configured in accordance with various embodiments of the present technology.

FIG. 8 is a flow diagram illustrating a method of account closure in a secure data storage system, in accordance with various embodiments of the present technology.

FIG. 9 is a flow diagram illustrating a method of user account state management for account access, in accordance with various embodiments of the present technology.

FIG. 10 is a flow diagram illustrating a method of adding a new device to a secure data storage system, in accordance with various embodiments of the present technology.

FIG. 11A is a flow diagram illustrating a method of device removal initiated from the removed device, in accordance with various embodiments of the present technology.

FIG. 11B is a flow diagram illustrating a method of device removal initiated from another registered device, in accordance with various embodiments of the present technology.

FIG. 12 is a flow diagram illustrating a method of creating a new repository in a secure data storage system, in accordance with various embodiments of the present technology.

FIG. 13 is a flow diagram illustrating a method of repository management including deletion and recovery operations, in accordance with various embodiments of the present technology.

FIG. 14 is a flow diagram illustrating a method of inviting a user to access a repository, in accordance with various embodiments of the present technology.

FIG. 15 is a flow diagram illustrating a method of removing a user from a repository, in accordance with various embodiments of the present technology.

FIG. 16 illustrates a system for managing access control with separate access control objects per document, configured in accordance with various embodiments of the present technology.

FIG. 17 is a flow diagram illustrating a method of device authentication in a secure data storage system, in accordance with various embodiments of the present technology.

FIG. 18 is a flow diagram illustrating a method of sharing and unsharing documents in a secure data storage system, in accordance with various embodiments of the present technology.

FIG. 19 illustrates a plan history snapshot system at a specific time point, configured in accordance with various embodiments of the present technology.

FIG. 20 illustrates a device hardware architecture overview for implementing the disclosed technology, configured in accordance with various embodiments of the present technology.

FIG. 21 illustrates a distributed system environment for secure data storage operations, configured in accordance with various embodiments of the present technology.

FIG. 22 illustrates a software component architecture for a secure data storage system, configured in accordance with various embodiments of the present technology.

FIG. 23 illustrates a user interface for a secure data storage system, configured in accordance with various embodiments of the present technology.

FIG. 24 illustrates a user interface for plan organization, configured in accordance with various embodiments of the present technology.

FIG. 25 illustrates a user interface for plan history tracking, configured in accordance with various embodiments of the present technology.

FIG. 26 illustrates a user interface for managing document sharing and trusted contact relationships, configured in accordance with various embodiments of the present technology.

FIG. 27 illustrates a user interface for displaying and managing recovery codes for account access restoration, configured in accordance with various embodiments of the present technology.

### DETAILED DESCRIPTION

Aspects of the present disclosure are directed to methods and systems for secure estate planning data storage that integrate version control with one or more zero-trust principles for managing access to sensitive financial and legal documents. At least some embodiments of the present disclosure relate to the field of estate planning data management and cybersecurity, specifically to systems and methods that integrate version control mechanisms with robust security measures based on one or more zero-trust principles to enhance privacy and integrity of estate planning documents, asset information, and beneficiary access controls.

In the realm of estate planning security, symmetric and asymmetric encryption protocols can play an important role in ensuring that wills, trust documents, asset inventories, and beneficiary information remain confidential and secure from unauthorized access. Symmetric encryption uses the same key for both encryption and decryption, offering speed and efficiency for large volumes of estate documents and financial records. Asymmetric encryption, also known as public key cryptography, uses a pair of keys (i.e., a public key and a private key) for encryption and decryption, facilitating secure sharing of estate information between executors, beneficiaries, and legal representatives over insecure channels. Zero-trust models can use these cryptographic protocols to verify each access request to estate planning data, even when the request originates from authorized family members or legal professionals.

Despite the advancements in version control systems and cryptographic protocols, there remains a gap in integrating these technologies to create an estate planning data storage system that offers both sophisticated version control capabilities for tracking changes to wills and trust documents and uncompromising security based on zero trust principles for protecting sensitive asset information. Conventional estate planning systems often leave the data accessible to administrators or third parties who manage the infrastructure, creating potential privacy and security vulnerabilities that could compromise the confidentiality of family financial information and inheritance plans. Furthermore, while version control systems, such as Global Information Tracker (GIT), provide a framework for tracking changes and managing collaboration among estate planning professionals, they may not inherently provide mechanisms for encrypting estate documents or ensuring that the data storage and retrieval processes adhere to zero trust principles when managing access to sensitive asset information and beneficiary details. For example, in an estate planning system adhering to true zero-trust principles, trust is never assumed, and verification is required from everyone accessing the system, including executors, beneficiaries, and legal representatives, regardless of their position or role in the estate administration process.

At least some embodiments of the systems and methods described herein address at least some of these problems by providing an estate planning data storage process that combines one or more benefits of version control systems with the stringent security measures afforded by modern encryption protocols, all within a framework that adheres to zero trust principles for managing access to wills, trusts, asset inventories, and beneficiary information. The estate planning data storage process can ensure that estate owners, executors, and beneficiaries securely manage, store, and/or retrieve sensitive financial and legal documents while maintaining complete privacy from administrators and other potential insiders, thereby significantly enhancing the security and integrity of the stored estate planning information and protecting family assets from unauthorized access.

The system is designed to enhance the privacy and security of stored estate planning data, including when estate documents and asset information are managed through a collaborative environment involving multiple family members, legal professionals, and financial advisors. The system can have an architecture for the seamless integration of encryption protocols with version control functionalities for estate planning documents, ensuring that while the collaborative features of version control systems (VCS) are preserved for managing wills, trusts, and asset distributions, the sensitive estate data remains inaccessible to unauthorized users, including the system administrators who cannot view confidential family financial information or inheritance plans.

In some embodiments, the system can store comprehensive estate planning data in secure digital repositories. An estate owner can update the estate planning data using version control and select authorized individuals including executors, beneficiaries, trustees, and legal representatives who can access specific estate documents and asset information before and/or after a trigger event (e.g., the owner's death, incapacitation, or other life events). The estate planning data can include, without limitation, login credentials for digital accounts (e.g., social media accounts, online banking, investment platforms), financial account information (bank accounts, retirement accounts, investment portfolios), estate planning documents (e.g., wills, trust agreements, codicils, estate plans), insurance policies and beneficiary designations, real estate titles and property deeds, power of attorney documents, advance healthcare directives, living wills, comprehensive asset inventories, end-of-life instructions, digital asset management instructions, durable financial power of attorney documents, charitable giving instructions, and business succession plans.

The estate owner can configure granular authorization levels, specify which estate data is accessible to different groups of authorized individuals, define trigger events for automatic access activation, establish automated notification protocols for beneficiaries and executors, and set privacy controls for sensitive family financial information. For example, an estate owner can authorize designated beneficiaries to access relevant inheritance documents, grant executors full access to asset inventories and legal documents, provide trustees with access to trust-related information, and enable attorneys to access necessary legal documentation for probate proceedings.

The estate owner can organize authorized individuals into specific groups such as immediate family members, extended family, legal professionals, financial advisors, and charitable organizations, with each group having access to estate data relevant to their respective roles in estate administration. Authorized individuals (e.g., spouses, children, beneficiaries, executors, trustees, attorneys, financial advisors, and healthcare providers) can access designated estate data to manage healthcare decisions, facilitate asset distribution, administer trusts, manage or close financial accounts (e.g., social media accounts, bank accounts, retirement accounts, investment accounts), execute charitable bequests, handle business succession, or fulfill other estate administration responsibilities. The estate planning data can be encrypted using advanced cryptographic protocols and stored in secure zero-trust digital repositories that prevent unauthorized access while enabling controlled sharing among authorized parties.

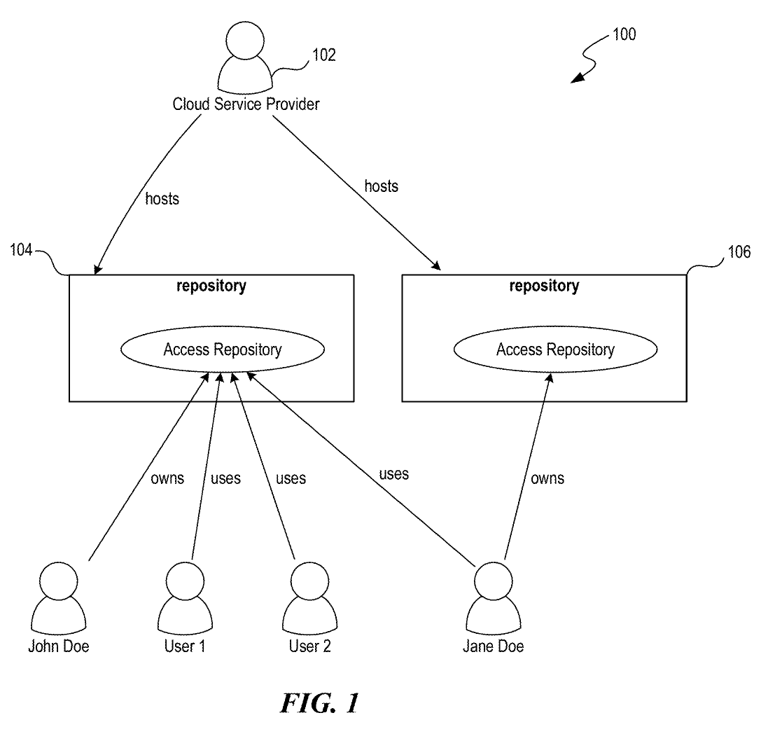

Referring to FIG. 1, a system 100 illustrates a cloud service provider 102 hosting repositories for multiple users. As shown, the system 100 includes a cloud service provider 102, a repository 104, and a repository 106. The system 100 can further include multiple users with different access roles and permissions for accessing the repositories hosted by the cloud service provider 102.

The cloud service provider 102 functions as a hosting infrastructure that manages and maintains repositories for multiple users while implementing zero-trust security principles. The cloud service provider 102 can host multiple repositories including repository 104 and repository 106, providing the underlying infrastructure and connectivity for users to access their data. The cloud service provider 102 can maintain the system infrastructure and provide repository hosting services, however, the cloud service provider 102 operates under zero-trust constraints that prevent access to the actual content of encrypted data objects stored within the repositories.

Repository 104 can be configured as a version-controlled data storage container that organizes encrypted data objects for collaborative access by authorized users (e.g., trusted contact). The repository 104 can include an access repository component that manages user permissions and access controls for the data stored within repository 104. Repository 104 can be owned by a user designated as "John Doe" who has ownership privileges and can control access permissions for other users. The repository 104 can also provide access to additional users including "User 1" and "User 2" who can have different permission levels such as editing or viewing rights depending on the access controls established by the owner.

Repository 106 can be configured similarly to repository 104 as a version-controlled data storage container with its own access control mechanisms. The repository 106 can include an access repository component that manages permissions for users authorized to access the data within repository 106. Repository 106 can be owned by a user designated as "Jane Doe" who has ownership privileges over repository 106. The system 100 can support cross-repository access where users can have access to multiple repositories, as demonstrated by Jane Doe having access to both repository 104 and repository 106 with different permission levels.

The system 100 implements zero-trust principles where the cloud service provider 102 cannot view the content of encrypted objects stored within repository 104 and repository 106. The cloud service provider 102 can have access to limited metadata about the repositories, such as the identity of repository owners, users who have access to each repository, subscription information and payment methods, however, the cloud service provider 102 cannot access the actual encrypted content of data objects. The system 100 can prevent the cloud service provider 102 from adding new objects directly to the commit tree of either repository 104 or repository 106, ensuring that only authorized users can modify repository content. This zero-trust approach ensures that even administrators who manage the infrastructure cannot compromise the privacy and security of the stored data, addressing fundamental security vulnerabilities present in many cloud-based version control systems.

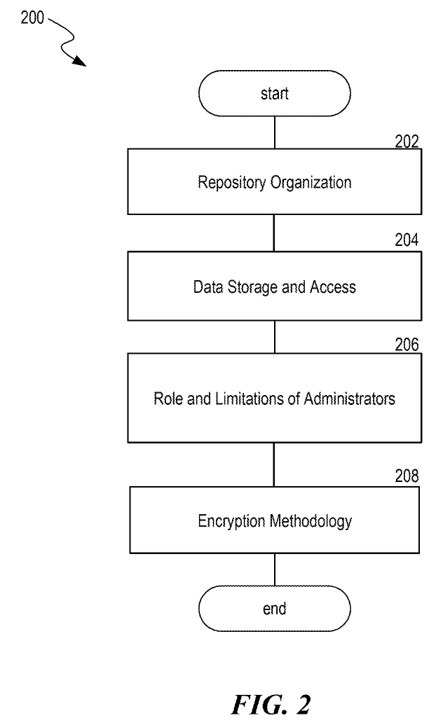

The system 100 may be utilized for estate planning applications where sensitive financial and legal documents require both collaborative access and stringent security measures. In estate planning contexts, the cloud service provider 102 can host repositories containing owner-managed digital binders, inheritance plans, encrypted documents (e.g., estate documents, wills, trust documents, life insurance documents), asset inventories, asset information, protocols (e.g., post-mortem autonomously executed protocols), linked accounts, password managers for accounts (e.g., banking accounts, social media accounts, retirement accounts, etc.), sharing rules, and/or beneficiary information, while the zero-trust architecture ensures that even system administrators cannot access confidential data. The repository 104 may store, for example, estate documents for one family, with the estate owner maintaining ownership privileges and granting specific access permissions to executors, beneficiaries, and/or legal representatives based on their roles in estate administration. Similarly, repository 106 may contain estate planning materials for another family, with cross-repository access capabilities enabling shared legal professionals or financial advisors to access multiple estate plans while maintaining appropriate permission boundaries. The version control capabilities of the system 100 can track changes to estate documents over time, providing audit trails for modifications to wills or trust agreements, while the encrypted storage ensures that sensitive asset information and beneficiary details remain protected from unauthorized access throughout the collaborative estate planning process using one or more steps or methods discussed in connection with FIGS. 2-19. The system 100 may be used for post-mortem estate distribution and other applications (e.g., investment planning, file sharing of legal documents, etc.).

Referring to FIG. 2, a flowchart illustrates a method 200 used for data storage and access in a secure data storage system. For example, the method 200 can be for organizing repositories, managing encrypted data storage, and implementing zero-trust access controls. The method 200 is illustrated as a series of blocks or steps including step 202, step 204, step 206, and step 208. All or a subset of one or more of steps of the method 200 can be executed by various components or devices of the system 100 of FIG. 1, such as the cloud service provider 102, repository 104, and repository 106. Furthermore, all or a subset of any one or more of steps of the method 200 can be executed in accordance with the discussion above and with the discussion below.

The method 200 begins at step 202 by organizing content within repositories. At step 202, the system can organize repositories as individual collections of versioned data that can include text files, binary files, and directories. Users can create repositories and manage them locally on their user devices, or users can establish repositories on remote servers for collaborative access. The repository organization at step 202 can enable authorized users to clone, modify, and update repositories while maintaining version control and tracking changes to the stored data. Step 202 can facilitate the hierarchical organization of data objects within repositories using tree structures that link to encrypted content through access control mechanisms.

At step 204, the method 200 continues by determining data storage and access configurations. Step 204 can implement a dual-state approach where data stored on remote servers is encrypted to secure sensitive private data against unauthorized access, while local versions of the same files or objects remain decrypted for user convenience and usability. The data storage and access determination at step 204 can enable users to work with their data seamlessly on local devices while maintaining a high level of security for data stored remotely. Step 204 can manage the encryption and decryption processes that occur when data is transferred between local and remote storage locations, ensuring that sensitive information remains protected during transmission and storage. Example encryption and decryption processes are disclosed in U.S. Provisional Application No. 63/779,826, which is incorporated by reference in its entirety.

At step 206, the method 200 continues by establishing the role and limitations of system administrators. Step 206 can restrict system administrators to maintaining the infrastructure of the data storage system while preventing access to encrypted data content according to zero-trust principles. Administrators can have access to a limited set of information about repositories at step 206, including the identity of repository creators and owners, users who have access to repositories, subscription, and/or payment information. The role and limitation determination at step 206 can prevent administrators from adding new objects directly to commit trees, ensuring that data privacy and security are preserved and the user content is protected even from those who manage the system infrastructure.

At step 208, the method 200 continues by implementing encryption methodology for data objects within repositories. Step 208 can apply encryption strategies that emphasize confidentiality and security of data while enabling controlled access within a version control framework. The encryption methodology at step 208 can be applied to various object types in repositories, including blobs, trees, commits, and tags, where each type of object can be encrypted with distinct symmetric encryption keys. The system can determine whether to encrypt objects with respective individual keys or with multi-object keys that encrypt multiple types of objects together. The encryption methodology implementation at step 208 can ensure that each data object receives appropriate cryptographic protection based on its type and access requirements while maintaining the ability to manage and retrieve encrypted content through the version control system.

Although steps of the method 200 are discussed and illustrated in a particular order, the method 200 of FIG. 2 is not so limited. In other embodiments, all or a subset of one or more of steps of the method 200 can be performed in a different order. In these and other embodiments, all or a subset of any of steps of the method 200 can be performed before, during, and after all or a subset of any of the other steps of the method 200. Furthermore, a person skilled in the art will readily recognize that the method 200 can be altered and still remain within these and other embodiments of the present technology. For example, all or a subset of one or more steps of the method 200 can be omitted and repeated in some embodiments.

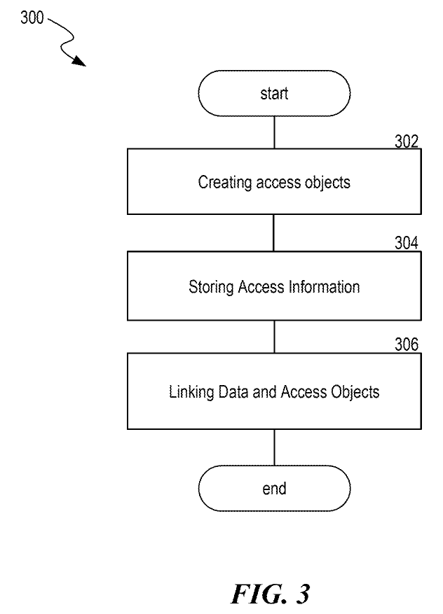

Referring to FIG. 3, a flow diagram illustrates a method 300 used for data objects and encryption in a secure data storage system. For example, method 300 can be for creating access control objects, storing encrypted access information, and linking data objects through hash pointers to enable fine-grain access control. The method 300 is illustrated as a series of blocks or steps including a step 302, a step 304, and a step 306. All or a subset of one or more of steps of the method 300 can be executed by various components or devices of the system 100 of FIG. 1, such as the cloud service provider 102, repository 104, and repository 106. Furthermore, all or a subset of any one or more of steps of the method 300 can be executed in accordance with the discussion above and with the discussion below.

The method 300 begins at step 302 by creating access control objects for encrypted data objects. At step 302, the system can store information in data objects that include blobs and tree objects, where blobs can be simple text files, binary files, or any other type of data that can be stored digitally, and tree objects can organize repositories hierarchically by including lists of other blobs and trees. The system can encrypt each data object using symmetric encryption with a unique encryption key to protect the confidentiality of the stored information. The access control object creation can generate a dedicated access control object for every blob and tree within the system, where each access control object serves as a secure container for storing the encryption key of its associated data object. The system can ensure that each data object receives its own unique encryption key, thus guaranteeing that a user that holds the key for a data object that was shared with them, and the user is unable to decrypt another data object which was not shared with them.

At step 304, the method 300 continues by storing access information within the access control objects. The system can configure each access control object to contain the symmetric encryption key for a specific blob or tree object, however, the symmetric key is not stored in plain form within the access control object. The access information storage can encrypt the symmetric key using asymmetric encryption with the public keys of each user who is authorized to access the data object. Step 304 can ensure that only authorized users with their corresponding private keys can decrypt and use the symmetric key to unlock the associated data object. The access information storage at step 304 can enable multiple users to access the same data object by encrypting the symmetric key with each authorized user's public key, allowing each user to independently decrypt the symmetric key using their private key.

At step 306, the method 300 continues by linking data objects and access control objects through hash pointers. Step 306 can place references or hash pointers to relevant access control objects within tree objects rather than embedding encryption keys directly within the tree objects themselves. The linking at step 306 can configure hash pointers to function as secure signposts that direct authorized users to the location where they can retrieve the access control object and obtain the encryption key needed to access the desired data object. Step 306 can enable users to navigate through the directory structure by following hash pointers from tree objects to access control objects, where users can decrypt the symmetric keys stored within access control objects using their private keys. The data and access object linking at step 306 can facilitate the hierarchical organization of encrypted data while maintaining fine-grain access control over individual data objects within the repository structure. In some embodiments, a system can include multiple parallel databases (e.g., two parallel databases), including one database for data objects and one database for access control objects, and the user may access both databases using the same hash pointer in parallel, to accelerate data fetching.

Although steps of the method 300 are discussed and illustrated in a particular order, the method 300 of FIG. 3 is not so limited. In other embodiments, all or a subset of one or more of steps of the method 300 can be performed in a different order. In these and other embodiments, all or a subset of any of steps of the method 300 can be performed before, during, and after all or a subset of any of the other steps of the method 300. Furthermore, a person skilled in the art will readily recognize that the method 300 can be altered and still remain within these and other embodiments of the present technology. For example, all or a subset of one or more steps of the method 300 can be omitted and repeated in some embodiments.

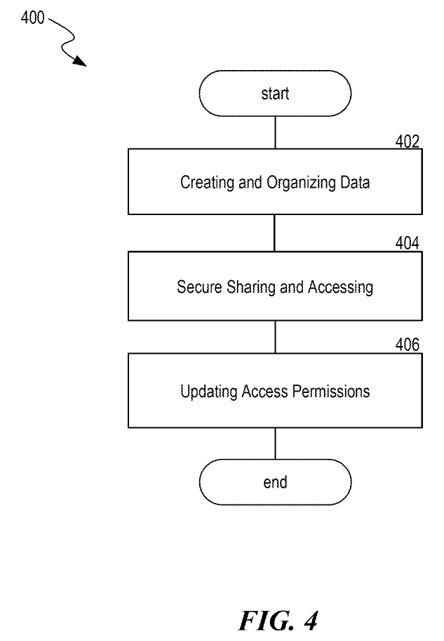

Referring to FIG. 4, a flow diagram illustrates a method 400 used for a data sharing system with fine-grain access control. For example, the method 400 can be for creating and organizing encrypted data objects, performing secure sharing and accessing through hash pointer navigation, and dynamically updating access permissions for collaborative environments. The method 400 is illustrated as a series of blocks or steps including a step 402, a step 404, and a step 406. All or a subset of one or more of steps of the method 400 can be executed by various components or devices of the system 100 of FIG. 1, such as the cloud service provider 102, repository 104, and repository 106. Furthermore, all or a subset of any one or more of steps of the method 400 can be executed in accordance with the discussion above and with the discussion below.

The method 400 begins at step 402 by creating and organizing data within the secure data storage system. At step 402, when a user adds a new data object to the system, the data object is encrypted with a unique symmetric key to ensure confidentiality and security. The creating and organizing at step 402 can generate an access control object for each encrypted data object, where the access control object contains the symmetric key encrypted with the public keys of authorized users. The system can organize data objects within repositories using hierarchical structures that facilitate collaborative access while maintaining encryption security. The data creation and organization at step 402 can assign unique encryption keys to each data object, ensuring that compromising one key does not affect the security of other data objects within the system.

At step 404, the method 400 continues by performing secure sharing and accessing of encrypted data objects. Step 404 can enable users to access encrypted files or directories by navigating the directory structure through tree objects and following hash pointers to access control objects. The secure sharing and accessing at step 404 can allow users to obtain respective access control objects at one, some, or all steps of the navigation process, where users can use their private keys to decrypt the symmetric keys stored within the access control objects. The system can use the decrypted symmetric keys to decrypt and access subsequent tree objects in the path, enabling users to navigate all the way to the original blob objects containing the desired data. The secure sharing and accessing at step 404 can support real-time collaboration where multiple users can work on documents simultaneously while maintaining encrypted security, with each change tracked as a new version accessible to authorized users through the version control system.

At step 406, the method 400 continues by updating access permissions dynamically within the access control objects. The system can modify access permissions when changes are needed, such as granting additional users access to data objects or revoking access from existing users. The access permission updating at step 406 can update access control objects by adding or removing encrypted versions of symmetric keys based on the new set of authorized users' public keys. Step 406 can provide dynamic and granular control over data access without requiring re-encryption of the data objects themselves, enabling flexible permission management for collaborative environments. The access permission updating at step 406 can maintain version control integrity while allowing real-time collaboration, where multiple users can simultaneously work on documents with tracked changes and version history accessible to authorized users based on their current permission levels.

Although steps of the method 400 are discussed and illustrated in a particular order, the method 400 of FIG. 4 is not so limited. In other embodiments, all or a subset of one or more of steps of the method 400 can be performed in a different order. In these and other embodiments, all or a subset of any of steps of the method 400 can be performed before, during, and after all or a subset of any of the other steps of the method 400. Furthermore, a person skilled in the art will readily recognize that the method 400 can be altered and still remain within these and other embodiments of the present technology. For example, all or a subset of one or more steps of the method 400 can be omitted and repeated in some embodiments.

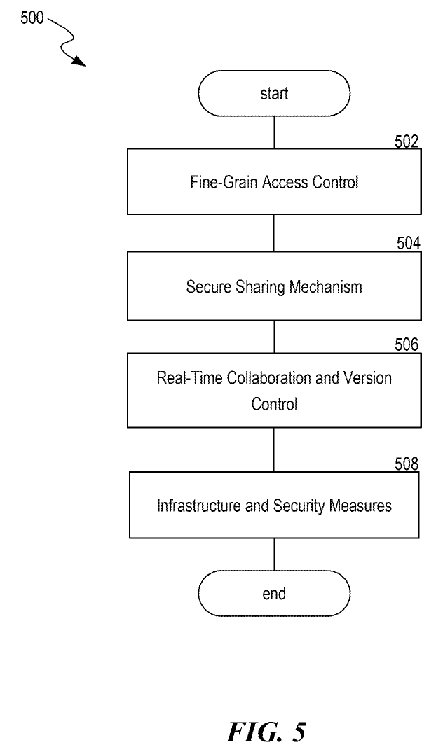

Referring to FIG. 5, a flow diagram illustrates a method 500 used for fine grain access control in a secure data storage system. For example, the method 500 can be for implementing granular access control in legal document-sharing platforms where attorneys, law firms, courts, clients, and authorized personnel require precise control over sensitive legal documents. The method 500 is illustrated as a series of blocks or steps including a step 502, a step 504, a step 506, and a step 508. All or a subset of one or more of steps of the method 500 can be executed by various components or devices of the system 100 of FIG. 1, such as the cloud service provider 102, repository 104, and repository 106. Furthermore, all or a subset of any one or more of steps of the method 500 can be executed in accordance with the discussion above and with the discussion below.

The method 500 begins at step 502 by implementing fine-grain access control for legal documents and sensitive data. At step 502, the system can establish granular control over who can access specific documents within legal document-sharing platforms, enabling document owners to precisely define access rights for each user or user group. The fine-grain access control implementation can allow a lead attorney to have full access to all documents within a case repository, while a junior attorney or paralegal can access only specific documents relevant to their tasks. The system can generate associated access control objects upon encryption of legal documents, where each access control object stores the encrypted symmetric key and specifies access permissions for the document. The fine-grain access control can enable precise management of access rights for different categories of legal professionals, including attorneys, paralegals, clients, and court personnel, where each category can have different permission levels based on their role and involvement in legal cases.

At step 504, the method 500 continues by using secure sharing mechanisms for legal document distribution. Step 504 can enable document owners or authorized users to specify intended recipients within the legal platform interface when sharing sensitive legal documents. The secure sharing mechanism at step 504 can update corresponding access control objects to include the public keys of recipients, encrypting the document's symmetric key with each recipient's public key to ensure that only authorized recipients can decrypt and access the documents using their private keys. The system can facilitate secure distribution of legal documents such as contracts, wills, case files, and court documents among authorized legal professionals while maintaining confidentiality and compliance with legal standards. The secure sharing at step 504 can support complex legal workflows where different documents within a case can be shared with different combinations of legal professionals, clients, and court personnel based on their specific roles and clearance levels.

At step 506, the method 500 continues by performing real-time collaboration and version control for legal document management. Step 506 can allow multiple legal professionals to work on documents simultaneously while maintaining the integrity and traceability of legal documents over time. The real-time collaboration and version control at step 506 can track each change to a legal document as a new version, with the version history accessible to authorized users based on their permission levels. The system can facilitate collaborative legal work where attorneys, paralegals, and other authorized personnel can simultaneously edit and review legal documents while maintaining a complete audit trail of all modifications. The real-time collaboration at step 506 can ensure that all changes to legal documents are properly tracked and attributed to specific users, providing the documentation and accountability required for legal proceedings and regulatory compliance.

At step 508, the method 500 continues by supporting infrastructure and security measures for legal document platforms. Step 508 can host the legal document-sharing platform on scalable cloud infrastructure designed to support high levels of data security and user activity required for legal practices. The infrastructure and security support at step 508 can implement advanced encryption protocols that protect legal documents at rest and in transit, ensuring compliance with legal and regulatory standards for data protection and privacy. The system can conduct regular security audits and compliance checks to ensure adherence to legal industry standards and regulatory requirements for handling sensitive legal information. The infrastructure and security measures at step 508 can provide the robust foundation needed for legal document-sharing platforms, where the security and integrity of legal documents can be maintained while enabling efficient collaboration among legal professionals and authorized parties involved in legal proceedings.

Although steps of the method 500 are discussed and illustrated in a particular order, the method 500 of FIG. 5 is not so limited. In other embodiments, all or a subset of one or more of steps of the method 500 can be performed in a different order. In these and other embodiments, all or a subset of any of steps of the method 500 can be performed before, during, and after all or a subset of any of the other steps of the method 500. Furthermore, a person skilled in the art will readily recognize that the method 500 can be altered and still remain within these and other embodiments of the present technology. For example, all or a subset of one or more steps of the method 500 can be omitted and repeated in some embodiments.

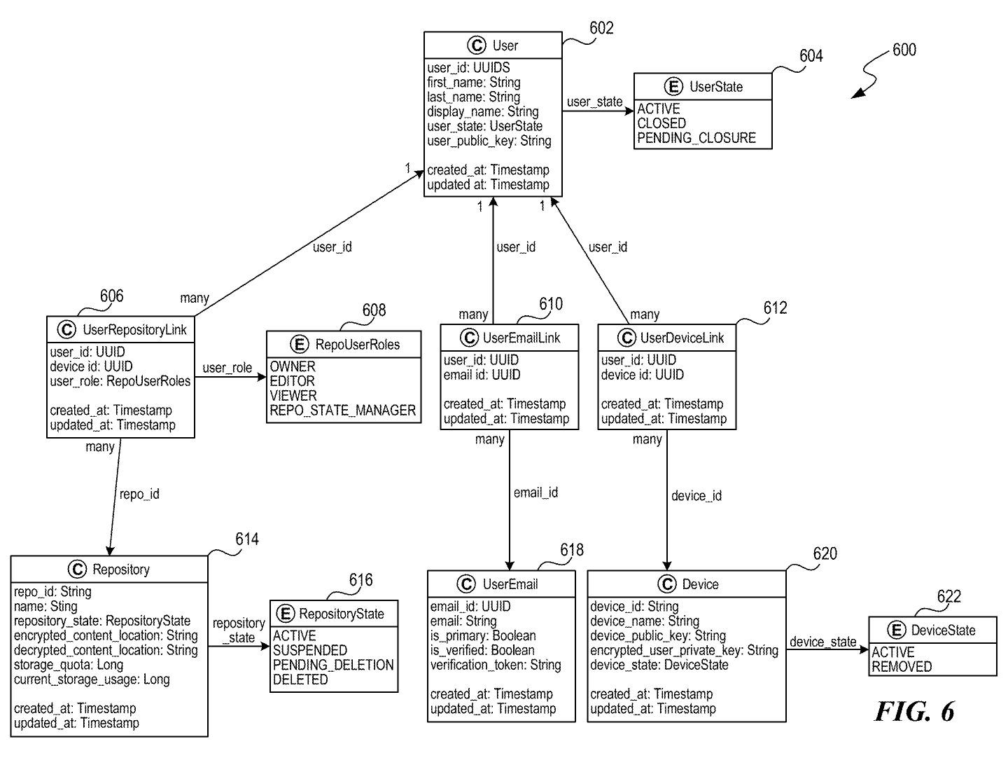

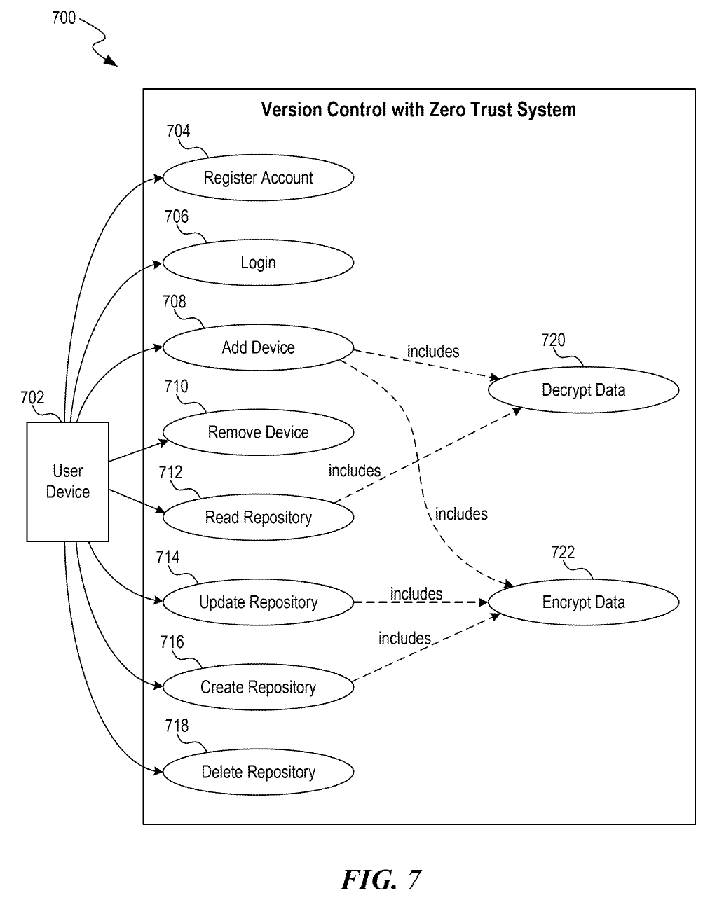

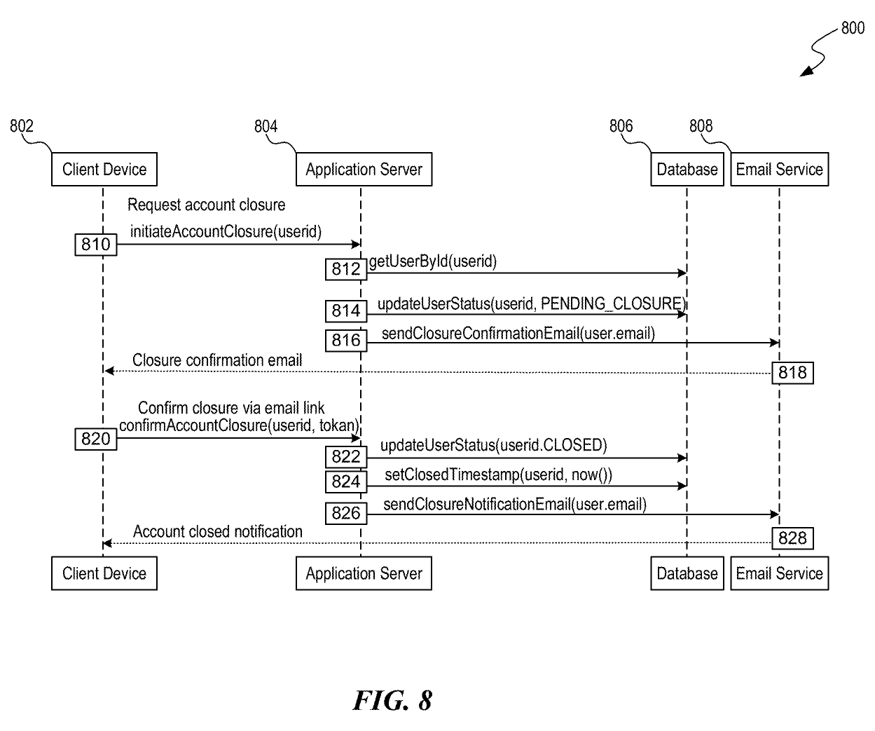

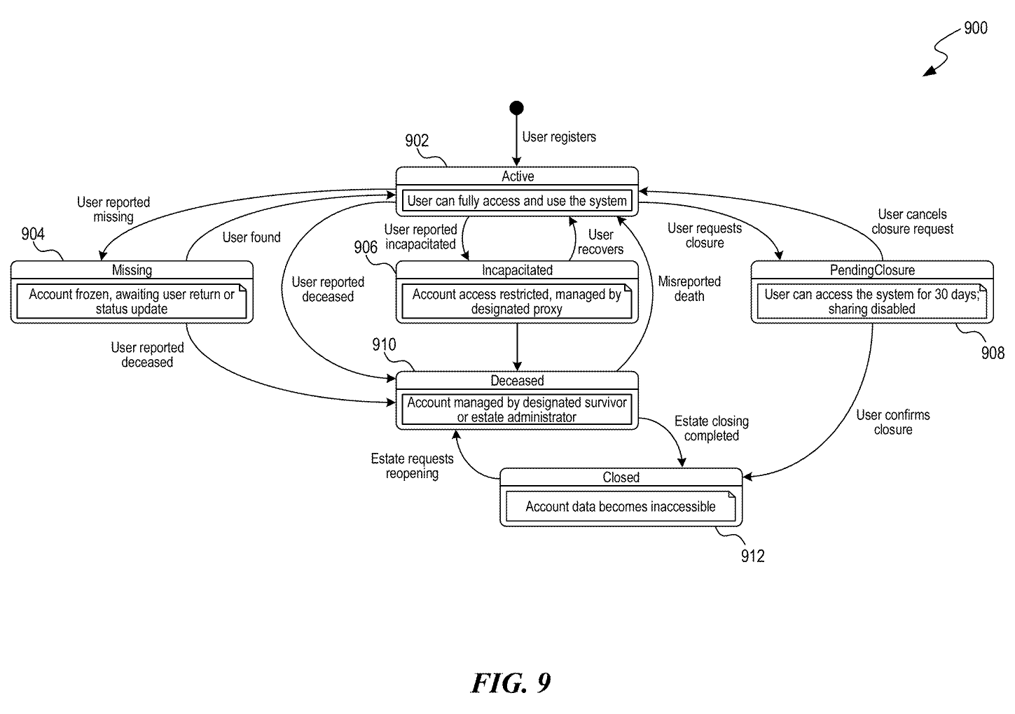

The techniques illustrated in FIGS. 6-19 may provide comprehensive estate planning and execution capabilities through integrated user management, device authorization, and secure document sharing workflows. The user management system 600 of FIG. 6 can enable estate owners to establish trusted relationships with beneficiaries, executors, and legal representatives while maintaining granular control over access permissions for wills, trust documents, and asset inventories. The zero-trust version control system 700 of FIG. 7 can facilitate secure estate document creation and modification workflows, where estate owners can update their plans over time while maintaining encrypted protection of sensitive financial information and beneficiary details. The account closure and state management processes of FIGS. 8-9 may automatically transition estate accounts through appropriate lifecycle states upon death or incapacitation, enabling designated survivors to access necessary documents for probate proceedings while maintaining security protocols. Upon an owner’s death, users (e.g., executors, legal representatives) can utilize the user management system 600 to manage post-mortem estate distribution by one or more users. The management system 600 can be linked to accounts to assist with managing assets, settling debts/taxes, distributing property, and facilitating comprehensive estate administration processes. The user management system 600 can automatically transition user accounts from an active state to deceased state upon verification of death, enabling designated executors and beneficiaries to access necessary estate planning documents, asset inventories, and/or beneficiary information stored within secure repositories. The system 600 can implement automated notification protocols that alert executors, trustees, and beneficiaries of their roles and responsibilities while providing controlled access to wills, trust documents, financial account information, and digital asset management instructions. The user management system 600 can coordinate with legal databases and government systems to ensure compliance with probate requirements, creditor notification periods, and statutory distribution timelines. The system 600 can manage the secure transfer of cryptographic access rights from the deceased owner to authorized estate administrators, enabling them to access encrypted data objects containing insurance policies, real estate titles, power of attorney documents, and comprehensive asset lists necessary for estate settlement. The user management system 600 can track estate administration progress through visual indicators, maintain audit trails of all post-death activities, and provide real-time updates to beneficiaries regarding asset distribution status and completion of legal requirements.

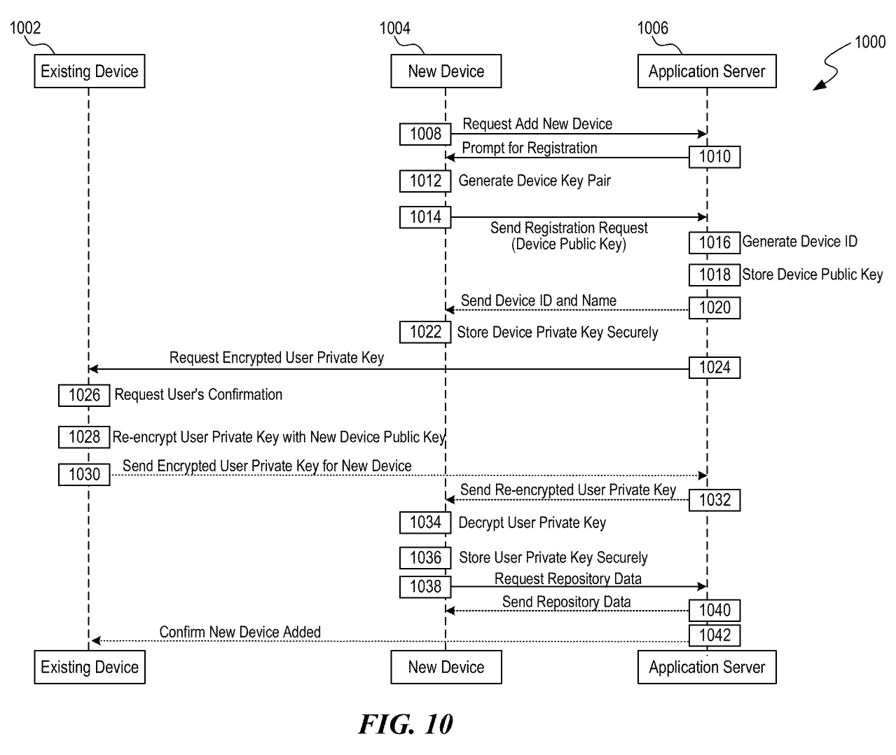

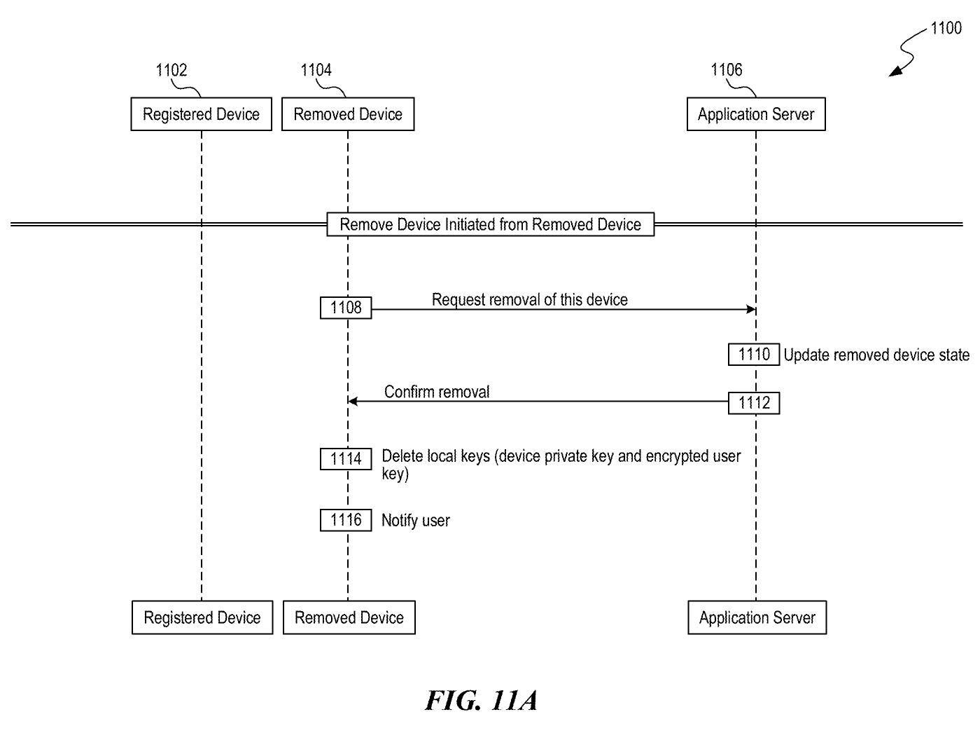

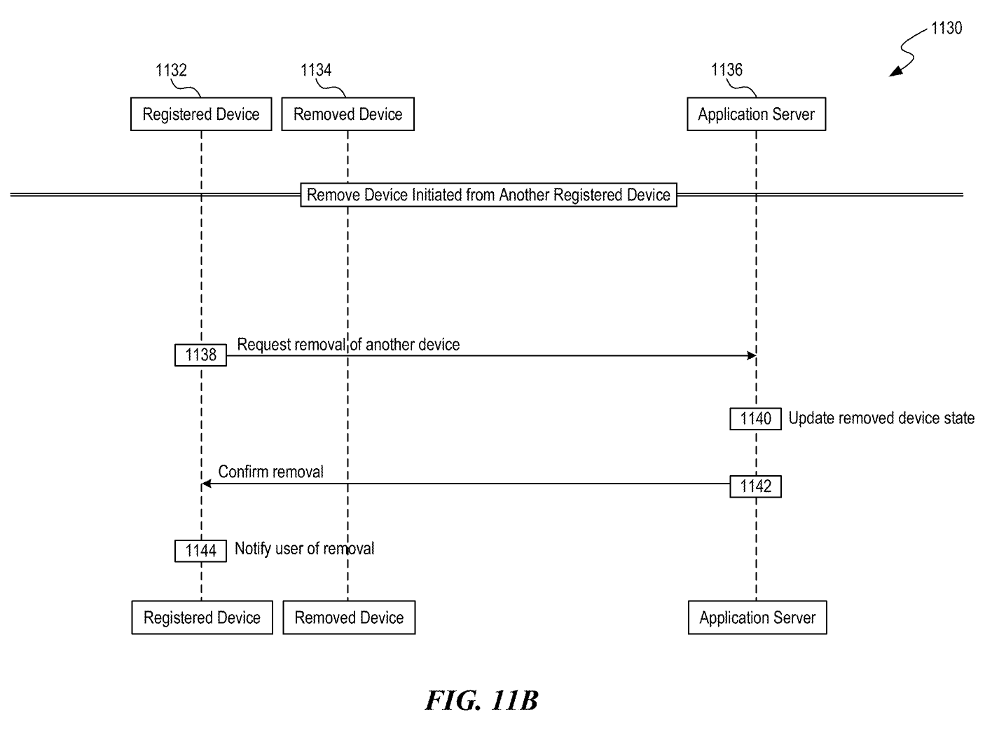

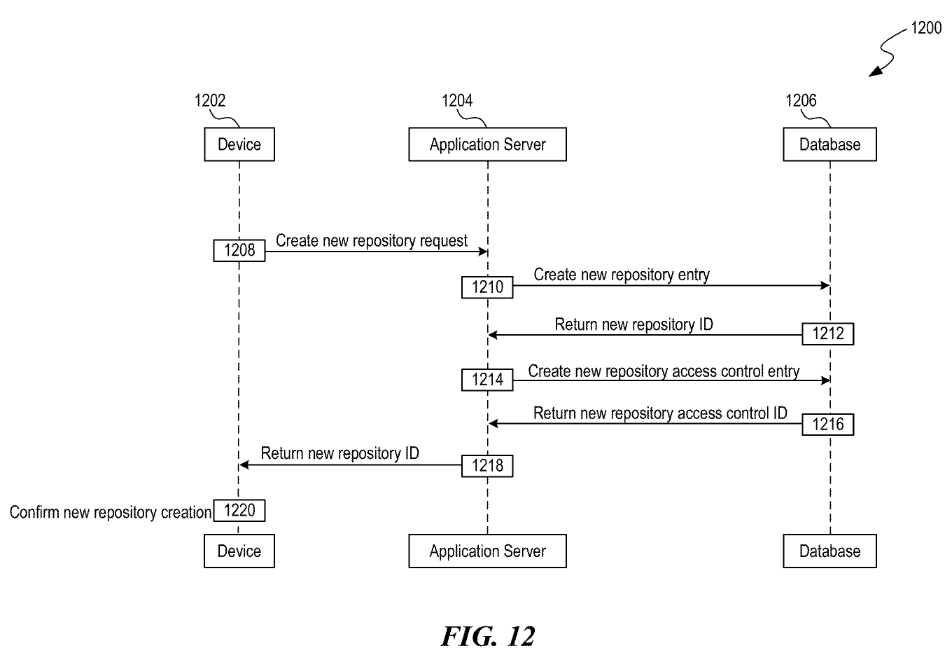

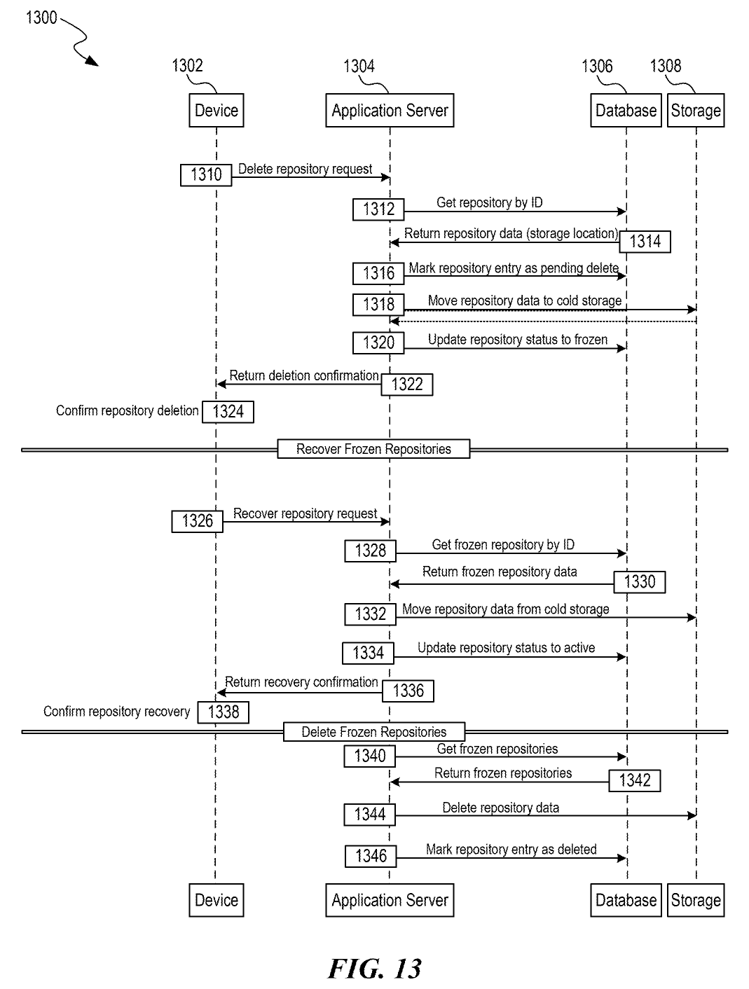

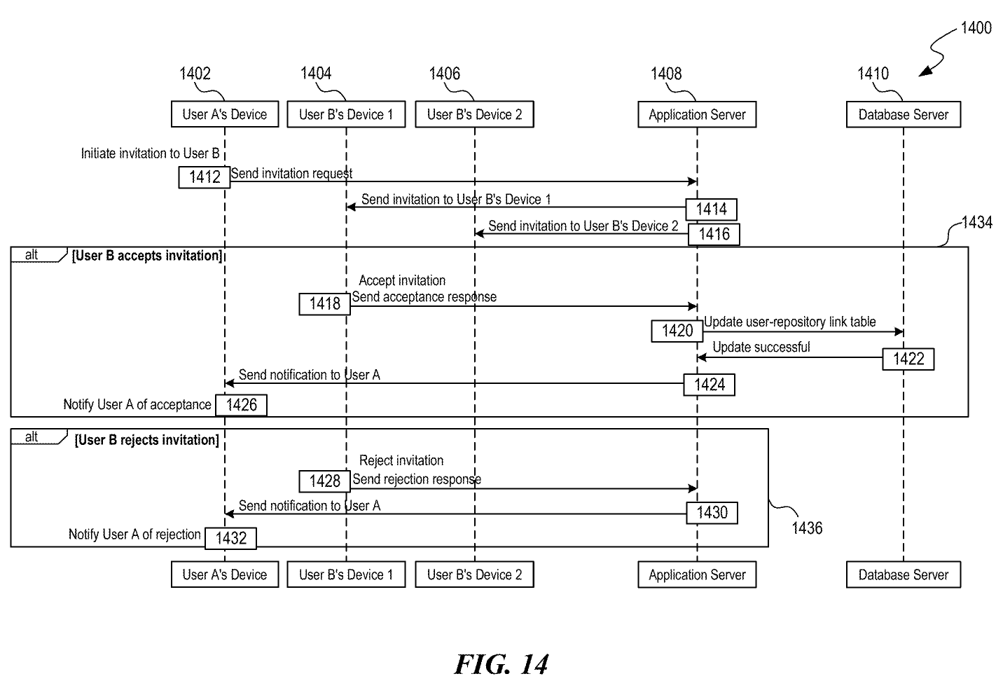

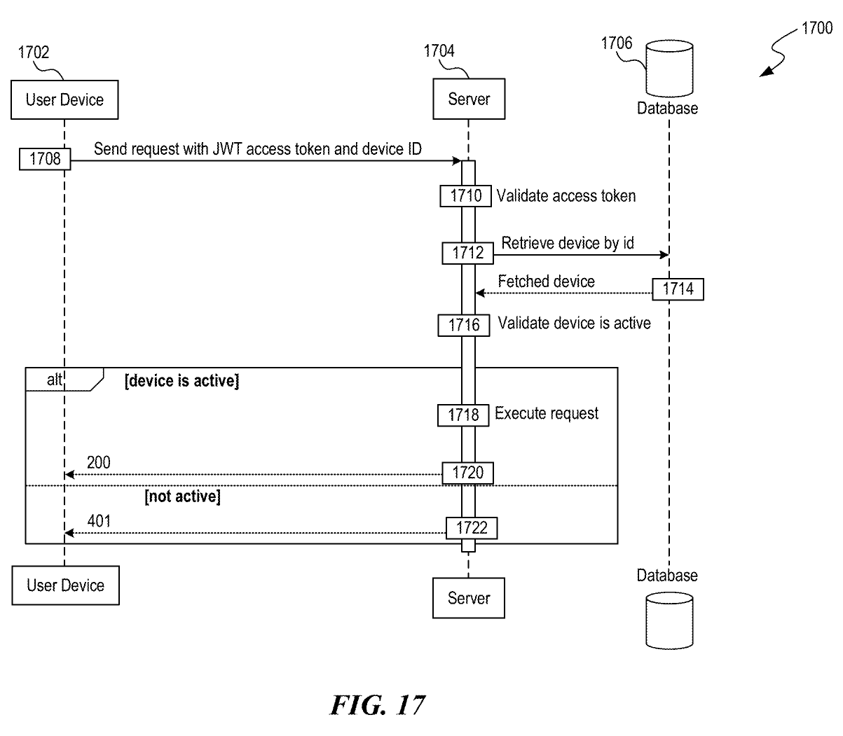

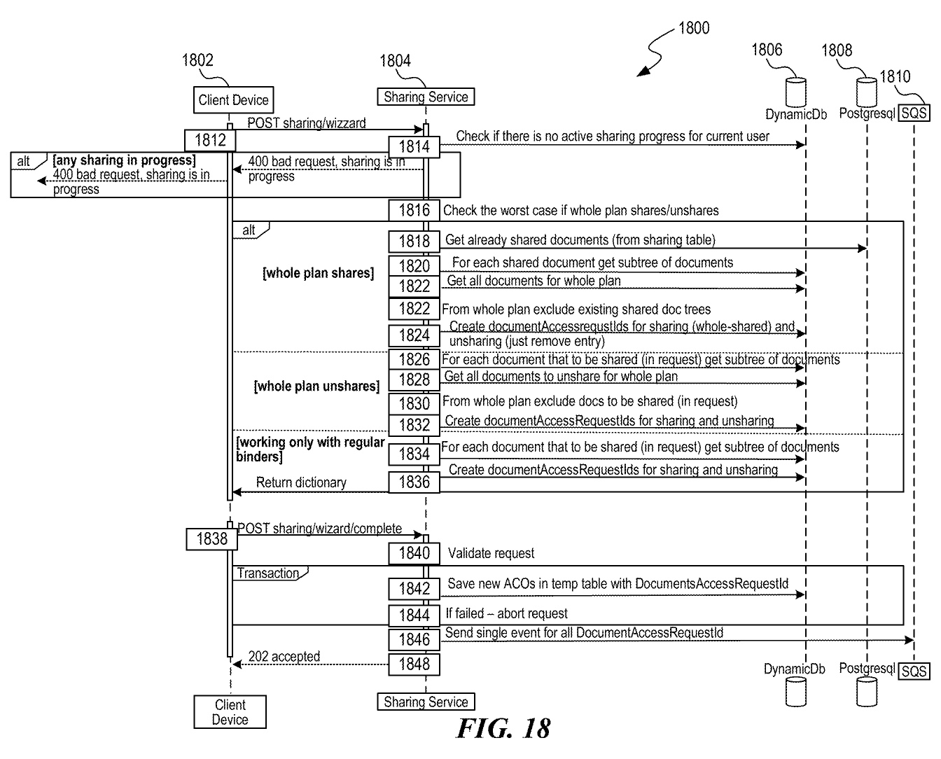

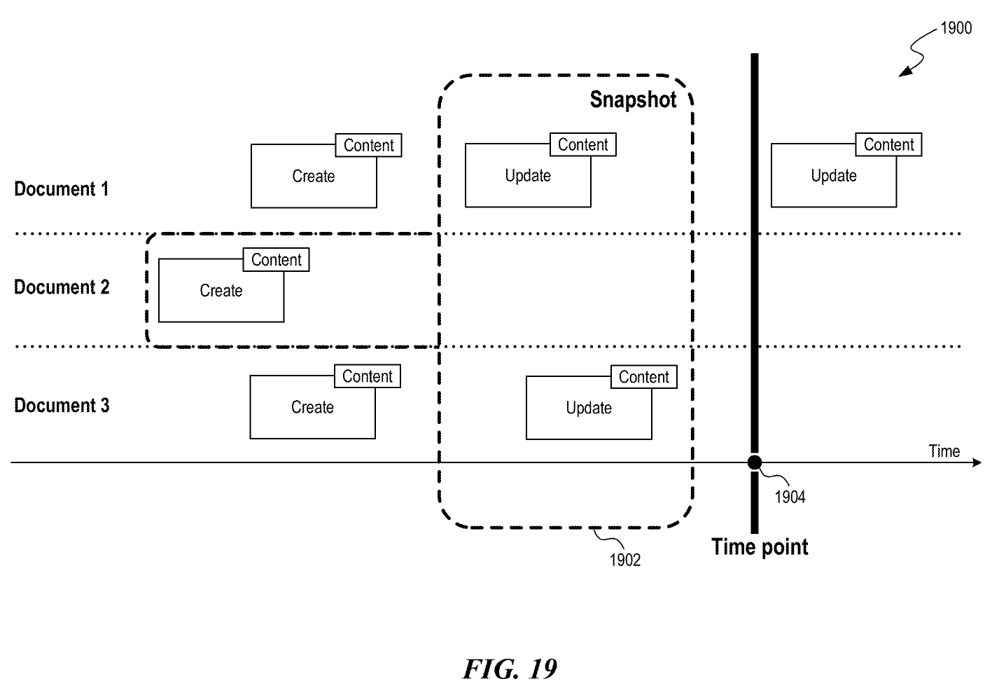

The device management workflows of FIGS. 10-11 can allow estate owners to authorize multiple devices for accessing estate plans and can enable executors to add new devices for estate administration purposes while maintaining cryptographic security throughout the authorization process. The repository management capabilities of FIGS. 12-13 may enable estate owners to create dedicated repositories for different aspects of their estate plans, such as separate repositories for financial assets, real estate holdings, and charitable bequests, with cold storage preservation ensuring that deleted estate documents can be recovered if needed during probate proceedings. The user invitation and sharing mechanisms of FIGS. 14-16 can facilitate controlled sharing of estate information with beneficiaries, trustees, and legal professionals based on their specific roles and authorization levels, while the device authentication and document sharing workflows of FIGS. 17-18 may ensure that only properly authenticated parties can access sensitive estate planning materials. The plan history snapshot system of FIG. 19 can maintain comprehensive audit trails of estate plan modifications, enabling probate courts and beneficiaries to review the evolution of estate documents and verify that final distributions reflect the estate owner's most recent intentions.

Referring to FIG. 6, a user management system 600 illustrates a comprehensive architecture for managing users, repositories, devices, and access controls within the secure data storage system. As shown, the user management system 600 includes a user component 602, a user state enumeration 604, a user repository link component 606, a repository user roles enumeration 608, a user email link component 610, a user device link component 612, a repository component 614, a repository state enumeration 616, a user email component 618, a device component 620, and a device state enumeration 622. The user management system 600 can further implement interconnected relationships between these components to provide comprehensive user state management, repository state management, device state tracking, and user role definitions for the secure data storage environment.

The user component 602 functions as a central element within the user management system 600 that stores and manages user information for the secure data storage system. The user component 602 can contain user information including a unique user identifier (UUID), first name, last name, display name, user state, and user public key for cryptographic operations. The user component 602 can also include timestamps for creation time and last update time to track when user information was initially created and when it was most recently modified. The user component 602 can serve as the primary reference point for all user-related operations within the system, providing the foundation for user authentication, authorization, and access control mechanisms.

The user state enumeration 604 can be configured to define and manage the various states that user accounts can occupy within the secure data storage system. The user state enumeration 604 can establish user states including ACTIVE, CLOSED, and PENDING_CLOSURE to track the current status of user accounts. The user state enumeration 604 can connect to the user component 602 through a one-to-one relationship, where each user account has exactly one current state at any given time. The user state enumeration 604 can enable the system to manage user account lifecycles, including active users who can fully access the system, users whose accounts are pending closure, and users whose accounts have been permanently closed.

The user repository link component 606 can be configured to establish relationships between users and repositories within the secure data storage system. The user repository link component 606 can contain a user identifier, repository identifier, and user role to define how each user can interact with specific repositories. The user repository link component 606 can establish many-to-one relationships between the user component 602 and the repository component 614, enabling users to have access to multiple repositories while allowing repositories to be accessed by multiple users with different permission levels. The user repository link component 606 can facilitate the assignment and management of user permissions for repository access, ensuring that users can only perform actions within repositories that are consistent with their assigned roles.

The repository user roles enumeration 608 can be configured to define the specific roles that users can have within repositories. The repository user roles enumeration 608 can include roles such as owner, editor, viewer, and repository state manager, where each role provides different levels of access and control over repository content and management functions. The repository user roles enumeration 608 can connect to the user repository link component 606 to specify the exact permissions and capabilities associated with each user's access to specific repositories. The repository user roles enumeration 608 can enable fine-grain control over user permissions, where owners can have full control over repositories, editors can modify repository content, viewers can access repository content without modification rights, and repository state managers can perform administrative functions related to repository lifecycle management. In some aspects, a user may be assigned multiple roles for a single repository, such as being designated as both a viewer and a repository state manager simultaneously. This multi-role assignment can enable the user to access repository content for viewing purposes while also having the capability to perform administrative functions related to repository lifecycle management. Different users can be assigned a different number of roles, different types of roles, etc.

The user email link component 610 can be configured to associate users with their email addresses for communication and verification purposes. The user email link component 610 can contain a user identifier and an email identifier, along with creation and update timestamps to track when email associations were established and modified. The user email link component 610 can establish many-to-one relationships between the user component 602 and the user email component 618, enabling users to have multiple email addresses associated with their accounts while allowing the system to manage email-based communications and verification processes.

The user device link component 612 can be configured to link users with their authorized devices for secure access to the data storage system. The user device link component 612 can contain a user identifier and a device identifier, as well as creation and update timestamps to track when device associations were established and modified. The user device link component 612 can establish many-to-one relationships between the user component 602 and the device component 620, enabling users to have multiple authorized devices while allowing the system to manage device-based authentication and access control mechanisms.

The repository component 614 can be configured to store and manage information about data repositories within the secure data storage system. The repository component 614 can contain a repository identifier, name, repository state, encrypted content location, storage quota, and current storage usage to track repository characteristics and resource utilization. The repository component 614 can also include creation and update timestamps to maintain records of when repositories were created and last modified. The repository component 614 can serve as the central management point for repository-related operations, including content storage, access control, and resource management functions.

The repository state enumeration 616 can be configured to define and manage the various states that repositories can occupy within the secure data storage system. The repository state enumeration 616 can establish repository states including ACTIVE, SUSPENDED, PENDING_DELETION, and DELETED to track the current status and lifecycle stage of repositories. The repository state enumeration 616 can connect to the repository component 614 through a one-to-one relationship, where each repository has exactly one current state at any given time. The repository state enumeration 616 can enable the system to manage repository lifecycles, including active repositories that are fully operational, suspended repositories that are temporarily inaccessible, repositories that are pending deletion, and repositories that have been permanently deleted from the system.

The user email component 618 can be configured to store and manage email-related information for users within the secure data storage system. The user email component 618 can include an email identifier, email address, primary status indicating whether the email is the user's primary contact method, verification status indicating whether the email address has been verified, and a verification token for email validation processes. The user email component 618 can also include creation and update timestamps to track when email information was established and modified. The user email component 618 can facilitate email-based communications, notifications, and verification processes within the secure data storage system.

The device component 620 can be configured to manage information about devices authorized to access the secure data storage system. The device component 620 can include a device identifier, device name, device public key for cryptographic operations, encrypted user private key for secure key management, and device state to track the current status of each device. The device component 620 can also include creation and update timestamps to maintain records of when devices were registered and last updated. The device component 620 can enable the system to implement device-based authentication and authorization mechanisms, ensuring that only authorized devices can access user accounts and repository data.

The device state enumeration 622 can be configured to define and manage the various states that devices can occupy within the secure data storage system. The device state enumeration 622 can establish device states including ACTIVE and REMOVED to track whether devices are currently authorized to access the system or have been deauthorized. The device state enumeration 622 can connect to the device component 620 through a one-to-one relationship, where each device has exactly one current state at any given time. The device state enumeration 622 can enable the system to manage device authorization lifecycles, including active devices that can access user accounts and repositories, and removed devices that have been deauthorized and can no longer access the system.

Referring to FIG. 7, a system 700 illustrates a zero-trust version control system that integrates cryptographic operations with repository management processes to ensure data security throughout user interactions. As shown, the system 700 includes a user device 702, a register account process 704, a login process 706, an add device process 708, a remove device process 710, a read repository process 712, an update repository process 714, a create repository process 716, a delete repository process 718, a decrypt data operation 720, and an encrypt data operation 722. The system 700 can further implement selective integration of the decrypt data operation 720 and the encrypt data operation 722 with specific processes to maintain zero-trust security principles while enabling collaborative version control functionality.

The user device 702 functions as the primary interface through which users interact with the zero-trust version control system and initiate various repository management and device management actions. The user device 702 can connect to multiple processes within the system 700 to enable comprehensive user account management, device authorization, and repository operations. The user device 702 can serve as the secure endpoint where users authenticate their identity, manage their authorized devices, and perform repository operations while maintaining cryptographic security throughout all interactions. The user device 702 can facilitate user interactions with the system 700 while ensuring that all data handling operations adhere to zero-trust principles where verification is required for every access request.

The register account process 704 can be configured to enable new users to create accounts within the zero-trust version control system. The register account process 704 can connect to the user device 702 to receive account creation requests and establish new user profiles with appropriate cryptographic keys and security credentials. The register account process 704 can generate user authentication credentials, establish initial security parameters, and configure user accounts for secure access to the version control system. The register account process 704 can implement zero-trust verification procedures during account creation to ensure that new users are properly authenticated and authorized before gaining access to system resources.

The login process 706 can be configured to provide secure authentication mechanisms for existing users to access their accounts within the zero-trust version control system. The login process 706 can connect to the user device 702 to receive authentication requests and verify user credentials against stored security parameters. The login process 706 can implement multi-factor authentication and device verification procedures to ensure that only authorized users can access their accounts from authorized devices. The login process 706 can maintain session security and enforce zero-trust principles by requiring continuous verification of user identity and device authorization throughout active sessions.

The add device process 708 can be configured to enable users to authorize new devices for access to their accounts within the zero-trust version control system. The add device process 708 can connect to the user device 702 to receive device authorization requests and establish cryptographic relationships between new devices and user accounts. The add device process 708 can include the decrypt data operation 720, as indicated by the connection between the add device process 708 and the decrypt data operation 720, enabling the process to decrypt user private keys and re-encrypt them for new devices during the device authorization workflow. The add device process 708 can implement secure key exchange mechanisms that allow new devices to access encrypted user data while maintaining zero-trust security principles throughout the device authorization process.

The remove device process 710 can be configured to enable users to revoke authorization for devices that should no longer have access to their accounts within the zero-trust version control system. The remove device process 710 can connect to the user device 702 to receive device removal requests and terminate cryptographic relationships between removed devices and user accounts. The remove device process 710 can update device authorization states and ensure that removed devices can no longer access encrypted user data or repository content. The remove device process 710 can implement secure device deauthorization procedures that maintain system security while allowing users to manage their authorized device lists dynamically.

The read repository process 712 can be configured to enable users to access and view the contents of repositories within the zero-trust version control system. The read repository process 712 can connect to the user device 702 to receive repository access requests and provide encrypted repository content to authorized users. The read repository process 712 can include the decrypt data operation 720, as indicated by the connection between the read repository process 712 and the decrypt data operation 720, enabling the process to decrypt repository content for authorized users while maintaining encryption security for unauthorized access attempts. The read repository process 712 can implement fine-grain access control mechanisms that verify user permissions for specific repository content and decrypt only the data objects that users are authorized to access.

The update repository process 714 can be configured to enable users to modify and add content to repositories within the zero-trust version control system. The update repository process 714 can connect to the user device 702 to receive repository modification requests and process changes to repository content while maintaining version control and encryption security. The update repository process 714 can include both the decrypt data operation 720 and the encrypt data operation 722, as indicated by the connections between the update repository process 714 and both cryptographic operations, enabling the process to decrypt existing repository content for modification and encrypt updated content for secure storage. The update repository process 714 can implement version control mechanisms that track all changes to repository content while ensuring that modified data objects are properly encrypted and access control objects are updated to reflect new content versions.

The create repository process 716 can be configured to enable users to establish new repositories within the zero-trust version control system. The create repository process 716 can connect to the user device 702 to receive repository creation requests and establish new version-controlled repositories with appropriate encryption and access control mechanisms. The create repository process 716 can include the encrypt data operation 722, as indicated by the connection between the create repository process 716 and the encrypt data operation 722, enabling the process to encrypt initial repository content and establish access control objects for new repositories. The create repository process 716 can implement repository initialization procedures that configure encryption keys, access control objects, and version control structures for new repositories while ensuring that all initial content is properly secured according to zero-trust principles.

The delete repository process 718 can be configured to enable users to remove repositories from the zero-trust version control system. The delete repository process 718 can connect to the user device 702 to receive repository deletion requests and manage the secure removal of repository content and associated cryptographic materials. The delete repository process 718 can implement repository lifecycle management procedures that handle the transition of repositories through deletion states while ensuring that sensitive data is properly secured or destroyed according to system security policies. The delete repository process 718 can manage the cleanup of access control objects, encryption keys, and version control structures associated with deleted repositories.

The decrypt data operation 720 can be configured to provide cryptographic decryption services for processes that require access to encrypted content within the zero-trust version control system. The decrypt data operation 720 can connect to the add device process 708, the read repository process 712, and the update repository process 714 through include relationships, indicating that these processes incorporate decryption functionality as part of their operational workflows. The decrypt data operation 720 can implement symmetric and asymmetric decryption algorithms that enable authorized users to access encrypted data objects, access control objects, and user private keys while maintaining zero-trust security principles. The decrypt data operation 720 can verify user authorization and device authentication before performing decryption operations, ensuring that encrypted content is only accessible to properly authenticated and authorized users.

The encrypt data operation 722 can be configured to provide cryptographic encryption services for processes that create or modify content within the zero-trust version control system. The encrypt data operation 722 can connect to the update repository process 714 and the create repository process 716 through include relationships, indicating that these processes incorporate encryption functionality as part of their operational workflows. The encrypt data operation 722 can implement symmetric and asymmetric encryption algorithms that secure data objects, access control objects, and cryptographic keys before storage within the version control system. The encrypt data operation 722 can generate unique encryption keys for new data objects and update access control objects with encrypted keys for authorized users, ensuring that all content stored within the system adheres to zero-trust security principles where data is encrypted at rest and accessible only to properly authorized users and devices.

Referring to FIG. 8, the flow diagram illustrates a process 800 for account closure in a secure data storage system. For example, the process 800 can be for managing user account termination through email confirmation workflows and database state transitions. The process 800 is illustrated as a series of blocks or steps including a step 810, a step 812, a step 814, a step 816, a step 818, a step 820, a step 822, a step 824, a step 826, and a step 828. All or a subset of one or more of steps of the process 800 can be executed by various components or devices including a client device 802, an application server 804, a database 806, and an email service 808. Furthermore, all or a subset of any one or more of steps of the process 800 can be executed in accordance with the discussion above and with the discussion below.

The client device 802 functions as the user interface endpoint that initiates and manages account closure requests within the secure data storage system. The client device 802 can connect to the application server 804 to send account closure requests and receive confirmation responses throughout the account termination workflow. The client device 802 can also receive email communications from the email service 808 to facilitate user confirmation of account closure decisions. The client device 802 can display notifications and confirmations to users regarding the status and completion of account closure procedures.

The application server 804 can be configured to coordinate account closure workflows by managing interactions between the client device 802, the database 806, and the email service 808. The application server 804 can process account closure requests from the client device 802 and execute the necessary database operations and email communications to complete the account termination process. The application server 804 can implement security measures and verification procedures to ensure that account closures are properly authorized and executed according to system policies. The application server 804 can manage user state transitions and coordinate the timing of database updates and email notifications throughout the account closure workflow.

The database 806 can be configured to store and manage user account information, including user states and closure timestamps within the secure data storage system. The database 806 can receive queries and update commands from the application server 804 to retrieve user information and modify user account states during the closure process. The database 806 can maintain records of user account states including PENDING_CLOSURE and CLOSED states to track the progress of account termination procedures. The database 806 can store closure timestamps and other metadata associated with account closure events to provide audit trails and historical records of account lifecycle management.

The email service 808 can be configured to send email communications to users during the account closure process to facilitate confirmation and notification procedures. The email service 808 can receive email sending requests from the application server 804 and deliver closure confirmation emails and final notification emails to users through the client device 802. The email service 808 can support the email-based verification workflow that ensures users confirm their intent to close their accounts before the closure process is completed. The email service 808 can provide reliable email delivery mechanisms that enable users to receive and respond to account closure communications regardless of their current device or location.

The process 800 begins at step 810 by initiating account closure through a user request from the client device 802 to the application server 804. At step 810, the client device 802 can send an "initiateAccountClosure" command with a user identifier to the application server 804 to begin the account termination workflow. The account closure initiation at step 810 can trigger the application server 804 to begin the multi-step verification and confirmation process required to securely close user accounts. Step 810 can establish the starting point for the account closure workflow where users express their intent to terminate their accounts within the secure data storage system.

At step 812, the process 800 continues by retrieving user information from the database 806 through the application server 804. Step 812 can execute a "getUserById" query from the application server 804 to the database 806 using the user identifier provided in the initial closure request. The user information retrieval at step 812 can obtain the current user account details and state information needed to process the account closure request. The application server 804 can verify that the user account exists and is in a state that allows for closure processing before proceeding with subsequent steps in the workflow.

At step 814, the application server 804 updates the user status to PENDING_CLOSURE in the database 806. Step 814 can execute an "updateUserStatus" command to change the user's account state from ACTIVE to PENDING_CLOSURE, indicating that the account closure process has been initiated but not yet completed. The user status update at step 814 can prevent normal account operations while the closure confirmation process is in progress. Step 814 can establish the intermediate state that allows the system to track accounts that are in the process of being closed while maintaining the ability to cancel the closure if the user does not confirm their intent.

At step 816, the application server 804 sends a closure confirmation email notification to the email service 808. The application server 8004 can execute a "sendClosureConfirmationEmail" command to the email service 808, providing the user's email address for delivery of the confirmation message. The closure confirmation email can contain verification links or instructions that allow users to confirm their intent to close their accounts. The application server 804 can implement the email-based verification mechanism that ensures account closures are intentional and authorized by the actual account owners.

At step 818, the process 800 continues by delivering the closure confirmation email from the email service 808 to the client device 802. Step 818 can complete the email delivery process initiated in step 816, ensuring that users receive the confirmation email needed to proceed with account closure. The email delivery at step 818 can provide users with the verification link or confirmation mechanism needed to authorize the completion of their account closure request. Step 818 can enable users to review their closure decision and take the necessary action to confirm or cancel the account termination process.

At step 820, the process 800 continues by confirming account closure through user interaction with the email verification link from the client device 802 to the application server 804. The client device 802 can execute a "confirmAccountClosure" command with the user identifier and verification token to authorize the completion of the account closure process. The closure confirmation at step 820 can verify that the user has received the confirmation email and actively chosen to proceed with account termination. Step 820 can provide the final user authorization needed to transition the account from PENDING_CLOSURE to CLOSED state.

At step 822, the application server 804 updates the user status to CLOSED in the database 806. The application server 804 can execute an "updateUserStatus" command to change the user's account state from PENDING_CLOSURE to CLOSED, indicating that the account closure process has been completed and authorized. The user status update at step 822 can finalize the account termination and prevent any further access to the account or associated data. Step 822 can establish the final account state that indicates the user account has been permanently closed and is no longer available for normal operations.

At step 824, the application server 804 sets a closure timestamp in the database 806. The application server 804 can execute a "setClosedTimestamp" command to record the exact date and time when the account closure was completed. The closure timestamp setting at step 824 can provide audit trail information and historical records of when account closures occurred within the system. Step 824 can establish permanent records of account closure events that can be used for compliance, auditing, and historical tracking purposes.

At step 826, the application server 804 initiates a closure notification to the email service 808. The application server 804 can execute a "sendClosureNotificationEmail" command to begin the process of notifying users that their account closure has been completed successfully. The closure notification initiation at step 826 can trigger the final communication step in the account closure workflow. Step 826 can prepare the system to send confirmation to users that their accounts have been permanently closed and that the termination process is complete.

At step 828, the email service 808 delivers the account closed notification to the client device 802. The email service 808 can complete the final communication in the account closure workflow by informing users that their accounts have been successfully closed. The account closed notification at step 828 can provide users with confirmation that their account termination request has been processed and completed according to their instructions. Step 828 can conclude the account closure workflow by ensuring that users receive final confirmation of their account status and closure completion.

Although steps of the process 800 are discussed and illustrated in a particular order, the process 800 of FIG. 8 is not so limited. In other embodiments, all or a subset of one or more of steps of the process 800 can be performed in a different order. In these and other embodiments, all or a subset of any of steps of the process 800 can be performed before, during, and after all or a subset of any of the other steps of the process 800. Furthermore, a person skilled in the art will readily recognize that the process 800 can be altered and still remain within these and other embodiments of the present technology. For example, all or a subset of one or more steps of the process 800 can be omitted and repeated in some embodiments.

Referring to FIG. 9 a user account state diagram 900 illustrates a system for managing account access and lifecycle transitions in a secure data storage system. For example, the diagram 900 can illustrate a method for managing user account states through various life events and administrative actions that affect user access to repositories and encrypted data. The diagram 900 includes several states including an active state 902, a missing state 904, an incapacitated state 906, a pending closure state 908, a deceased state 910, and a closed state 912. All or a subset of one or more of the states of the diagram 900 can be managed by various components or devices of of FIGS. 6 or 8, such as the user management system 600, such as the user component 602, the user state enumeration 604, and the application server 804. Furthermore, all or a subset of any one or more of the states and transitions of the diagram 900 can be executed in accordance with the discussion above and with the discussion below.

The active state 902 functions as the primary operational state where users can fully access and utilize all features of the secure data storage system. The active state 902 can enable users to perform repository operations, device management, data encryption and decryption, and collaborative activities within their authorized repositories. The active state 902 can serve as the default state for users who have completed account registration and verification procedures and are in good standing within the system. The active state 902 can provide users with complete access to their encrypted data objects, access control objects, and version control functionalities while maintaining zero-trust security principles throughout all operations.

The missing state 904 can be configured to handle situations where users are reported as missing or cannot be contacted through normal communication channels. The missing state 904 can be reached from the active state 902 when a user is reported missing by authorized parties or when the system detects prolonged inactivity that suggests the user may be unavailable. The missing state 904 can implement account freezing mechanisms that temporarily suspend normal account operations while preserving the user's data and access rights for potential recovery. The missing state 904 can trigger sharing or unsharing of user’s data with trusted contacts, for example, an emergency contact list, if sharing was conditioned on the user’s repository going into this state. The missing state 904 can enable the system to transition back to the active state 902 through a "user found" transition when the missing user is located and can resume normal account operations.

The incapacitated state 906 can be configured to manage user accounts when users are reported as incapacitated and unable to manage their own account access and repository operations. The incapacitated state 906 can be reached from the active state 902 when a user is reported incapacitated by authorized parties such as family members, legal representatives, or medical professionals. The incapacitated state 906 can restrict direct user access while enabling designated proxies or representatives to manage the account and access encrypted data on behalf of the incapacitated user. The incapacitated state 906 can trigger sharing and/or unsharing of user’s data with trusted contacts, for example, an advance health directive or medical information release documents, if sharing was conditioned on the user’s repository going into this state, leaving this state, etc. The incapacitated state 906 can support a "user recovers" transition that allows the account to return to the active state 902 when the user regains capacity to manage their own account operations. In response to the user’s repository returning to the active state 902, the user’s data (advance health directive or medical information release documents) can be unshared with trusted contacts.

The pending closure state 908 can be configured to manage accounts that are in the process of being closed but have not yet completed the closure verification workflow. The pending closure state 908 can be reached from the active state 902 when a user requests account closure, triggering the email confirmation process described in the process 800 of FIG. 8. The pending closure state 908 can temporarily suspend normal account operations while maintaining the ability to cancel the closure process if the user does not confirm their intent to close the account. The pending closure state 908 can support a "user cancels closure request" transition that returns the account to the active state 902, or a "user confirms closure" transition that moves the account to the closed state 912.

The deceased state 910 can be configured to handle user accounts when users are reported deceased by authorized parties such as family members, estate administrators, or legal representatives. The deceased state 910 can be reached from the active state 902, the missing state 904, or the incapacitated state 906 through "user reported deceased" transitions that accommodate various circumstances leading to the deceased status. The deceased state 910 can enable designated survivors or estate administrators to manage the account and access encrypted data for estate management purposes while preventing unauthorized access by the deceased user's devices. The deceased state 910 can trigger sharing and/or unsharing of user’s data with trusted contacts, for example, an advance health directive or medical information release documents, if sharing was conditioned on the user’s repository going into this state. The deceased state 910 can support a "misreported death" transition that allows the account to return to the active state 902 if the death report was incorrect, and an "estate closing completed" transition that moves the account to the closed state 912 when estate administration is finished.

The closed state 912 can be configured as the final state where user accounts are permanently terminated and data becomes inaccessible through normal system operations. The closed state 912 can be reached from the active state 902 through direct user closure requests, from the pending closure state 908 when users confirm their closure intent, or from the deceased state 910 when estate administration is completed. The closed state 912 can implement permanent account termination procedures that prevent any further access to the user's encrypted data objects, repositories, and associated cryptographic materials. The closed state 912 can represent the end of the account lifecycle where all user access rights are permanently revoked and the account cannot be reactivated through normal system operations.

The system can implement state transition mechanisms that respond to various life events and administrative actions affecting user account status. The state transitions can include "user reported missing" from the active state 902 to the missing state 904, "user reported incapacitated" from the active state 902 to the incapacitated state 906, and "user reported deceased" from multiple states to the deceased state 910. The system can also support recovery transitions including "user found" from the missing state 904 to the active state 902, "user recovers" from the incapacitated state 906 to the active state 902, and "misreported death" from the deceased state 910 to the active state 902. The closure-related transitions can include "user requests closure" from the active state 902 to the pending closure state 908, "user confirms closure" from the pending closure state 908 to the closed state 912, and "user cancels closure request" from the pending closure state 908 back to the active state 902.

Although the states and transitions of the diagram 900 are discussed and illustrated in a particular configuration, the diagram 900 of FIG. 9 is not so limited. In other embodiments, all or a subset of one or more of the states of the diagram 900 can be configured with different transition rules or additional intermediate states. In these and other embodiments, all or a subset of any of the state transitions of the diagram 900 can be modified to accommodate different organizational policies, legal requirements, or security protocols.

Referring to FIG. 10, a flow diagram illustrates a method 1000 for adding a new device to a secure data storage system. For example, the method 1000 can be for securely registering new devices and establishing cryptographic relationships between devices and user accounts while maintaining zero-trust security principles. The method 1000 is illustrated as a series of blocks or steps including a step 1008, a step 1010, a step 1012, a step 1014, a step 1016, a step 1018, a step 1020, a step 1022, a step 1024, a step 1026, a step 1028, a step 1030, a step 1032, a step 1034, a step 1036, a step 1038, a step 1040, and a step 1042. All or a subset of one or more of steps of the method 1000 can be executed by various components or devices including an existing device 1002, a new device 1004, and an application server 1006. Furthermore, all or a subset of any one or more of steps of the method 1000 can be executed in accordance with the discussion above and with the discussion below.

The existing device 1002 functions as an authorized device that is already registered and authenticated within the secure data storage system and can facilitate the addition of new devices to the user's account. The existing device 1002 can store encrypted user private keys and can perform cryptographic operations needed to authorize new device additions while maintaining security protocols. The existing device 1002 can communicate with the application server 1006 to coordinate device addition workflows and can request user confirmation before authorizing new devices to access the user's account and encrypted data. The existing device 1002 can re-encrypt user private keys for new devices and can receive confirmation notifications when new device additions are completed successfully.

The new device 1004 can be configured as a device that is being added to a user's account within the secure data storage system and requires registration and key establishment procedures. The new device 1004 can generate its own cryptographic key pairs and can communicate with the application server 1006 to register itself within the system. The new device 1004 can receive encrypted user private keys from the existing device 1002 through the application server 1006 and can decrypt and store these keys securely for future access to encrypted repositories and data objects. The new device 1004 can request repository data from the application server 1006 once the device registration and key exchange processes are completed.

The application server 1006 can be configured to coordinate device addition workflows by managing communications between the existing device 1002 and the new device 1004 while maintaining security protocols and user authorization requirements. The application server 1006 can generate device identifiers, store device public keys, and manage the secure transfer of encrypted user private keys between devices during the registration process. The application server 1006 can provide repository data to newly registered devices and can send confirmation notifications to existing devices when new device additions are completed. The application server 1006 can implement zero-trust verification procedures throughout the device addition process to ensure that only authorized devices gain access to user accounts and encrypted data.

The method 1000 begins at step 1008 by the new device 1004 initiating a new device addition request to the application server 1006. At step 1008, the new device 1004 can send an "add new device" request to the application server 1006 to begin the device registration workflow within the secure data storage system. The device addition initiation at step 1008 can trigger the application server 1006 to begin the multi-step verification and registration process required to securely add new devices to user accounts.

At step 1010, the method 1000 continues by the application server 1006 prompting the new device 1004 for registration. The application server 1006 can send a registration prompt to the new device 1004 to initiate the device registration procedures. The registration prompting can request the new device 1004 to generate cryptographic keys and provide device identification information needed for secure registration. Step 1010 can prepare the new device 1004 to begin the cryptographic key generation and registration workflow required for secure device addition.

At step 1012, the new device 1004 can generate a device key pair. The new device 1004 can create both a device public key and a device private key using cryptographic algorithms appropriate for the secure data storage system. The device key pair generation at step 1012 can establish the cryptographic foundation needed for the new device 1004 to participate in encrypted communications and data access within the system. Step 1012 can ensure that the new device 1004 has unique cryptographic credentials that can be used for device authentication and encrypted key exchange operations.

At step 1014, the new device 1004 sends a registration request to the application server 1006. The new device 1004 can transmit the device public key generated in step 1012 along with other device identification information to the application server 1006. The registration request can provide the application server 1006 with the cryptographic and identification information needed to register the new device 1004 within the system. Step 1014 can establish the communication pathway for the new device 1004 to provide its credentials to the application server 1006 for processing and storage.

At step 1016, the application server 1006 generates a device identifier for the new device 1004. The application server 1006 can create a unique device identifier that can be used to reference and manage the new device 1004 within the secure data storage system. The device identifier generation at step 1016 can establish a unique reference for the new device 1004 that can be used in database records, access control mechanisms, and device management operations. Step 1016 can ensure that the new device 1004 receives a unique identifier that distinguishes it from other devices within the system.

At step 1018, the application server 1006 stores the device public key on the application server 1006. The application server 1006 can save the device public key received from the new device 1004 in step 1014 within the system's device management database. The device public key storage at step 1018 can enable the application server 1006 to perform cryptographic operations involving the new device 1004 and can facilitate secure communications between the new device 1004 and other system components. Step 1018 can establish the cryptographic record needed for the new device 1004 to participate in encrypted data access and device authentication procedures.

At step 1020, the application server 1006 sends the device identifier and name to the new device 1004. The application server 1006 can provide the new device 1004 with its assigned device identifier and any associated device name information generated during the registration process. The device identifier and name transmission at step 1020 can confirm to the new device 1004 that its registration request has been processed successfully and can provide the device with its system credentials. Step 1020 can enable the new device 1004 to reference itself within the system using the assigned identifier for future communications and operations.

At step 1022, the new device 1004 securely stores the device private key. The new device 1004 can save the device private key generated in step 1012 within secure storage mechanisms on the new device 1004 to protect it from unauthorized access. The device private key storage at step 1022 can ensure that the new device 1004 maintains secure access to its cryptographic credentials for future authentication and decryption operations. Step 1022 can implement secure key storage protocols that protect the device private key from compromise while enabling the new device 1004 to access it for authorized cryptographic operations.

At step 1024, the application server 1006 sends a request for an encrypted user private key from the existing device 1002. The application server 1006 can initiate the key transfer process that enables the new device 1004 to access the user's encrypted data by obtaining the user's private key in a form that can be decrypted by the new device 1004. The encrypted user private key request at step 1024 can trigger the existing device 1002 to begin the user confirmation and key re-encryption procedures needed to authorize the new device 1004. Step 1024 can establish the communication pathway for transferring cryptographic access rights from the existing device 1002 to the new device 1004.

At step 1026, the existing device 1002 requests user confirmation for adding the new device 1004. The existing device 1002 can prompt the user to authorize the addition of the new device 1004 to their account through the existing device 1002 interface. The user confirmation request at step 1026 can implement zero-trust verification procedures that ensure only authorized device additions are processed by requiring explicit user approval. Step 1026 can provide the user with information about the new device 1004 and can request confirmation that the device addition is authorized and intended.

At step 1028, the existing device 1002 re-encrypts the user private key with the new device public key. The existing device 1002 can decrypt the user private key using the existing device's cryptographic credentials and can re-encrypt the user private key using the public key of the new device 1004 received from the application server 1006. The user private key re-encryption at step 1028 can enable the new device 1004 to access the user's encrypted data while maintaining cryptographic security throughout the key transfer process. Step 1028 can ensure that the user private key is properly encrypted for the new device 1004 while preventing unauthorized access during the transfer process.

At step 1030, the existing device 1002 sends the re-encrypted user private key to the application server 1006. The existing device 1002 can transmit the user private key that has been re-encrypted for the new device 1004 to the application server 1006 for delivery to the new device 1004. The re-encrypted user private key transmission at step 1030 can complete the key preparation process on the existing device 1002 and can initiate the key delivery process through the application server 1006. Step 1030 can ensure that the re-encrypted user private key is securely transmitted to the application server 1006 for subsequent delivery to the new device 1004.

At step 1032, the application server 1006 sends the re-encrypted user private key to the new device 1004. The application server 1006 can deliver the user private key that has been encrypted specifically for the new device 1004 using the new device's public key. The re-encrypted user private key delivery at step 1032 can provide the new device 1004 with the cryptographic credentials needed to access the user's encrypted repositories and data objects. Step 1032 can complete the secure key transfer process by ensuring that the new device 1004 receives the user private key in a form that can be decrypted using the new device's private key.

At step 1034, the new device 1004 decrypts the user private key using its device private key. The new device 1004 can use the device private key stored securely in step 1022 to decrypt the re-encrypted user private key received from the application server 1006. The user private key decryption at step 1034 can recover the user's private key in a form that can be used by the new device 1004 for accessing encrypted data objects and repositories. Step 1034 can establish the cryptographic capability for the new device 1004 to participate in the user's encrypted data access and repository operations.

At step 1036, the new device 1004 stores the user private key securely on the new device 1004. The new device 1004 can save the decrypted user private key within secure storage mechanisms on the new device 1004 to protect it from unauthorized access while enabling future cryptographic operations. The user private key storage at step 1036 can ensure that the new device 1004 maintains secure access to the user's cryptographic credentials for accessing encrypted repositories and data objects. Step 1036 can implement secure key storage protocols that protect the user private key from compromise while enabling the new device 1004 to access it for authorized decryption and authentication operations.

At step 1038, the new device 1004 requests repository data from the application server 1006. The new device 1004 can initiate the process of providing the new device 1004 with access to the user's repositories and encrypted data objects now that the device has been successfully registered and has received the necessary cryptographic credentials. The repository data request at step 1038 can trigger the application server 1006 to provide the new device 1004 with repository information and access to encrypted content that the user is authorized to access. Step 1038 can establish the new device's ability to participate in repository operations and collaborative activities within the secure data storage system.

At step 1040, the application server 1006 sends repository data to the new device 1004. The application server 1006 can deliver repository information, access control objects, and encrypted data objects that the user is authorized to access through the newly registered device. The repository data transmission at step 1040 can provide the new device 1004 with the information needed to access and interact with the user's repositories and collaborative environments. Step 1040 can complete the data provisioning process that enables the new device 1004 to function as a fully authorized device within the user's secure data storage environment.

At step 1042, the application server 1006 confirms the new device addition to the existing device 1002. The application server 1006 can send a confirmation notification to the existing device 1002 indicating that the new device 1004 has been successfully added to the user's account and has received the necessary cryptographic credentials and repository access. The new device addition confirmation at step 1042 can provide the existing device 1002 with verification that the device addition process has been completed successfully and that the new device 1004 is now authorized to access the user's encrypted data. Step 1042 can conclude the device addition workflow by ensuring that all authorized devices are notified of changes to the user's device authorization list.

Although steps of the method 1000 are discussed and illustrated in a particular order, the method 1000 of FIG. 10 is not so limited. In other embodiments, all or a subset of one or more of steps of the method 1000 can be performed in a different order. In these and other embodiments, all or a subset of any of steps of the method 1000 can be performed before, during, and after all or a subset of any of the other steps of the method 1000. Furthermore, a person skilled in the art will readily recognize that the method 1000 can be altered and still remain within these and other embodiments of the present technology. For example, all or a subset of one or more steps of the method 1000 can be omitted and repeated in some embodiments.

Referring to FIG. 11A, a flow diagram illustrates a method 1100 for device removal in a secure data storage system when initiated from the device being removed. For example, the method 1100 can be for self-initiated device deauthorization where users remove devices directly from the device they wish to deauthorize from their account. The method 1100 is illustrated as a series of blocks or steps including a step 1108, a step 1110, a step 1112, a step 1114, and a step 1116. All or a subset of one or more of steps of the method 1100 can be executed by various components or devices including a registered device 1102, a removed device 1104, and an application server 1106. Furthermore, all or a subset of any one or more of steps of the method 1100 can be executed in accordance with the discussion above and with the discussion below.

The registered device 1102 functions as an authorized device that remains active within the secure data storage system and can receive notifications about device management activities affecting the user's account. The registered device 1102 can maintain its authorization status and cryptographic credentials while other devices are being removed from the user's account. The registered device 1102 can serve as a reference point for ongoing device management operations and can continue to provide secure access to the user's repositories and encrypted data objects throughout device removal procedures.

The removed device 1104 can be configured as the device that is being deauthorized and removed from the user's account within the secure data storage system. The removed device 1104 can initiate its own removal process by communicating directly with the application server 1106 to request deauthorization from the user's account. The removed device 1104 can perform local cleanup operations including deletion of cryptographic keys and sensitive data stored on the device to ensure that deauthorized devices cannot access encrypted repositories or user data after removal. The removed device 1104 can provide user notifications about the completion of the device removal process and can confirm that local sensitive data has been properly deleted.

The application server 1106 can be configured to coordinate device removal workflows by processing removal requests from devices and updating device authorization states within the secure data storage system. The application server 1106 can manage device state transitions from active to removed status and can maintain records of device authorization changes for security and audit purposes. The application server 1106 can send confirmation messages to devices throughout the removal process and can ensure that device deauthorization procedures are completed according to system security policies.

At step 1108, the removed device 1104 sends a device removal request to the application server 1106. For example, the removed device 1104 sends a request to remove itself from the user's account within the secure data storage system. The device removal initiation at step 1108 can trigger the application server 1106 to begin the device deauthorization workflow that will revoke the device's access to encrypted repositories and user data. Step 1108 can establish the starting point for self-initiated device removal where devices request their own deauthorization from user accounts.

At step 1110, the application server 1106 updates the removed device state. The application server 1106 can change the device status from active to removed within the system's device management database to reflect the device's deauthorized status. The removed device state update at step 1110 can prevent the removed device 1104 from accessing encrypted repositories, user data, or other system resources after the removal process is initiated. Step 1110 can ensure that the device authorization changes are recorded within the system's security infrastructure to maintain proper access control enforcement.

At step 1112, the application server 1106 sends a confirmation message to the removed device 1104. The application server 1106can acknowledge that the device removal request has been processed successfully and that the device's authorization status has been updated within the system. The removal confirmation at step 1112 can provide the removed device 1104 with verification that its deauthorization request has been accepted and processed by the application server 1106. Step 1112 can enable the removed device 1104 to proceed with local cleanup operations knowing that its system authorization has been revoked.

At step 1114, the removed device 1104 deletes local keys on the removed device 1104. The removed device 1104 can remove sensitive cryptographic materials including the device private key and encrypted user private key from the removed device's local storage. The local key deletion at step 1114 can ensure that the removed device 1104 cannot access encrypted repositories or user data even if the device retains cached copies of encrypted content. Step 1114 can implement secure deletion procedures that prevent recovery of cryptographic keys from the removed device's storage systems, ensuring that deauthorized devices cannot compromise user data security.

At step 1116, the removed device 1104 notifies the user of successful device removal. The removed device 1104 can display a confirmation message to the user indicating that the device removal process has been completed successfully and that local sensitive data has been deleted. The user notification at step 1116 can provide confirmation that the device is no longer authorized to access the user's account and that appropriate security measures have been implemented. Step 1116 can conclude the self-initiated device removal workflow by ensuring that users receive confirmation of the device deauthorization and local data cleanup completion.

Although steps of the method 1100 are discussed and illustrated in a particular order, the method 1100 of FIG. 11A is not so limited. In other embodiments, all or a subset of one or more of steps of the method 1100 can be performed in a different order. In these and other embodiments, all or a subset of any of steps of the method 1100 can be performed before, during, and after all or a subset of any of the other steps of the method 1100. Furthermore, a person skilled in the art will readily recognize that the method 1100 can be altered and still remain within these and other embodiments of the present technology. For example, all or a subset of one or more steps of the method 1100 can be omitted and repeated in some embodiments.

Referring to FIG. 11B, a flow diagram illustrates a method 1130 for device removal in a secure data storage system when initiated from another registered device. For example, the method 1130 can be for remote device deauthorization where users remove devices from their account using a different authorized device rather than the device being removed. The method 1130 is illustrated as a series of blocks or steps including a step 1138, a step 1140, a step 1142, and a step 1144. All or a subset of one or more of steps of the method 1130 can be executed by various components or devices including a registered device 1132, a removed device 1134, and an application server 1136. Furthermore, all or a subset of any one or more of steps of the method 1130 can be executed in accordance with the discussion above and with the discussion below.

The registered device 1132 functions as an authorized device that initiates the removal of another device from the user's account within the secure data storage system. The registered device 1132 can maintain its own authorization status and cryptographic credentials while coordinating the deauthorization of other devices associated with the user's account. The registered device 1132 can communicate with the application server 1136 to request removal of specific devices and can receive confirmation notifications when device removal operations are completed successfully. The registered device 1132 can provide user notifications about device management activities and can enable users to manage their authorized device lists remotely without requiring direct access to the devices being removed.

The removed device 1134 can be configured as the target device that is being deauthorized and removed from the user's account through remote initiation by the registered device 1132. The removed device 1134 can be a device that is lost, stolen, no longer in use, or otherwise requires deauthorization without direct user access to the device itself. The removed device 1134 can have its authorization status changed by the application server 1136 based on removal requests from the registered device 1132, enabling users to revoke access from devices that they cannot physically access or control. The removed device 1134 can lose its ability to access encrypted repositories and user data once the removal process is completed by the application server 1136.

The application server 1136 can be configured to coordinate remote device removal workflows by processing removal requests from authorized devices and updating device authorization states for target devices within the secure data storage system. The application server 1136 can verify that removal requests originate from properly authorized devices before processing device deauthorization operations. The application server 1136 can manage device state transitions for remotely removed devices and can send confirmation notifications to initiating devices when removal operations are completed. The application server 1136 can maintain security protocols that prevent unauthorized device removals while enabling legitimate remote device management operations.

At step 1138, the registered device 1132 sends a device removal request to the application server 1136. The registered device 1132 can send a request to remove a device from the user's account, specifying the removed device 1134 should be deauthorized from the system. The device removal initiation can trigger the application server 1136 to begin the remote device deauthorization workflow that will revoke the target device's access to encrypted repositories and user data. Step 1138 can establish the starting point for remote-initiated device removal where authorized devices request deauthorization of other devices within the same user account.

At step 1140, the application server 1136 updates the removed device state. The application server 1136 can change the device status of the removed device 1134 from active to removed within the system's device management database to reflect the device's deauthorized status. The removed device state update at step 1140 can prevent the removed device 1134 from accessing encrypted repositories, user data, or other system resources after the remote removal process is initiated. Step 1140 can ensure that device authorization changes are recorded within the system's security infrastructure to maintain proper access control enforcement for remotely deauthorized devices.

At step 1142, the application server 1136 sends a confirmation message to the registered device 1132. The application server 1136 can acknowledge that the remote device removal request has been processed successfully and that the target device's authorization status has been updated within the system. The removal confirmation at step 1142 can provide the registered device 1132 with verification that the deauthorization request for the removed device 1134 has been accepted and processed by the application server 1136. Step 1142 can enable the registered device 1132 to confirm to the user that the remote device removal operation has been completed successfully.

At step 1144, the registered device 1132 notifies the user of the successful device removal of the removed device 1134. The registered device 1132 can display a confirmation message to the user indicating that the remote device removal process has been completed successfully and that the target device no longer has authorization to access the user's account. The user notification at step 1144 can provide confirmation that the removed device 1134 is no longer authorized to access encrypted repositories or user data within the secure data storage system. Step 1144 can conclude the remote-initiated device removal workflow by ensuring that users receive confirmation of the device deauthorization through their authorized registered device 1132, enabling effective management of device authorization lists even when users cannot directly access the devices being removed.

Although steps of the method 1130 are discussed and illustrated in a particular order, the method 1130 of FIG. 11B is not so limited. In other embodiments, all or a subset of one or more of steps of the method 1130 can be performed in a different order. In these and other embodiments, all or a subset of any of steps of the method 1130 can be performed before, during, and after all or a subset of any of the other steps of the method 1130. Furthermore, a person skilled in the art will readily recognize that the method 1130 can be altered and still remain within these and other embodiments of the present technology. For example, all or a subset of one or more steps of the method 1130 can be omitted and repeated in some embodiments.

Referring to FIG. 12, a flow diagram illustrates a method 1200 for creating a new repository in a secure data storage system. For example, the method 1200 can be for establishing new version-controlled repositories with appropriate encryption and access control mechanisms while maintaining zero-trust security principles. The method 1200 is illustrated as a series of blocks or steps including a step 1208, a step 1210, a step 1212, a step 1214, a step 1216, a step 1218, and a step 1220. All or a subset of one or more of steps of the method 1200 can be executed by various components or devices including a device 1202, an application server 1204, and a database 1206. Furthermore, all or a subset of any one or more of steps of the method 1200 can be executed in accordance with the discussion above and with the discussion below.

The device 1202 functions as the user interface endpoint that initiates repository creation requests within the secure data storage system. The device 1202 can connect to the application server 1204 to send repository creation requests and receive confirmation responses throughout the repository establishment workflow. The device 1202 can provide users with interfaces for specifying repository parameters and can display notifications and confirmations regarding the status and completion of repository creation procedures. The device 1202 can serve as the primary interaction point where users define new repositories and receive feedback about the success of repository establishment operations.

The application server 1204 can be configured to coordinate repository creation workflows by managing interactions between the device 1202 and the database 1206 while implementing security protocols and access control mechanisms. The application server 1204 can process repository creation requests from the device 1202 and execute the necessary database operations to establish new repositories with appropriate encryption and access control structures. The application server 1204 can generate repository identifiers, create access control entries, and coordinate the establishment of cryptographic frameworks needed for secure repository operations. The application server 1204 can implement zero-trust verification procedures throughout the repository creation process to ensure that new repositories are properly secured and authorized.

The database 1206 can be configured to store and manage repository information, access control data, and cryptographic metadata within the secure data storage system. The database 1206 can receive repository creation commands from the application server 1204 and generate unique identifiers for new repositories and their associated access control structures. The database 1206 can maintain records of repository ownership, access permissions, and cryptographic parameters needed for secure repository operations. The database 1206 can provide persistent storage for repository metadata and access control information that enables ongoing repository management and user authorization procedures.

At step 1208, the device 1202 sends a repository creation request to the application server 1204. The device 1202 can send a "create new repository" command to the application server 1204 to begin the repository establishment workflow within the secure data storage system. The repository creation initiation at step 1208 can trigger the application server 1204 to begin the multi-step process required to establish new repositories with appropriate encryption, access control, and version control mechanisms. Step 1208 can establish the starting point for the repository creation workflow where users express their intent to create new version-controlled repositories for storing encrypted data objects.

At step 1210, the application server 1204 creates a new repository entry that is stored in the database 1206. The application server 1204 can execute a "create new repository entry" command from the application server 1204 to the database 1206 to establish the foundational database record for the new repository. The repository entry creation at step 1210 can initialize the database structures needed to store repository metadata, ownership information, and configuration parameters. Step 1210 can establish the persistent storage foundation that enables the new repository to be managed, accessed, and maintained within the secure data storage system.

At step 1212, the database 1206 generates and returns a new repository identifier to the application server 1204. The database 1206 can create a unique repository identifier that can be used to reference and manage the new repository throughout its lifecycle within the system. The repository identifier generation at step 1212 can provide the application server 1204 with a unique reference that can be used for subsequent database operations, access control configurations, and user interactions related to the new repository. Step 1212 can ensure that the new repository receives a unique identifier that distinguishes it from other repositories within the secure data storage system.

At step 1214, the application server creates a new repository access control entry that is stored in the database 1206. The application server 1204 can execute a "create new repository access control entry" command to establish the access control framework that will manage user permissions and cryptographic access to the new repository. The repository access control entry creation at step 1214 can initialize the security structures needed to implement fine-grain access control and zero-trust principles for the new repository. Step 1214 can establish the access control foundation that enables authorized users to access encrypted repository content while preventing unauthorized access according to the repository's security policies.

At step 1216, the database 1206 generates and returns a new repository access control identifier to the application server 1204. The database 1206 can create a unique access control identifier that can be used to reference and manage the access control mechanisms associated with the new repository. The repository access control identifier generation at step 1216 can provide the application server 1204 with a unique reference for managing user permissions, cryptographic keys, and access policies related to the new repository. Step 1216 can ensure that the new repository's access control system receives appropriate identification that enables ongoing management of user authorization and encrypted data access.

At step 1218, the application server 1204 sends the new repository identifier to the device 1202. The application server 1204 can transmit the repository identifier generated in step 1212 to provide the device 1202 with confirmation that the repository creation process has been successful and to provide the unique reference for the new repository. The repository identifier transmission at step 1218 can enable the device 1202 to reference the new repository in future operations and can provide users with confirmation that their repository creation request has been processed successfully. Step 1218 can establish the communication pathway that confirms successful repository establishment and provides users with the information needed to access and manage their new repository.

At step 1220, the device 1202 generates a confirmation notification regarding the successful creation of the new repository. The device 1202 can display a confirmation message to the user indicating that the repository creation process has been completed successfully and that the new repository is ready for use. The repository creation confirmation at step 1220 can provide users with verification that their new repository has been established with appropriate encryption, access control, and version control mechanisms. Step 1220 can conclude the repository creation workflow by ensuring that users receive confirmation of successful repository establishment and can begin using their new repository for secure data storage and collaborative operations.

Although steps of the method 1200 are discussed and illustrated in a particular order, the method 1200 of FIG. 12 is not so limited. In other embodiments, all or a subset of one or more of steps of the method 1200 can be performed in a different order. In these and other embodiments, all or a subset of any of steps of the method 1200 can be performed before, during, and after all or a subset of any of the other steps of the method 1200. Furthermore, a person skilled in the art will readily recognize that the method 1200 can be altered and still remain within these and other embodiments of the present technology. For example, all or a subset of one or more steps of the method 1200 can be omitted and repeated in some embodiments.

Referring to FIG. 13, a flow diagram illustrates a method 1300 for repository management in a secure data storage system. For example, the method 1300 can be for managing repository lifecycle states through deletion, recovery, and permanent removal operations while implementing cold storage mechanisms for data preservation and recovery capabilities. The method 1300 is illustrated as a series of blocks or steps including a step 1310, a step 1312, a step 1314, a step 1316, a step 1318, a step 1320, a step 1322, a step 1324, a step 1326, a step 1328, a step 1330, a step 1332, a step 1334, a step 1336, a step 1338, a step 1340, a step 1342, a step 1344, and a step 1346. All or a subset of one or more of steps of the method 1300 can be executed by various components or devices including a device 1302, an application server 1304, a database 1306, and a storage 1308. Furthermore, all or a subset of any one or more of steps of the method 1300 can be executed in accordance with the discussion above and with the discussion below.

The device 1302 functions as the user interface endpoint that initiates repository management requests within the secure data storage system. The device 1302 can connect to the application server 1304 to send repository deletion and recovery requests and receive confirmation responses throughout repository lifecycle management workflows. The device 1302 can provide users with interfaces for managing repository states and can display notifications and confirmations regarding the status and completion of repository management procedures. The device 1302 can serve as the primary interaction point where users control repository lifecycle transitions and receive feedback about the success of repository management operations.

The application server 1304 can be configured to coordinate repository management workflows by managing interactions between the device 1302, the database 1306, and the storage 1308 while implementing repository lifecycle policies and data preservation mechanisms. The application server 1304 can process repository management requests from the device 1302 and execute the necessary database operations and storage transitions to manage repository states through deletion, recovery, and permanent removal phases. The application server 1304 can coordinate the movement of repository data between active storage and cold storage systems and can manage the timing of permanent deletion operations according to system policies. The application server 1304 can implement automated repository cleanup procedures that permanently delete frozen repositories after specified time periods while maintaining recovery capabilities during intermediate states. Example recovery and device authentication technologies are disclosed in U.S. Provisional Application No. 63/779,826, which is incorporated by reference in its entirety.

The database 1306 can be configured to store and manage repository metadata, state information, and storage location references within the secure data storage system. The database 1306 can receive repository state update commands from the application server 1304 and maintain records of repository lifecycle transitions including pending deletion, frozen, active, and deleted states. The database 1306 can provide persistent storage for repository metadata that enables tracking of repository locations in active storage and cold storage systems. The database 1306 can support queries for frozen repositories that enable automated cleanup procedures and can maintain audit trails of repository lifecycle management activities.

The storage 1308 can be configured to provide both active storage and cold storage capabilities for repository data within the secure data storage system. The storage 1308 can receive repository data movement commands from the application server 1304 and can transfer encrypted repository content between active storage locations and cold storage locations based on repository lifecycle states. The storage 1308 can implement cold storage mechanisms that preserve repository data in a cost-effective manner while maintaining the ability to restore data to active storage when repository recovery is requested. The storage 1308 can support permanent data deletion operations that securely remove repository content from both active storage and cold storage locations when repositories reach their final deletion state.

At step 1310, the device 1302 sends a repository deletion request to the application server 1304. The device 1302 can send a "delete repository" command to the application server 1304 to begin the repository deletion workflow within the secure data storage system. The repository deletion initiation at step 1310 can trigger the application server 1304 to begin the multi-phase deletion process that transitions repositories through intermediate states before permanent removal. Step 1310 can establish the starting point for the repository deletion workflow where users express their intent to remove repositories from active use while maintaining recovery capabilities during an intermediate period.

At step 1312, the application server 1304 retrieves repository data from the database 1306. The application server 1304 can execute a query to obtain repository information including storage location, metadata, and current state information needed to process the deletion request. The repository data retrieval at step 1312 can provide the application server 1304 with the information needed to locate repository content in the storage 1308 and to coordinate the transition to cold storage. Step 1312 can verify that the repository exists and is in a state that allows for deletion processing before proceeding with subsequent steps in the workflow.

At step 1314, the database 1306 returns repository data including storage location information to the application server 1304. The database 1306 can provide the application server 1304 with the repository metadata and storage location references needed to coordinate the movement of repository content to cold storage. The repository data return at step 1314 can enable the application server 1304 to identify the current location of repository content within the storage 1308 and to plan the transition to cold storage systems. Step 1314 can establish the information foundation needed for the application server 1304 to coordinate repository data movement and state transitions.

At step 1316, the application server 1304 marks the repository entry as pending delete in the database 1306. The application server 1304 can update the repository state to indicate that the deletion process has been initiated and that the repository is transitioning toward removal from active use. The repository pending delete marking at step 1316 can prevent normal repository operations while the deletion workflow is in progress and can establish the intermediate state that precedes cold storage transition. Step 1316 can ensure that repository state changes are recorded within the system's management infrastructure to maintain proper lifecycle tracking throughout the deletion process.

At step 1318, the application server 1304 moves repository data to cold storage in the storage 1308. The application server 1304 can transfer encrypted repository content from active storage locations to cold storage systems that provide cost-effective data preservation while maintaining recovery capabilities. The repository data movement to cold storage at step 1318 can implement the data preservation mechanism that enables repository recovery if users change their deletion decision during the intermediate period. Step 1318 can ensure that repository content is securely transferred to cold storage while maintaining encryption and access control properties that protect the data during the preservation period.

At step 1320, the application server 1304 updates the repository status to frozen in the database 1306. The application server 1304 can change the repository state from pending delete to frozen to indicate that the repository content has been successfully moved to cold storage and is available for recovery if requested. The repository status update to frozen at step 1320 can establish the intermediate state that enables repository recovery while preventing normal repository operations. Step 1320 can ensure that the repository's frozen state is properly recorded within the system's management infrastructure to support both recovery operations and automated cleanup procedures.

At step 1322, the application server 1304 returns a deletion confirmation to the device 1302. The application server 1304 can acknowledge that the repository deletion request has been processed successfully and that the repository has been transitioned to cold storage with frozen status. The deletion confirmation return at step 1322 can provide the device 1302 with verification that the deletion workflow has been completed and that the repository is no longer in active use but remains recoverable. Step 1322 can enable the device 1302 to confirm to the user that the repository deletion has been processed while maintaining recovery options during the frozen period.

At step 1324, the device 1302 confirms the repository deletion. The device 1302 can display a confirmation message to the user indicating that the repository deletion process has been completed successfully and that the repository has been moved to cold storage with recovery capabilities. The repository deletion confirmation at step 1324 can provide users with verification that their deletion request has been processed and can inform users about the recovery options available during the frozen period. Step 1324 can conclude the deletion workflow by ensuring that users receive confirmation of repository state transition and understand the recovery capabilities available for frozen repositories.

At step 1326, the device 1302 sends a repository recovery request to the application server 1304. The device 1302 can send a "recover repository" command to the application server 1304 to begin the repository recovery workflow that restores frozen repositories to active status. The repository recovery initiation at step 1326 can trigger the application server 1304 to begin the process of moving repository content from cold storage back to active storage and updating repository state accordingly. Step 1326 can establish the starting point for the repository recovery workflow where users express their intent to restore previously deleted repositories from frozen status back to active use.

At step 1328, the application server 1304 retrieves frozen repository data from the database 1306. The application server 1304 can execute a query to obtain information about the frozen repository including its cold storage location, metadata, and current frozen state needed to process the recovery request. The frozen repository data retrieval at step 1328 can provide the application server 1304 with the information needed to locate repository content in cold storage within the storage 1308 and to coordinate the transition back to active storage. Step 1328 can verify that the repository exists in frozen state and is available for recovery before proceeding with subsequent steps in the recovery workflow.

At step 1330, the database 1306 returns frozen repository data to the application server 1304. The database 1306 can provide the application server 1304 with the repository metadata and cold storage location references needed to coordinate the movement of repository content back to active storage. The frozen repository data return at step 1330 can enable the application server 1304 to identify the current location of repository content within cold storage systems and to plan the transition back to active storage. Step 1330 can establish the information foundation needed for the application server 1304 to coordinate repository data restoration and state transitions during the recovery process.

At step 1332, the application server 1304 moves repository data from cold storage to active storage in the storage 1308. The application server 1304 can transfer encrypted repository content from cold storage systems back to active storage locations that support normal repository operations and user access. The repository data movement from cold storage at step 1332 can implement the data restoration mechanism that enables recovered repositories to resume normal operations with full functionality. Step 1332 can ensure that repository content is securely transferred from cold storage to active storage while maintaining encryption and access control properties throughout the restoration process.

At step 1334, the application server 1304 updates the repository status to active in the database 1306. The application server 1304 can change the repository state from frozen to active to indicate that the repository content has been successfully restored to active storage and is available for normal repository operations. The repository status update to active at step 1334 can establish the operational state that enables users to access, modify, and collaborate on repository content as they could before the deletion and recovery cycle. Step 1334 can ensure that the repository's active state is properly recorded within the system's management infrastructure to support normal repository operations and user access controls.

At step 1336, the application server 1304 returns a recovery confirmation to the device 1302. The application server 1304 can acknowledge that the repository recovery request has been processed successfully and that the repository has been restored to active storage with operational status. The recovery confirmation return at step 1336 can provide the device 1302 with verification that the recovery workflow has been completed and that the repository is available for normal use. Step 1336 can enable the device 1302 to confirm to the user that the repository recovery has been processed successfully and that the repository is ready for normal operations.

At step 1338, the device 1302 confirms the repository recovery. The device 1302 can display a confirmation message to the user indicating that the repository recovery process has been completed successfully and that the repository has been restored to active status with full functionality. The repository recovery confirmation at step 1338 can provide users with verification that their recovery request has been processed and can inform users that the repository is available for normal operations. Step 1338 can conclude the recovery workflow by ensuring that users receive confirmation of repository state restoration and can resume normal repository activities.

At step 1340, the application server 1304 retrieves frozen repositories from the database 1306. The application server 1304 can execute automated queries to identify repositories that have remained in frozen state for specified time periods and are eligible for permanent deletion according to system policies. The frozen repositories retrieval at step 1340 can provide the application server 1304 with a list of repositories that can be permanently removed from the system to free storage resources and complete the deletion lifecycle. Step 1340 can implement automated cleanup procedures that identify frozen repositories that have exceeded their recovery period and can be safely deleted without user intervention.

At step 1342, the database 1306 returns frozen repositories information to the application server 1304. The database 1306 can provide the application server 1304 with the list of frozen repositories and their associated metadata needed to coordinate permanent deletion operations. The frozen repositories return at step 1342 can enable the application server 1304 to identify repositories that can be permanently deleted and to coordinate the removal of repository content from cold storage systems. Step 1342 can establish the information foundation needed for the application server 1304 to execute automated cleanup procedures that permanently remove repositories that have exceeded their recovery periods.

At step 1344, the application server 1304 deletes repository data from the storage 1308. The application server 1304 can permanently remove encrypted repository content from cold storage systems for repositories that have exceeded their recovery periods and are eligible for final deletion. The repository data deletion at step 1344 can implement secure deletion procedures that ensure repository content cannot be recovered after permanent removal and that storage resources are freed for other system uses. Step 1344 can ensure that repository content is permanently and securely removed from all storage systems while maintaining audit trails of deletion activities for compliance and security purposes.

At step 1346, the application server 1304 marks repository entries as deleted in the database 1306. The application server 1304 can update repository states to indicate that permanent deletion has been completed and that repositories are no longer available for any operations including recovery. The repository entry marking as deleted at step 1346 can establish the final state in the repository lifecycle where repositories are permanently removed from the system and cannot be restored through normal operations. Step 1346 can ensure that repository deletion is properly recorded within the system's management infrastructure to maintain accurate records of repository lifecycle completion and to prevent attempts to access permanently deleted repositories.

Although steps of the method 1300 are discussed and illustrated in a particular order, the method 1300 of FIG. 13 is not so limited. In other embodiments, all or a subset of one or more of steps of the method 1300 can be performed in a different order. In these and other embodiments, all or a subset of any of steps of the method 1300 can be performed before, during, and after all or a subset of any of the other steps of the method 1300. Furthermore, a person skilled in the art will readily recognize that the method 1300 can be altered and still remain within these and other embodiments of the present technology. For example, all or a subset of one or more steps of the method 1300 can be omitted and repeated in some embodiments.

Referring to FIG. 14, a flow diagram illustrates a method 1400 for inviting users to access repositories in a secure data storage system. For example, the method 1400 can be for managing collaborative access to encrypted repositories through multi-device invitation workflows that implement database link table updates and user confirmation procedures. The method 1400 is illustrated as a series of interactions between a user A's device 1402, a user B's device 11404, a user B's device 21406, an application server 1408, and a database server 1410. All or a subset of one or more of the interactions of the method 1400 can be executed by various components or devices of the secure data storage system. Furthermore, all or a subset of any one or more of the interactions of the method 1400 can be executed in accordance with the discussion above and with the discussion below.

The user A's device 1402 functions as the repository owner's interface endpoint that initiates user invitation requests within the secure data storage system. The user A's device 1402 can connect to the application server 1408 to send invitation requests for granting other users access to repositories and can receive confirmation responses regarding the status of invitation workflows. The user A's device 1402 can provide repository owners with interfaces for specifying invited users and can display notifications about invitation acceptance or rejection decisions. The user A's device 1402 can serve as the primary control point where repository owners manage collaborative access to their encrypted repositories and receive feedback about the success or failure of invitation procedures.

The user B's device 11404 can be configured as one of the invited user's interface endpoints that receives invitation notifications and enables the invited user to respond to repository access requests. The user B's device 11404 can connect to the application server 1408 to receive invitation messages and can send acceptance or rejection responses based on the invited user's decision regarding repository access. The user B's device 11404 can display invitation details and repository information to help the invited user make informed decisions about accepting collaborative access to encrypted repositories. The user B's device 11404 can provide the invited user with the ability to accept invitations that will grant access to encrypted data objects and collaborative version control features within the specified repository.

The user B's device 21406 can be configured as another of the invited user's interface endpoints that receives the same invitation notifications to ensure comprehensive multi-device coverage for invitation delivery. The user B's device 21406 can connect to the application server 1408 to receive invitation messages simultaneously with the user B's device 11404, providing redundant notification delivery that ensures the invited user receives invitations regardless of which device is currently active. The user B's device 21406 can enable the invited user to respond to repository access invitations from multiple devices, providing flexibility in how users interact with the invitation system. The user B's device 21406 can support the multi-device notification approach that ensures reliable invitation delivery across the invited user's authorized device ecosystem.

The application server 1408 can be configured to coordinate user invitation workflows by managing communications between repository owners and invited users while implementing security protocols and access control verification procedures. The application server 1408 can process invitation requests from repository owners and can distribute invitation notifications to multiple devices associated with invited users to ensure reliable delivery. The application server 1408 can coordinate database updates that establish or modify user-repository relationships based on invitation acceptance or rejection decisions. The application server 1408 can implement zero-trust verification procedures throughout the invitation process to ensure that repository access is granted only to properly authenticated and authorized users.

The database server 1410 can be configured to store and manage user-repository link information, access permissions, and invitation status data within the secure data storage system. The database server 1410 can receive user-repository link table update commands from the application server 1408 and can maintain records of collaborative relationships between users and repositories. The database server 1410 can provide persistent storage for access control information that enables ongoing repository sharing and collaborative operations between repository owners and invited users. The database server 1410 can support queries and updates related to user permissions and can maintain audit trails of invitation activities and access control changes.

At step 1412, user A's device 1402 sends an invitation request to the application server 1408. The user A's device 1402 can send an invitation command to the application server 1408 to begin the user invitation workflow for granting another user access to a specific repository. The invitation initiation at step 1412 can trigger the application server 1408 to begin the multi-device notification process that ensures the invited user receives the invitation across their authorized devices. Step 1412 can establish the starting point for the collaborative access workflow where repository owners express their intent to share encrypted repositories with other users.

At step 1414, the application server 1408 sends the invitation to the user B's device 11404. The application server 1408 can deliver the repository access invitation to one of the invited user's devices to notify them of the collaboration opportunity. The invitation delivery at step 1414 can provide the invited user with information about the repository, the inviting user, and the proposed access permissions through the user B's device 11404. Step 1414 can implement the first part of the multi-device notification strategy that ensures invited users receive invitations through multiple communication channels.

At step 1416, the application server 1408 sends the invitation to the user B's device 21406. The application server 1408 can deliver the same repository access invitation to another of the invited user's devices to ensure comprehensive notification coverage. The invitation delivery at step 1416 can provide redundant notification that increases the likelihood that the invited user will receive and respond to the repository access invitation. Step 1416 can complete the multi-device notification approach that ensures reliable invitation delivery regardless of which devices the invited user is currently using.

The method 1400 illustrates two outcomes for the invitation process through outcome 1434 and outcome 1436. The outcome 1434 can represent the workflow of steps 1418-1426 that occur when the invited user accepts the repository access invitation and gains collaborative access to the encrypted repository. The outcome 1436 can represent the alternative workflow of steps 1428-1432 that occur when the invited user declines the repository access invitation and maintains their current access permissions without gaining access to the specified repository.

At step 1418, the user B's device 11404 sends an acceptance response to the application server 1408. The user B's device 11404 can transmit the invited user's decision to accept the repository access invitation to the application server 1408 for processing. The acceptance response at step 1418 can trigger the application server 1408 to begin the database update procedures that will establish the collaborative relationship between the invited user and the specified repository. Step 1418 can establish the user's consent for gaining access to encrypted repository content and collaborative version control features.

At step 1420, the application server 1408 updates the user-repository link table in the database server 1410. The application server 1408 can execute database commands that establish the relationship between the invited user and the repository, granting the user appropriate access permissions for collaborative operations. The user-repository link table update at step 1420 can create the persistent access control records that enable the invited user to access encrypted data objects and participate in version control activities within the shared repository. Step 1420 can implement the database changes that formalize the collaborative relationship and enable ongoing shared access to the repository.

At step 1422, the database server 1410 confirms the successful update to the application server 1408. The database server 1410 can acknowledge that the user-repository link table has been updated successfully and that the invited user now has authorized access to the specified repository. The update confirmation at step 1422 can provide the application server 1408 with verification that the database changes have been completed and that the collaborative relationship has been established properly. Step 1422 can enable the application server 1408 to proceed with notification procedures that inform both users about the successful invitation acceptance.

At step 1424, the application server 1408 sends a notification to the user A's device 1402. The application server 1408 can inform the repository owner that their invitation has been accepted and that the invited user now has access to the shared repository. The acceptance notification at step 1424 can provide the repository owner with confirmation that the collaborative relationship has been established successfully and that the invited user can begin accessing encrypted repository content. Step 1424 can enable repository owners to track the status of their invitation requests and to understand when collaborative access has been granted to invited users.

At step 1426, the user A's device 1402 notifies the repository owner about the invitation acceptance. The user A's device 1402 can display a confirmation message to the repository owner indicating that the invited user has accepted the repository access invitation and that collaborative access has been established. The acceptance notification display at step 1426 can provide repository owners with verification that their invitation workflow has been completed successfully and that the repository is now available for collaborative operations with the invited user. Step 1426 can conclude the successful invitation workflow by ensuring that repository owners receive confirmation of collaborative relationship establishment.

At step 1428, the user B's device 11404 sends a rejection response to the application server 1408. The user B's device 11404 can transmit the invited user's decision to decline the repository access invitation to the application server 1408 for processing. The rejection response at step 1428 can trigger the application server 1408 to begin the notification procedures that will inform the repository owner about the invitation decline without making any database changes to user-repository relationships. Step 1428 can establish the user's decision to maintain their current access permissions without gaining access to the specified repository.

At step 1430, the application server 1408 sends a notification to the user A's device 1402. The application server 1408 can inform the repository owner that their invitation has been rejected and that the invited user has declined access to the shared repository. The rejection notification at step 1430 can provide the repository owner with information about the invitation outcome and can enable them to take alternative actions such as extending new invitations or seeking other collaborators. Step 1430 can ensure that repository owners receive timely feedback about invitation decisions regardless of whether invitations are accepted or rejected.

At step 1432, the user A's device 1402 notifies the repository owner about the invitation rejection. The user A's device 1402 can display a notification message to the repository owner indicating that the invited user has declined the repository access invitation and that no collaborative relationship has been established. The rejection notification display at step 1432 can provide repository owners with clear feedback about invitation outcomes and can enable them to understand when collaborative access requests have been declined. Step 1432 can conclude the invitation rejection workflow by ensuring that repository owners receive definitive information about invitation decisions and can plan alternative collaboration strategies if needed.

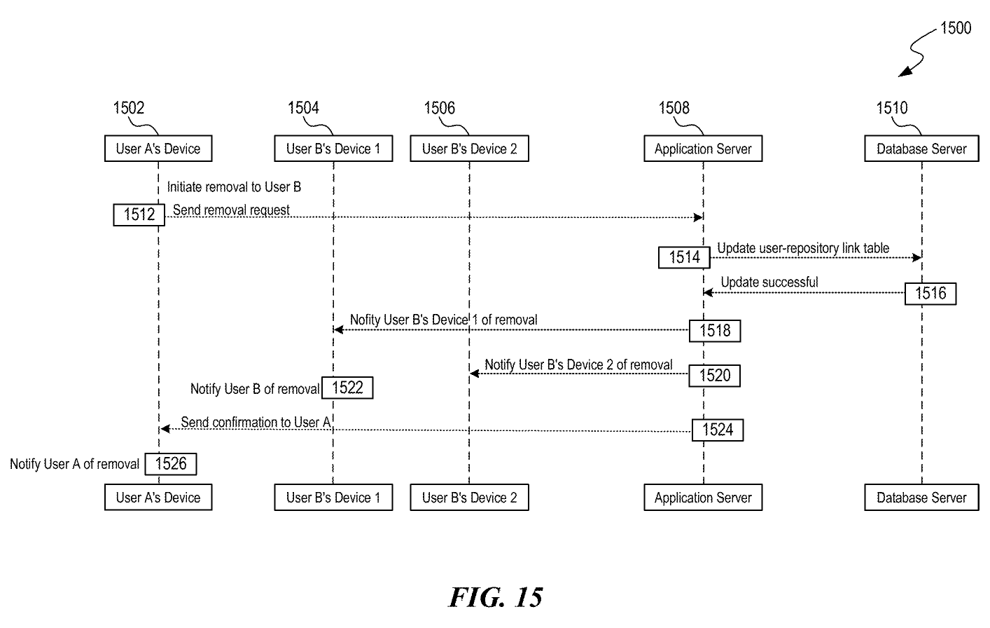

Referring to FIG. 15, a flow diagram illustrates a method 1500 for removing users from repositories in a secure data storage system. For example, the method 1500 can be for revoking collaborative access to encrypted repositories through multi-device notification workflows that implement database link table updates and user removal procedures. The method 1500 is illustrated as a series of interactions between a user A's device 1502, a user B's device 11504, a user B's device 21506, an application server 1508, and a database server 1510. All or a subset of one or more of the interactions of the method 1500 can be executed by various components or devices of the secure data storage system. Furthermore, all or a subset of any one or more of the interactions of the method 1500 can be executed in accordance with the discussion above and with the discussion below.

The user A's device 1502 functions as the repository owner's interface endpoint that initiates user removal requests within the secure data storage system. The user A's device 1502 can connect to the application server 1508 to send removal requests for revoking other users' access to repositories and can receive confirmation responses regarding the status of removal workflows. The user A's device 1502 can provide repository owners with interfaces for specifying users to be removed and can display notifications about removal completion. The user A's device 1502 can serve as the primary control point where repository owners manage collaborative access revocation for their encrypted repositories and receive feedback about the success of removal procedures.

The user B's device 11504 can be configured as one of the removed user's interface endpoints that receives removal notifications informing the user that their repository access has been revoked. The user B's device 11504 can connect to the application server 1508 to receive removal messages that notify the user about the termination of their collaborative access to encrypted repositories. The user B's device 11504 can display removal notifications to inform the user that they no longer have access to specific repositories and associated encrypted data objects. The user B's device 11504 can provide the removed user with clear information about access revocation to prevent confusion about their current repository permissions.

The user B's device 21506 can be configured as another of the removed user's interface endpoints that receives the same removal notifications to ensure comprehensive multi-device coverage for removal notification delivery. The user B's device 21506 can connect to the application server 1508 to receive removal messages simultaneously with the user B's device 11504, providing redundant notification delivery that ensures the removed user receives removal notifications regardless of which device is currently active. The user B's device 21506 can enable the removed user to receive repository access revocation notifications from multiple devices, providing comprehensive coverage of removal communications. The user B's device 21506 can support the multi-device notification approach that ensures reliable removal notification delivery across the removed user's authorized device ecosystem.

The application server 1508 can be configured to coordinate user removal workflows by managing communications between repository owners and removed users while implementing security protocols and access control revocation procedures. The application server 1508 can process removal requests from repository owners and can distribute removal notifications to multiple devices associated with removed users to ensure reliable delivery. The application server 1508 can coordinate database updates that eliminate or modify user-repository relationships based on removal decisions from repository owners. The application server 1508 can implement zero-trust verification procedures throughout the removal process to ensure that repository access is revoked properly and that removed users cannot continue accessing encrypted repository content.

The database server 1510 can be configured to store and manage user-repository link information, access permissions, and removal status data within the secure data storage system. The database server 1510 can receive user-repository link table update commands from the application server 1508 and can maintain records of collaborative relationship terminations between users and repositories. The database server 1510 can provide persistent storage for access control information that reflects current repository sharing relationships after user removals have been processed. The database server 1510 can support queries and updates related to user permission revocation and can maintain audit trails of removal activities and access control changes.

At step 1512, the user A's device 1502 sends a user removal request to the application server 1508. The user A's device 1502 can send a removal command to the application server 1508 to begin the user removal workflow for revoking another user's access to a specific repository. The removal initiation at step 1512 can trigger the application server 1508 to begin the database update and multi-device notification process that ensures the removed user is properly notified about access revocation across their authorized devices. Step 1512 can establish the starting point for the access revocation workflow where repository owners express their intent to terminate collaborative access to encrypted repositories for specific users.

At step 1514, the application server 1508 updates the user-repository link table in the database server 1510. The application server 1508 can execute database commands that eliminate the relationship between the removed user and the repository, revoking the user's access permissions for collaborative operations. The user-repository link table update at step 1514 can remove the persistent access control records that previously enabled the removed user to access encrypted data objects and participate in version control activities within the shared repository. Step 1514 can implement the database changes that formalize the termination of the collaborative relationship and prevent ongoing shared access to the repository.

At step 1516, the database server 1510 confirms the update was successful to the application server 1508. The database server 1510 can acknowledge that the user-repository link table has been updated successfully and that the removed user no longer has authorized access to the specified repository. The update confirmation at step 1516 can provide the application server 1508 with verification that the database changes have been completed and that the collaborative relationship has been terminated properly. Step 1516 can enable the application server 1508 to proceed with notification procedures that inform both the repository owner and the removed user about the successful access revocation.

At step 1518, the application server 1508 sends a removal notification to the user B's device 11504. The application server 1508 can deliver the repository access removal notification to one of the removed user's devices to notify them that their collaborative access has been revoked. The removal notification delivery at step 1518 can provide the removed user with information about the repository access termination and the repository owner's decision to revoke collaborative permissions through the user B's device 11504. Step 1518 can implement the first part of the multi-device notification strategy that ensures removed users receive access revocation notifications through multiple communication channels.

At step 1520, the application server 1508 sends a removal notification to the user B's device 21506. The application server 1508 can deliver the same repository access removal notification to another of the removed user's devices to ensure comprehensive notification coverage. The removal notification delivery at step 1520 can provide redundant notification that increases the likelihood that the removed user will receive and understand the repository access revocation. Step 1520 can complete the multi-device notification approach that ensures reliable removal notification delivery regardless of which devices the removed user is currently using.

At step 1522, the user B's device 11504 presents a notification to the removed user. The user B's device 11504 can display a removal message to the removed user indicating that their access to the specified repository has been revoked and that they can no longer access encrypted repository content or participate in collaborative operations. The removal notification presentation at step 1522 can provide the removed user with clear information about their changed access status and can prevent confusion about their current repository permissions. Step 1522 can ensure that removed users understand that their collaborative access has been terminated and that they should no longer attempt to access the specified repository.

At step 1524, the application server 1508 sends confirmation to the user A's device 1502. The application server 1508 can inform the repository owner that the user removal process has been completed successfully and that the specified user no longer has access to the shared repository. The removal completion confirmation at step 1524 can provide the repository owner with verification that the access revocation workflow has been processed successfully and that the removed user can no longer access encrypted repository content. Step 1524 can enable repository owners to track the status of their removal requests and to understand when collaborative access has been successfully revoked from specified users.

At step 1526, the user A's device 1502 notifies the repository owner about the successful user removal. The user A's device 1502 can display a confirmation message to the repository owner indicating that the specified user has been successfully removed from the repository and that collaborative access has been terminated. The removal completion notification display at step 1526 can provide repository owners with verification that their removal workflow has been completed successfully and that the repository access permissions have been updated to reflect the removal of the specified user. Step 1526 can conclude the user removal workflow by ensuring that repository owners receive confirmation of collaborative relationship termination and can proceed with repository management knowing that access permissions have been properly updated.

Although steps of the method 1500 are discussed and illustrated in a particular order, the method 1500 of FIG. 15 is not so limited. In other embodiments, all or a subset of one or more of steps of the method 1500 can be performed in a different order. In these and other embodiments, all or a subset of any of steps of the method 1500 can be performed before, during, and after all or a subset of any of the other steps of the method 1500. Furthermore, a person skilled in the art will readily recognize that the method 1500 can be altered and still remain within these and other embodiments of the present technology. For example, all or a subset of one or more steps of the method 1500 can be omitted and repeated in some embodiments.

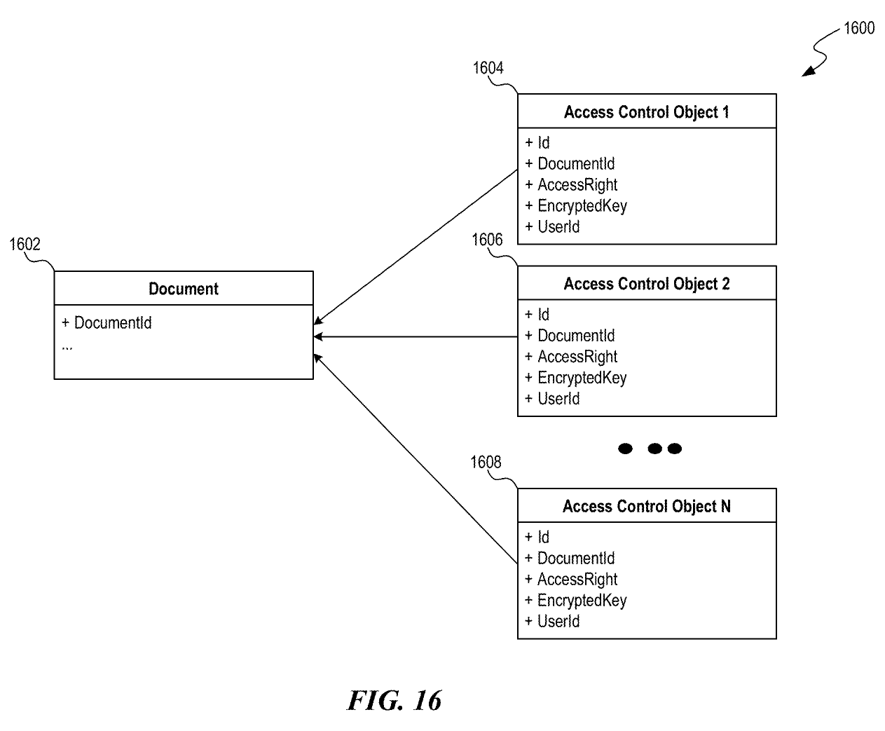

Referring to FIG. 16, system 1600 illustrates an architecture for managing access control with separate access control objects per document and per trusted contact within the secure data storage system. As shown, the system 1600 includes a document 1602, an access control object 1604, an access control object 1606, and an access control object 1608. The system 1600 can further implement a distributed access control architecture that provides enhanced granularity and reduces server-side contention by maintaining individual access control objects for each combination of document and trusted contact (e.g., authorized user).

The document 1602 functions as the encrypted data object that requires fine-grain access control management within the secure data storage system. The document 1602 can contain sensitive information that must be accessible to multiple trusted contacts with different access permissions and authorization levels. The document 1602 can be associated with multiple access control objects rather than relying on a single consolidated access control mechanism, enabling more precise management of user permissions and cryptographic key distribution. The document 1602 can serve as the central data object around which the distributed access control architecture is organized, providing the foundation for implementing separate access control objects for each trusted contact.

The access control object 1604 can be configured as a dedicated access control mechanism that manages cryptographic keys and permissions for a specific trusted contact's access to the document 1602. The access control object 1604 can contain attributes including an identifier, a document identifier that references the document 1602, an access right specification, an encrypted key for the specific trusted contact, and a user identifier that specifies which user the access control object serves. The access control object 1604 can implement individual key management for one trusted contact, enabling the system 1600 to grant, modify, or revoke access permissions for that specific user without affecting other users' access to the document 1602. The access control object 1604 can provide isolated access control that prevents interference between different users' access permissions and cryptographic key management operations. The access control objects 1606 and 1608 can be configured similarly to the access control object 1604 as additional dedicated access control mechanism that manages cryptographic keys and permissions for a different trusted contact's access to the document 1602.

The system 1600 implements a separate access control object architecture that provides higher granularity and better management flexibility compared to consolidated access control approaches. The separate access control objects can enable the system 1600 to manage individual user permissions independently, allowing for precise control over each trusted contact's access rights, cryptographic keys, and authorization levels without affecting other users' access to the document 1602. The system 1600 can avoid server-side race conditions and lock contention issues that can occur when multiple users attempt to access or modify a single consolidated access control object simultaneously. The separate access control object approach can enable concurrent access control operations where different trusted contacts can have their access permissions modified simultaneously without creating conflicts or requiring serialized access to shared access control resources.

The system 1600 can provide enhanced security and performance benefits through the separate access control object architecture. The individual access control objects can enable the system 1600 to implement fine-grain permission changes where access rights for one trusted contact can be modified without requiring updates to other users' access control information. The system 1600 can support efficient access control operations where each trusted contact's access permissions can be processed independently, reducing the computational overhead and system resources required for access control management. The separate access control object architecture can enable the system 1600 to maintain better audit trails and access control history for each trusted contact, providing detailed records of permission changes and access activities for individual users without complicating the access control records for other trusted contacts.

Referring to FIG. 17, a flow diagram illustrates a method 1700 for device authentication in a secure data storage system. For example, the method 1700 can be for implementing dual authorization using JWT access tokens and device ID validation to enhance security beyond standard token-based authentication mechanisms. The method 1700 is illustrated as a series of blocks or steps including a step 1708, a step 1710, a step 1712, a step 1714, a step 1716, a step 1718, a step 1720, and a step 1722. All or a subset of one or more of steps of the method 1700 can be executed by various components or devices including a user device 1702, a server 1704, and a database 1706. Furthermore, all or a subset of any one or more of steps of the method 1700 can be executed in accordance with the discussion above and with the discussion below.

The user device 1702 functions as the client endpoint that initiates authentication requests within the secure data storage system. The user device 1702 can connect to the server 1704 to send authentication requests that include both JWT access tokens and device identification information for dual authorization verification. The user device 1702 can maintain device-specific identifiers and can include these identifiers in authentication headers for each request to the server 1704. The user device 1702 can receive authentication responses from the server 1704 indicating whether requests have been successfully authorized or rejected based on the dual authorization criteria.

The server 1704 can be configured to coordinate device authentication workflows by validating JWT access tokens and verifying device registration status through interactions with the database 1706. The server 1704 can implement dual authorization mechanisms that require both valid JWT tokens and registered device identifiers before processing user requests. The server 1704 can communicate with the database 1706 to retrieve device information and can validate that devices are active and properly registered within the system. The server 1704 can execute authorized requests when both authentication criteria are satisfied or can reject requests with appropriate error codes when authentication fails.

The database 1706 can be configured to store and manage device registration information, device states, and authentication metadata within the secure data storage system. The database 1706 can receive device lookup requests from the server 1704 and can return device information needed for authentication validation procedures. The database 1706 can maintain records of registered devices, device states, and device authorization status that enable the server 1704 to verify device legitimacy during authentication workflows. The database 1706 can provide persistent storage for device authentication data that supports ongoing device verification and access control enforcement.

At step 1708, the user device 1702 sends a request with JWT access token and device ID to the server 1704. The user device 1702 can transmit authentication requests that include both a JWT access token in the authorization header and a device identifier in a separate header to enable dual authorization validation. The request transmission at step 1708 can implement the dual authorization approach where both token-based authentication and device-based authentication are required for request processing. Step 1708 can establish the foundation for enhanced security authentication that goes beyond standard JWT token validation by incorporating device-specific verification requirements.

At step 1710, the server 1704 validates the access token. The server 1704 can verify that the JWT access token has not expired, was issued by the server 1704, and contains valid user information and permissions. The access token validation at step 1710 can implement standard JWT verification procedures that confirm token authenticity and validity before proceeding with device-specific authentication steps. Step 1710 can ensure that requests include properly formatted and authorized JWT tokens as the first component of the dual authorization mechanism.

At step 1712, the server 1704 retrieves device information by ID from the database 1706. The server 1704 can execute database queries that obtain device registration records, device states, and device authorization information needed for device validation procedures. The device information retrieval at step 1712 can provide the server 1704 with the data needed to verify that the device identifier included in the authentication request corresponds to a properly registered and authorized device within the system. Step 1712 can implement the database lookup component of the device authentication workflow that enables verification of device legitimacy.

At step 1714, the database 1706 returns fetched device information to the server 1704. The database 1706 can provide the server 1704 with device registration data, device state information, and device authorization status needed to complete device validation procedures. The device information return at step 1714 can enable the server 1704 to determine whether the requesting device is registered within the system and is in an active state that permits access to secure resources. Step 1714 can establish the information foundation needed for the server 1704 to make authorization decisions based on device registration and state verification.

At step 1716, the server 1704 validates that the device is registered and active. The server 1704 can verify that the device identifier corresponds to a registered device within the system and that the device state indicates active authorization for accessing secure resources. The device registration and state validation at step 1716 can implement the second component of the dual authorization mechanism where device legitimacy is confirmed in addition to JWT token validation. Step 1716 can determine whether the requesting device meets the authorization criteria needed to proceed with request execution or whether the request should be rejected due to device authentication failure.

The method 1700 illustrates two outcomes following device validation at step 1716. In a successful authentication scenario, the server 1704 can proceed to execute the authorized request and return a successful response. In a failed authentication scenario, the server 1704 can reject the request and return an unauthorized error response to indicate authentication failure.

At step 1718, the server 1704 executes the request when device validation is successful. The server 1704 can process the user's request and perform the requested operations within the secure data storage system after both JWT token validation and device authentication have been completed successfully. The request execution at step 1718 can enable authorized users with registered devices to access encrypted repositories, perform repository operations, and interact with secure system resources. Step 1718 can implement the successful completion of the dual authorization workflow where both authentication criteria have been satisfied.

At step 1720, the server 1704 sends a successful status response to the user device 1702. The server 1704 can return a status code 200 or other success indicator to confirm that the request has been processed successfully and that the dual authorization requirements have been met. The successful status transmission at step 1720 can provide the user device 1702 with confirmation that the authentication workflow has been completed successfully and that the requested operations have been executed. Step 1720 can conclude the successful authentication workflow by ensuring that authorized users receive confirmation of successful request processing.

At step 1722, the server 1704 sends an unauthorized status code to the user device 1702 when device validation fails. The server 1704 can return a status code 401 rejection response when the server 1704 cannot match the device identifier to a registered active device or when device authentication fails for other reasons. The unauthorized status transmission at step 1722 can provide the user device 1702 with clear indication that the authentication request has been rejected due to device authentication failure. Step 1722 can conclude the failed authentication workflow by ensuring that unauthorized devices receive appropriate error responses and cannot access secure system resources.

The method 1700 implements JWT token authorization with additional device ID validation for enhanced security beyond standard token-based authentication mechanisms. The dual authorization approach can prevent unauthorized access even when JWT tokens are compromised, since attackers would also need access to registered devices to successfully authenticate with the system. The method 1700 can provide enhanced security for the secure data storage system by requiring both valid authentication tokens and authorized devices for accessing encrypted repositories and sensitive system resources.

Although steps of the method 1700 are discussed and illustrated in a particular order, the method 1700 of FIG. 17 is not so limited. In other embodiments, all or a subset of one or more of steps of the method 1700 can be performed in a different order. In these and other embodiments, all or a subset of any of steps of the method 1700 can be performed before, during, and after all or a subset of any of the other steps of the method 1700. Furthermore, a person skilled in the art will readily recognize that the method 1700 can be altered and still remain within these and other embodiments of the present technology. For example, all or a subset of one or more steps of the method 1700 can be omitted and repeated in some embodiments.

Referring to FIG. 18, a flow diagram illustrates a method 1800 for sharing and unsharing documents in a secure data storage system through a sharing wizard workflow. For example, the method 1800 can be for managing document sharing operations with progress tracking, retry mechanisms, and queue-based event processing to ensure reliable completion of sharing and unsharing activities. The method 1800 is illustrated as a series of blocks or steps including a step 1812, a step 1814, a step 1816, a step 1818, a step 1820, a step 1822, a step 1824, a step 1826, a step 1828, a step 1830, a step 1832, a step 1834, a step 1836, a step 1838, a step 1840, a step 1842, a step 1844, a step 1846, and a step 1848. All or a subset of one or more of steps of the method 1800 can be executed by various components or devices including a client device 1802, a sharing service 1804 (e.g., a server or server system), a database 1806 (e.g., DynamicDb), a database 1808 (e.g., Postgresql), and a queue 1810 (e.g., SQS). Furthermore, all or a subset of any one or more of steps of the method 1800 can be executed in accordance with the discussion above and with the discussion below.

The client device 1802 functions as the user interface endpoint that initiates document sharing and unsharing requests within the secure data storage system. The client device 1802 can connect to the sharing service 1804 to send sharing wizard requests that specify documents to be shared or unshared with trusted contacts and can receive confirmation responses regarding the status of sharing operations. The client device 1802 can provide users with interfaces for selecting documents and trusted contacts for sharing operations and can display notifications about sharing completion or failure. The client device 1802 can prepare encrypted symmetric keys for documents per requested trusted contact and can send completion requests to finalize sharing operations.

The sharing service 1804 can be configured to coordinate document sharing workflows by managing interactions between the client device 1802, the database 1806, the database 1808, and the queue 1810 while implementing sharing progress tracking and retry mechanisms. The sharing service 1804 can process sharing wizard requests from the client device 1802 and can execute the necessary database operations to determine sharing plans, retrieve document trees, and create document access request identifiers. The sharing service 1804 can validate sharing requests, save access control objects in temporary tables, and send events to queues for asynchronous processing. The sharing service 1804 can implement progress tracking mechanisms that prevent concurrent sharing operations and can provide retry capabilities for failed sharing operations.

The database 1806 can be configured to store and manage document metadata, sharing progress information, and document access request data within the secure data storage system. The database 1806 can receive queries from the sharing service 1804 to check sharing progress, retrieve document subtrees, and obtain document information needed for sharing operations. The database 1806 can maintain records of document access request identifiers and can store temporary access control objects during sharing workflows. The database 1806 can provide persistent storage for sharing metadata that enables tracking of sharing operations and supports retry mechanisms for failed sharing attempts.

The database 1808 can be configured to store and manage sharing table information and already shared document records within the secure data storage system. The database 1808 can receive queries from the sharing service 1804 to retrieve information about documents that have already been shared with trusted contacts. The database 1808 can maintain records of existing sharing relationships that enable the sharing service 1804 to determine which documents require new sharing operations and which documents can be unshared. The database 1808 can provide persistent storage for sharing relationship data that supports the sharing wizard's ability to calculate sharing plans and avoid duplicate sharing operations.

The queue 1810 can be configured to provide asynchronous event processing capabilities for document sharing operations within the secure data storage system. The queue 1810 can receive events from the sharing service 1804 that contain document access request identifiers and sharing operation details for processing by dedicated handlers. The queue 1810 can implement reliable message delivery mechanisms that ensure sharing events are processed even if temporary failures occur during sharing operations. The queue 1810 can support retry mechanisms where sharing events can be reprocessed if initial processing attempts fail, and can implement automatic cleanup procedures that remove stale sharing requests after specified time periods.

At step 1812, the client device 1802 sends a sharing wizard request to the sharing service 1804. The client device 1802 can transmit a POST sharing/wizard request that includes details of documents to be shared or unshared with specified trusted contacts. The sharing wizard request at step 1812 can contain user identifiers, access rights, root document identifiers, documents to share, and documents to unshare as parameters for the sharing operation. Step 1812 can establish the starting point for the sharing wizard workflow where users specify their document sharing intentions and initiate the complex sharing plan calculation and execution process.

At step 1814, the sharing service 1804 checks the sharing progress in the database 1806. The sharing service 1804 can query the database 1806 to determine whether there is an active sharing operation in progress for the current user to prevent concurrent sharing operations that could create conflicts. The sharing progress check at step 1814 can return a 400 bad request response if sharing is already in progress, ensuring that users complete existing sharing operations before initiating new ones. Step 1814 can implement the progress tracking mechanism that prevents overlapping sharing operations and maintains system consistency during complex sharing workflows.

At step 1816, the sharing service 1804 checks the worst case scenario for whole plan sharing and unsharing. The sharing service 1804 can analyze the complete sharing plan to determine the maximum scope of sharing operations that would be required if all specified documents and their subtrees were shared or unshared. The worst case scenario analysis at step 1816 can help the sharing service 1804 prepare for the full scope of sharing operations and can enable resource planning for complex sharing workflows. Step 1816 can establish the foundation for calculating the complete sharing plan by understanding the maximum extent of documents that could be affected by the sharing operation.

At step 1818, the sharing service 1804 retrieves already shared documents from the sharing table in the database 1808. The sharing service 1804 can query the database 1808 to obtain information about documents that have already been shared with trusted contacts to avoid duplicate sharing operations. The already shared documents retrieval at step 1818 can provide the sharing service 1804 with the baseline information needed to calculate which documents require new sharing operations and which documents can be unshared. Step 1818 can implement the sharing state analysis that enables the sharing wizard to make informed decisions about sharing plan execution.

At step 1820, the sharing service 1804 obtains subtrees of documents for each shared document from the database 1806. The sharing service 1804 can retrieve hierarchical document structures that include all child documents and subdirectories associated with already shared documents. The document subtree retrieval at step 1820 can provide the sharing service 1804 with comprehensive information about existing sharing relationships that include not only individual documents but also their associated document hierarchies. Step 1820 can enable the sharing wizard to understand the complete scope of existing sharing relationships when calculating new sharing plans.

At step 1822, the sharing service 1804 retrieves all documents for the whole plan from the database 1806. The sharing service 1804 can obtain comprehensive document information that encompasses all documents that could potentially be affected by the sharing operation. The whole plan document retrieval at step 1822 can provide the sharing service 1804 with the complete document inventory needed to calculate sharing and unsharing operations. Step 1822 can establish the comprehensive document foundation that enables the sharing wizard to make complete sharing plan calculations.

At step 1824, the sharing service 1804 excludes existing shared document trees from the whole plan and creating document access request identifiers for sharing and unsharing operations in the database 1806. The sharing service 1804 can calculate the net sharing operations required by removing already shared document trees from the complete sharing plan and can generate unique identifiers for tracking sharing and unsharing operations. The document access request identifier creation at step 1824 can establish the tracking mechanisms needed to manage complex sharing operations that involve multiple documents and trusted contacts. Step 1824 can implement the sharing plan optimization that avoids redundant sharing operations while ensuring that all required sharing and unsharing activities are properly tracked.

At step 1826, the sharing service 1804 obtains subtrees of documents for each document to be shared in the request from the database 1806 through the sharing service 1804. The sharing service 1804 can retrieve hierarchical document structures for documents that are specifically requested to be shared, ensuring that sharing operations include all child documents and subdirectories. The document subtree retrieval for sharing at step 1826 can provide the sharing service 1804 with detailed information about the document hierarchies that will be affected by new sharing operations. Step 1826 can ensure that sharing operations are comprehensive and include all related documents within the specified document trees.

At step 1828, the sharing service 1804 retrieves all documents to unshare for the whole plan from the database 1806 through the sharing service 1804. The sharing service 1804can obtain information about documents that should be unshared as part of the sharing plan execution. The documents to unshare retrieval at step 1828 can provide the sharing service 1804 with the information needed to revoke sharing access for documents that are no longer intended to be shared with specified trusted contacts. Step 1828 can implement the unsharing component of the sharing wizard that enables users to revoke document access as part of comprehensive sharing plan updates.

At step 1830, the sharing service 1804 excludes documents to be shared in the request from the whole plan through the sharing service 1804. The sharing service 1804 can refine the unsharing plan by removing documents that are being newly shared from the list of documents to be unshared, preventing conflicting operations within the same sharing workflow. The document exclusion for unsharing at step 1830 can ensure that the sharing wizard does not attempt to simultaneously share and unshare the same documents with the same trusted contacts. Step 1830 can implement the sharing plan consistency mechanism that prevents contradictory sharing operations within a single sharing workflow.

At step 1832, the sharing service 1804 creates document access request identifiers for sharing and unsharing operations in the database 1806 through the sharing service 1804. The sharing service 1804 can generate unique tracking identifiers for the refined sharing and unsharing operations that will be executed as part of the sharing plan. The document access request identifier creation at step 1832 can establish the tracking framework needed to monitor the progress of individual sharing and unsharing operations within the complex sharing workflow. Step 1832 can implement the operation tracking mechanism that enables the sharing wizard to manage multiple concurrent sharing operations and provide status updates to users.

At step 1834, the sharing service 1804 obtains subtrees of documents for each document to be shared in the request from the database 1806 through the sharing service 1804. The sharing service 1804 can retrieve additional document hierarchy information needed to complete the sharing plan calculation and ensure that all related documents are included in sharing operations. The document subtree retrieval at step 1834 can provide comprehensive coverage of document relationships that must be considered during sharing plan execution. Step 1834 can ensure that the sharing wizard has complete information about document hierarchies before proceeding with sharing operation execution.

At step 1836, the sharing service 1804 creates document access request identifiers for sharing and unsharing operations and returns a dictionary to the client device 1802. The sharing service 1804 can generate the final set of tracking identifiers for sharing operations and can provide the client device 1802 with a mapping of document access request identifiers to documents that will be shared. The document access request identifier creation and dictionary return at step 1836 can complete the sharing plan calculation phase and can provide the client device 1802 with the information needed to prepare encrypted symmetric keys for the sharing operation. Step 1836 can establish the transition point between sharing plan calculation and sharing operation execution.

At step 1838, the client device 1802 sends a completion request to the sharing service 1804. The client device 1802 can transmit a POST sharing/wizard/complete request that includes encrypted symmetric keys prepared by the client device 1802 for the documents and trusted contacts specified in the sharing plan. The completion request at step 1838 can provide the sharing service 1804 with the cryptographic materials needed to complete the sharing operations by creating access control objects with encrypted keys for authorized users. Step 1838 can initiate the sharing operation execution phase where the sharing plan calculated in previous steps is implemented through database updates and access control object creation.

At step 1840, the sharing service 1804 validates the completion request on the sharing service 1804. The sharing service 1804 can verify that the completion request contains valid encrypted symmetric keys, proper document access request identifiers, and appropriate trusted contact information needed to execute the sharing plan. The request validation at step 1840 can ensure that the sharing operation can be completed successfully before proceeding with database updates and access control object creation. Step 1840 can implement the quality control mechanism that prevents invalid sharing operations from being processed and can provide error feedback if completion requests are malformed or incomplete.

At step 1842, the sharing service 1804 saves new access control objects in a temporary table with document access request identifiers in the database 1806. The sharing service 1804 can create access control objects that contain encrypted symmetric keys for trusted contacts and can store these objects in temporary storage associated with document access request identifiers. The access control object creation at step 1842 can implement the cryptographic access control mechanism that enables trusted contacts to access shared documents using their private keys to decrypt the symmetric keys stored in access control objects. Step 1842 can establish the temporary storage phase where access control objects are prepared for final processing through queue-based event handling.

At step 1844, the sharing service 1804 determines if there is a failure and aborting the request if necessary. The sharing service 1804 can implement error handling mechanisms that detect failures during access control object creation and can abort the sharing operation if critical errors occur. The failure detection and request abortion at step 1844 can prevent incomplete sharing operations from being processed and can ensure that sharing operations are completed successfully or not at all. Step 1844 can implement the error recovery mechanism that maintains system consistency by preventing partial sharing operations that could leave the system in an inconsistent state.

At step 1846, the sharing service 1804 sends a single event for all document access request identifiers to the queue 1810. The sharing service 1804 can create a queue event that contains all document access request identifiers associated with the sharing operation for processing by dedicated event handlers. The event creation and queue transmission at step 1846 can initiate the asynchronous processing phase where access control objects are moved from temporary storage to permanent storage and sharing relationships are finalized. Step 1846 can implement the queue-based processing mechanism that enables reliable completion of sharing operations even if temporary system failures occur during processing.

At step 1848, the sharing service 1804 sends an accepted response to the client device 1802 that displays a notification confirming completion of the sharing process. The sharing service 1804 can provide the client device 1802 with confirmation that the sharing request has been accepted for processing and that the sharing operations will be completed asynchronously through queue-based event handling. The accepted response and notification display at step 1848 can inform users that their sharing operations have been initiated successfully and will be completed by the system's background processing mechanisms. Step 1848 can conclude the sharing wizard workflow by ensuring that users receive confirmation of sharing operation acceptance while the actual sharing implementation continues through asynchronous queue processing.

The method 1800 implements a sharing wizard process that handles document sharing and unsharing with progress tracking and retry mechanisms to ensure reliable completion of complex sharing operations. The sharing wizard can prevent concurrent sharing operations through progress tracking, can calculate comprehensive sharing plans that include document hierarchies, and can implement queue-based processing that provides retry capabilities for failed sharing operations. The method 1800 can support automatic cleanup procedures that remove stale sharing requests after specified time periods and can provide users with reliable sharing capabilities that handle complex document hierarchies and multiple trusted contacts through a streamlined wizard interface.

Although steps of the method 1800 are discussed and illustrated in a particular order, the method 1800 of FIG. 18 is not so limited. In other embodiments, all or a subset of one or more of steps of the method 1800 can be performed in a different order. In these and other embodiments, all or a subset of any of steps of the method 1800 can be performed before, during, and after all or a subset of any of the other steps of the method 1800. Furthermore, a person skilled in the art will readily recognize that the method 1800 can be altered and still remain within these and other embodiments of the present technology. For example, all or a subset of one or more steps of the method 1800 can be omitted and repeated in some embodiments.

Referring to FIG. 19, a diagram 1900 illustrates a plan history snapshot system that captures document content at specific points in time for version tracking within the secure data storage system. The diagram 1900 can implement a history tracking mechanism that maintains records of document modifications and enables efficient retrieval of repository states at any given point in time through database filtering operations.

The diagram 1900 functions as a visual representation of how the secure data storage system maintains comprehensive version history for documents within repositories while enabling efficient snapshot retrieval capabilities. The diagram 1900 can display the timeline of multiple documents (Document 1, Document 2, and Document 3) and a sequence of operations for each document including create and update actions of the content in the documents. The diagram 1900 can demonstrate how document modifications are tracked over time and how snapshots can capture the state of multiple documents at specific temporal points. The diagram 1900 can illustrate the temporal relationship between document operations and snapshot boundaries, showing how the system can reconstruct repository states from historical modification records.

The snapshot 1902 can be configured as a temporal boundary that captures the state of documents at a specific point in time within the repository history tracking system. The snapshot 1902 captured at the timepoint 1904 can include the previous operations of each document. For example, the snapshot includes an update operation of Document 1, a create operation of Document 2, and an update operation of Document 3. The snapshot 1902 can demonstrate how the system can capture the state of multiple documents simultaneously, providing a consistent view of repository content at the specified temporal point. The snapshot 1902 can enable users to retrieve and examine repository states as they existed at specific points in time, supporting version control operations and historical analysis of document changes.

The system can maintain history items for each document modification that occur within repositories, where each history item contains data such as timestamp, author information, and document content immediately after modification. The history tracking mechanism can store comprehensive records of all document changes including create operations, update operations, and content modifications that affect repository state over time. The system can implement efficient database queries that filter history items by comparing them with selected time points, enabling rapid retrieval of repository snapshots without requiring complex reconstruction operations. The history item storage approach can simplify the process of fetching repository snapshots at any given point in time by maintaining pre-computed content states rather than requiring real-time reconstruction from change logs.

The plan history snapshot system can enable users to retrieve repository states as they existed at specific points in time by filtering history items based on temporal criteria and presenting the results as comprehensive snapshots. The system can support temporal queries where users can specify desired time points and can receive complete repository snapshots that show the state of all documents as they existed at those specific times. The snapshot retrieval mechanism can provide efficient access to historical repository states without requiring complex version reconstruction algorithms, since document content is stored directly within historical items at the time of each modification. The plan history snapshot system can support version control operations, audit trails, and historical analysis by providing reliable access to repository states across the complete timeline of document modifications and collaborative activities.

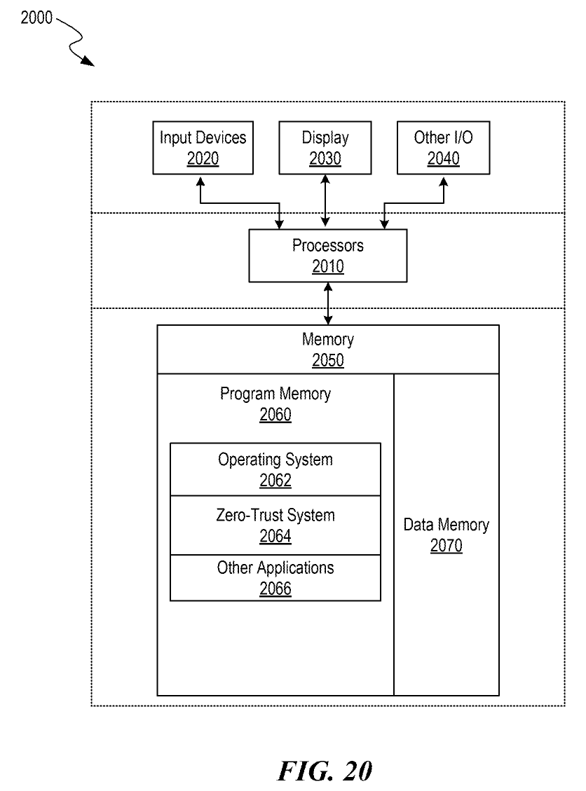

FIG. 20 is a block diagram illustrating an overview of devices on which some implementations of the disclosed technology can operate. The devices can comprise hardware components of a device 2000. Device 2000 can include one or more input devices 2020 that provide input to the processor(s) 2010 (e.g., CPU(s), GPU(s), HPU(s), etc.), notifying it of actions. The actions can be mediated by a hardware controller that interprets the signals received from the input device and communicates the information to the processors 2010 using a communication protocol. Input devices 2020 include, for example, a mouse, a keyboard, a touchscreen, an infrared sensor, a touchpad, a wearable input device, a camera- or image-based input device, a microphone, or other user input devices.

Processors 2010 can be a single processing unit or multiple processing units in a device or distributed across multiple devices. Processors 2010 can be coupled to other hardware devices, for example, with the use of a bus, such as a PCI bus or SCSI bus. The processors 2010 can communicate with a hardware controller for devices, such as for a display 2030. Display 2030 can be used to display text and graphics. In some implementations, display 2030 provides graphical and textual visual feedback to a user. In some implementations, display 2030 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 2040 can also be coupled to the processor, such as a network card, video card, audio card, USB, firewire or other external device, camera, printer, speakers, CD-ROM drive, DVD drive, disk drive, or Blu-Ray device.

In some implementations, the device 2000 also includes a communication device capable of communicating wirelessly or wire-based with a network node. The communication device can communicate with another device or a server through a network using, for example, TCP/IP protocols. Device 2000 can utilize the communication device to distribute operations across multiple network devices, such as the network devices of FIGS. 1-19.

The processors 2010 can have access to a memory 2050 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 2050 can include program memory 2060 that stores programs and software, such as an operating system 2062, data security system 2064, and other application programs 2066. Memory 2050 can also include data memory 2070 storing decrypted data, encrypted data, keys, authorized user information, or the like.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, or the like.

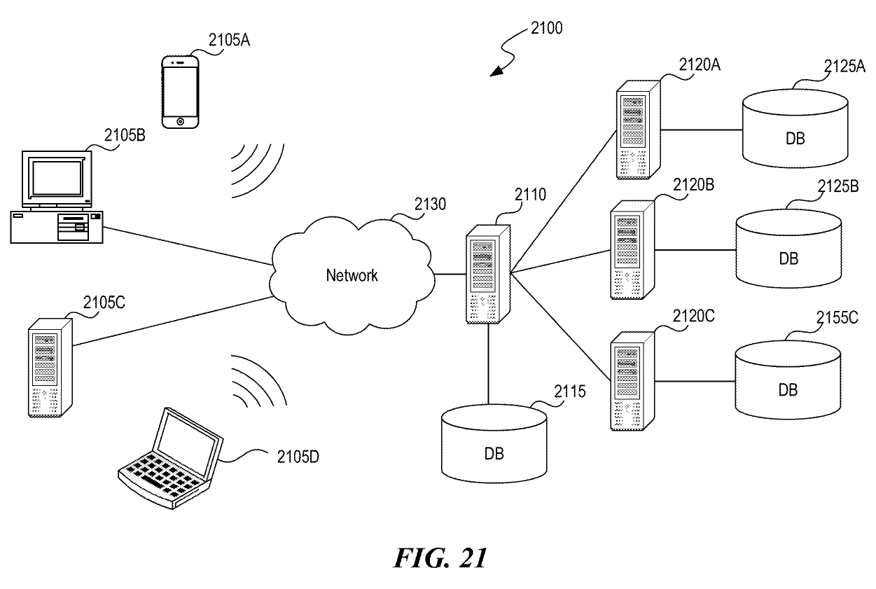

FIG. 21 is a block diagram illustrating an overview of an environment 2100 in which some implementations of the disclosed technology can operate. Environment 2100 can include one or more client computing devices 2105A-D, examples of which can include device 2000. Client computing devices 2105 can operate in a networked environment using logical connections through network 2130 to one or more remote computers, such as a server computing device 2110.

In some implementations, server 2110 can be an edge server which receives client requests and coordinates fulfillment of those requests through other servers, such as servers 2120A-C. Server computing devices 2110 and 2120 can comprise computing systems, such as device 2000. Though each server computing device 2110 and 2120 is displayed logically as a single server, server computing devices can each be a distributed computing environment encompassing multiple computing devices located at the same or at geographically disparate physical locations. In some implementations, each server 2120 corresponds to a group of servers.

Client computing devices 2105 and server computing devices 2110 and 2120 can each act as a server or client to other server/client devices. Server 2110 can connect to a database 2115. Servers 2120A-C can each connect to a corresponding database 2125A-C. As discussed above, each server 2120 can correspond to a group of servers, and each of these servers can share a database or can have their own database. Databases 2115 and/or 2125 can be access repositories and/or a warehouse (e.g., store) information such as keys, encryption/decryption data. Though databases 2115 and 2125 are displayed logically as single units, databases 2115 and 2125 can each be a distributed computing environment encompassing multiple computing devices, can be located within their corresponding server, or can be located at the same or at geographically disparate physical locations.

Network 2130 can be a local area network (LAN) or a wide area network (WAN), but can also be other wired or wireless networks. Network 2130 may be the Internet or some other public or private network. Client computing devices 2105 can be connected to network 2130 through a network interface, such as by wired or wireless communication. While the connections between server 2110 and servers 2120 are shown as separate connections, these connections can be any kind of local, wide area, wired, or wireless network, including network 2130 or a separate public or private network.

A user can use a computing device 2105 to update stored data using version control and can select authorized individuals who can access the data before and/or after a trigger event (e.g., death of the user). The data can include login data (e.g., login information for social media accounts), account information (bank accounts), estate planning documents (e.g., will, trust documents, etc.), insurance documents, title documents, power of attorney documents, living wills, asset lists, end-of-life documents, instructions for digital assets, durable financial power of attorney document, etc. The user can select authorization levels, data accessible to groups of authorized individuals using computing devices 2105, trigger events, automated notification settings, etc. For example, a user can authorize designed beneficiaries to access, via the network 2130, relevant documents stored in databases 2115 and 2125. The user can select groups of authorized individuals, data accessible to respective groups, authorization protocols, privacy settings, or the like. Authorized individuals (e.g., family members, beneficiaries, lawyers, doctors, etc.) can access data to, for example, manage healthcare, distribution of assets, manage trusts, manage or close accounts (e.g., social media accounts, bank account, retirement accounts), or the like.

The environment 2100 can implement automated estate administration workflows that activate upon detection of trigger events such as an end of life event, death of a user, etc. The system can automatically notify designated executors through the network 2130, providing them with updated access privileges to relevant estate planning documents and asset information stored in databases 2115 and 2125. The automated notification system can send communications to executors via client computing devices 2105, informing them of their responsibilities and providing access to necessary legal documents, asset inventories, and beneficiary contact information required for estate administration.

The system can automatically update executor privileges within the secure data storage environment, granting access to previously restricted estate planning documents, financial account information, and digital asset inventories based on predefined authorization protocols established by the deceased user. The privilege escalation mechanism can enable executors to access wills, trust documents, insurance policies, and asset distribution instructions through their client computing devices 2105 connected to the network 2130. The system can simultaneously notify designated beneficiaries about the commencement of estate administration processes, providing them with relevant information about their inheritances and the expected timeline for asset distribution.

The environment 2100 can address technical challenges in estate planning implementation by automating compliance with trusts, intestacy laws, and creditor notification requirements. The system can implement automated workflows that ensure proper legal procedures are followed, including mandatory waiting periods for creditor claims and statutory notification requirements for beneficiaries and interested parties. The servers 2120A-C can coordinate with legal databases and government systems to verify compliance with applicable state and federal estate administration laws, automatically generating required legal notices and maintaining audit trails of all estate administration activities.

The system can implement automated digital account management protocols that activate upon user death, including automatic logging into social media accounts, financial platforms, and subscription services using stored credentials from databases 2115 and 2125. The automated account management system can execute predefined instructions for account closure, data preservation, or transfer to designated beneficiaries based on the deceased user's preferences. The system can automatically cancel credit cards, subscription services, and recurring payments while preserving access to accounts that contain valuable digital assets or sentimental content for beneficiaries.

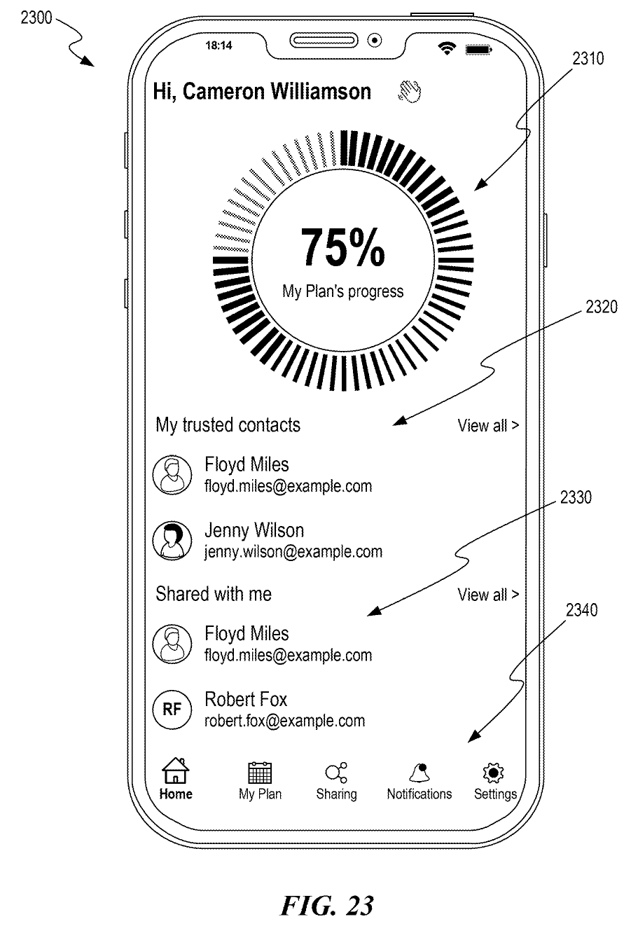

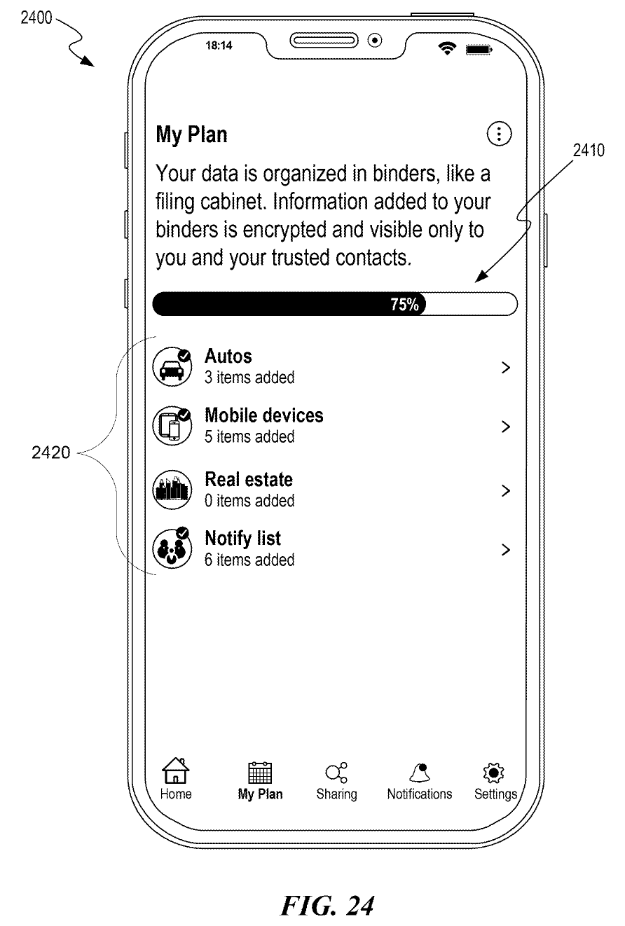

The environment 2100 can manage post-mortem estate distributions by, for example, provid real-time progress tracking for estate administration activities through visual indicators displayed on client computing devices 2105. The progress tracking system can display progress indicators (e.g., as illustrated in FIGS. 23-24) that show completion status for various estate administration tasks including asset valuation, creditor notification periods, tax filing requirements, and beneficiary distributions. The real-time tracking mechanism can enable executors and beneficiaries to monitor the status of estate administration processes and receive updates about completed milestones and pending activities.

The system can implement dynamic asset linking capabilities that automatically update estate information (e.g., estate planning information, post-mortem estate management, etc.) when connected assets change in value or ownership status. The asset linking mechanism can connect estate plans to real estate records, financial accounts, investment portfolios, and personal property inventories, automatically updating asset valuations and ownership information in real-time. The automated asset tracking system can maintain current records of estate values for tax purposes and can alert executors to significant changes in asset values that may affect distribution calculations or tax obligations.

The environment 2100 can maintain comprehensive post-death activity logs that track all estate administration actions, asset distributions, and beneficiary communications through the network 2130. The activity logging system can record executor actions, beneficiary acknowledgments, asset transfers, and legal compliance activities, creating permanent audit trails stored in databases 2115 and 2125. The post-death tracking mechanism can generate reports for probate courts, tax authorities, and beneficiaries, documenting the complete estate administration process and ensuring transparency in asset distribution activities.

The environment 2100 can support zero-trust estate planning methods through the implementation of public key generation and repository management systems. The servers 2110 and 2120A-C can generate public keys for zero-trust digital repositories that are configured to be unlocked by the public key only, where the zero-trust computer system allows an owner of the zero-trust digital repository to link the repository to one or more authorized users through network connections via network 2130. The databases 2115 and 2125A-C can store one or more encrypted data objects of the owner for estate planning in the zero-trust digital repository, where the repository prevents non-authorized user access to the encrypted data objects through cryptographic access controls implemented across the distributed computing environment.

The client computing devices 2105A-D can receive public keys from at least one authorized user of the one or more authorized users, enabling the system to authorize access to encrypted data objects stored in databases 2115 and 2125A-C based on public key verification. The environment 2100 can display estate planning menus through client computing devices 2105A-D for receiving data objects from the owner for identifying assets for estate planning, where the user interfaces can present categorized asset types and input fields for estate documentation.

The zero-trust digital repositories implemented across servers 2110 and 2120A-C can include sets of digital binders, where each binder includes at least one encrypted data object for one or more types of assets of the owner and can be linked to authorized users such that the linked authorized users can access asset information through their client computing devices 2105A-D connected via network 2130. The system can cause display of types of assets through client computing devices 2105A-D, and in response to the owner selecting one of the types of assets, can display fields of information for receiving input from the owner for an asset, where the asset information becomes accessible to authorized users upon submission of the public key.

The environment 2100 can cause images of public and/or private keys to be stored in image galleries on electronic devices of the owner, where the public and/or private keys may be implemented as two-dimensional barcodes for convenient access and sharing. The zero-trust digital repositories can include pluralities of individually linkable digital binders each configured to store owner-managed asset information for types of assets including, without limitation, personal property (e.g., vehicles, watercraft, automobiles, jewelry, artwork, etc.), electronic devices, financial assets (e.g., bank accounts, retirement funds), digital assets (e.g., crypto, digital wallets, etc.), intellectual property (e.g., patents, trade secrets, etc.), and/or real estate (e.g., land, houses, rental properties, etc.). A user can generate any number of digital binders to sort, categorize, and store information for groups of assets. The repositories can include digital binders configured to store notify lists of individuals to be notified upon death of the owner, where the automated notification systems can access these lists through network 2130 to execute post-death communication protocols.

The zero-trust digital repositories stored by databases 2115 and 2125A-C can be configured to prevent any administrator with administrator privileges to the databases from accessing the encrypted data objects, implementing true zero-trust principles where even system administrators cannot compromise data privacy. The repositories can be configured to provide responses to key replacement requests from the owner through secure communication channels established via network 2130 between client computing devices 2105A-D and servers 2110 and 2120A-C.

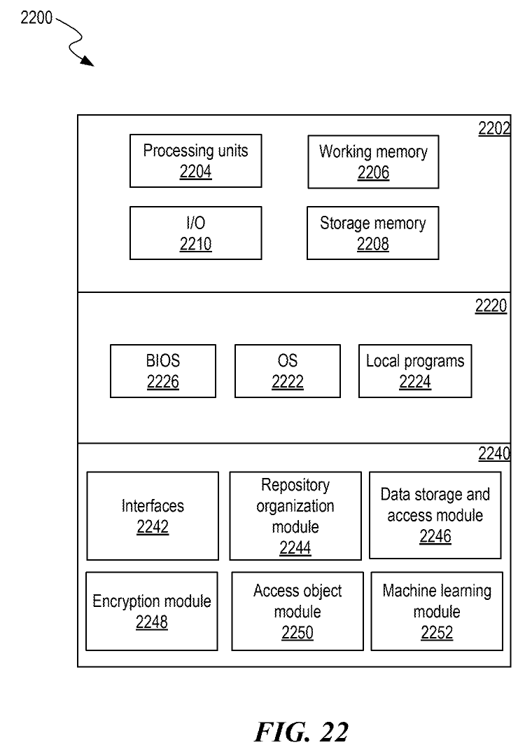

FIG. 22 is a block diagram illustrating components 2200 which, in some implementations, can be used in a system employing the disclosed technology. The components 2200 include hardware 2202, general software 2220, and specialized components 2240. As discussed above, a system implementing the disclosed technology can use various hardware including processing units 2204 (e.g. CPUs, GPUs, APUs, etc.), working memory 2206, storage memory 2208 (local storage or as an interface to remote storage, such as storage 2115 or 2125), and input and output devices 2210. In various implementations, storage memory 2208 can be one or more of: local devices, interfaces to remote storage devices, or combinations thereof. For example, storage memory 2208 can be a set of one or more hard drives (e.g., a redundant array of independent disks (RAID)) accessible through a system bus or can be a cloud storage provider or other network storage accessible via one or more communications networks (e.g. a network accessible storage (NAS) device, such as storage 2115 or storage provided through another server 2120). Components 2000 of FIG. 20 can be implemented in a client computing device such as client computing devices 2105 of FIG. 21 or on a server computing device, such as server computing device 2110 or 2120 of FIG. 21.

General software 2220 can include various applications including an operating system 2222, local programs 2224, and a basic input output system (BIOS) 2226. Specialized components 2240 can be subcomponents of a general software application 2220, such as local programs 2224. Specialized components 2240 can include repository organization module 2244, data storage and access module 2246, encryption module 2248, access object module 2250, machine learning module 2252, and components which can be used for providing user interfaces, transferring data, and controlling the specialized components, such as interfaces 2242. In some implementations, components 2200 can be in a computing system that is distributed across multiple computing devices or can be an interface to a server-based application executing one or more of specialized components 2240. Although depicted as separate components, specialized components 2240 may be logical or other nonphysical differentiations of functions and/or may be submodules or code-blocks of one or more applications.

In some implementations, the repository organization module 2244 is configured to organize content within repositories. A repository is an individual collection of versioned data, which can include but is not limited to text files, binary files, and directories. Users have the flexibility to create a repository and manage it locally on their device, or they can establish it on a remote server. Once created on a remote server, the repository can be cloned, modified, and updated by authorized users.

In some implementations, the data storage and access module 2246 is configured to encrypt files or objects stored on a remote server, ensuring that sensitive private data is secured against unauthorized access. The local versions of these files or objects, in contrast, remain decrypted for the user's convenience and usability. This dual-state approach—encrypted remotely and decrypted locally—enables users to work with their data seamlessly while maintaining a high level of security for stored data.

In some implementations, the encryption module 2248 is configured to deploy an encryption strategy to safeguard data objects within repositories. This strategy emphasizes the confidentiality and security of data, enabling controlled access within a sophisticated version control framework. The encryption methodology is meticulously applied to various object types in a repository, specifically blobs, trees, commits, and tags. A particular focus is placed on blobs, trees, and commits, each encrypted with a distinct symmetric encryption key.

In some implementations, the access object module 2250 is configured to store information in what are termed as "data objects." These objects can be anything from a simple text file (a "blob") to a directory structure (a "tree") that organizes other blobs and trees. To protect the confidentiality of these data objects, each one is encrypted using a process called symmetric encryption. This process uses a single key to both encrypt (lock) and decrypt (unlock) the data. Each data object receives its own unique encryption key, ensuring that even if one key is compromised, the other objects remain secure.

In some implementations, the machine learning module 2252 is configured to perform the methods and systems described herein. User interfaces, graphical user interfaces, and/or dashboards can be used to perform steps or processes discussed in connection with FIGS. 1-22.

FIG. 23 illustrates a user interface 2300 for an estate planning dashboard within a secure data storage system. The user interface 2300 displays a progress indicator 2310 (e.g., 75%) that shows completion status of the estate planning process, providing users with a visual representation of how much of their estate documentation and asset organization has been completed. The progress indicator 2310 may also display completion status for post-mortem estate administration tasks that need to be completed by designated beneficiaries, executors, or trustees, such as asset valuation confirmations, beneficiary acknowledgments, and/or legal document submissions required for probate proceedings. In some embodiments, the progress indicator can track the completion of executor responsibilities including creditor notifications, tax filing requirements, and asset distribution activities, providing real-time visibility into the estate settlement process for all authorized parties involved in estate administration.

The user interface 2300 includes a trusted contacts section 2320 that may display designated beneficiaries, executors, and other authorized individuals (e.g., Floyd Miles and Jenny Wilson) with their contact information. These trusted contacts may include family members who will inherit assets, legal representatives who will execute the estate plan, or financial advisors who will manage trust distributions. The user interface 2300 also features a "Shared with me" section 2330 showing estate plans or documents that other users have shared, which may include joint assets, family trust documents, or collaborative estate planning materials. The navigation bar 2340 at the bottom provides access to different estate planning functions including "Home" for the main dashboard, "My Plan" for organizing wills and trust documents, "Sharing" for managing beneficiary access to estate information, "Notifications" for updates on asset status or legal requirements, and "Settings" for configuring estate plan parameters and court filing requirements. The user interface 2300 can display graphical user interfaces for estate management and/or distribution with progress indicators. The progress indicators can show completion of, for example, status of asset distribution (e.g., individual assets, group of assets, entire estate), etc. The sharing button can be used to select users (e.g., users discussed in connection with FIG. 1, user devices (e.g., user devices discussed in connection with FIGS. 14 and 15), etc.

FIG. 24 illustrates a user interface 2400 for organizing estate planning documents and assets within a secure data storage system. The user interface 2400 displays explanatory text describing how estate planning data is organized in secure digital binders that function like a filing cabinet for sensitive legal documents. The progress bar 2410 (e.g., showing 75% completion) may indicate the digital binder status of estate plan preparation, including completion of wills, trust documents, asset inventories, and beneficiary designations. The progress bar 2410 may also track post-mortem administrative tasks that authorized users such as executors, beneficiaries, or estate administrators need to complete following the owner's death. These tasks may include canceling credit cards and closing financial accounts, notifying the Social Security Administration of the death, contacting power utility companies to transfer or terminate service, reaching out to internet and telecommunications providers to cancel subscriptions, filing claims with life insurance companies, and managing other essential account closures and notifications. The progress indicator 2410 can provide a visual representation of completed versus remaining administrative responsibilities, helping executors systematically work through the complex process of settling an estate while ensuring that no critical tasks are overlooked during the estate administration period. In some embodiments, each task (or a user selected group) has a separate progress bar.

The user interface 2400 presents categorized sections 2420 for different types of estate assets and documents. The "Autos" category may contain vehicle titles, registration documents, and instructions for transferring automotive assets to designated beneficiaries. The "Mobile devices" category may include digital asset inventories, social media account information, and instructions for managing or closing online accounts upon death. The "Real estate" category may include property holdings that may require documentation of deeds, mortgage information, and specific bequests to heirs or charitable organizations. The "Notify list" category may include contact information for individuals and institutions that need to be notified upon death, including banks, insurance companies, employers, and government agencies. Each category may link to relevant legal documents such as wills or trust agreements and can automatically update asset valuations and ownership information.

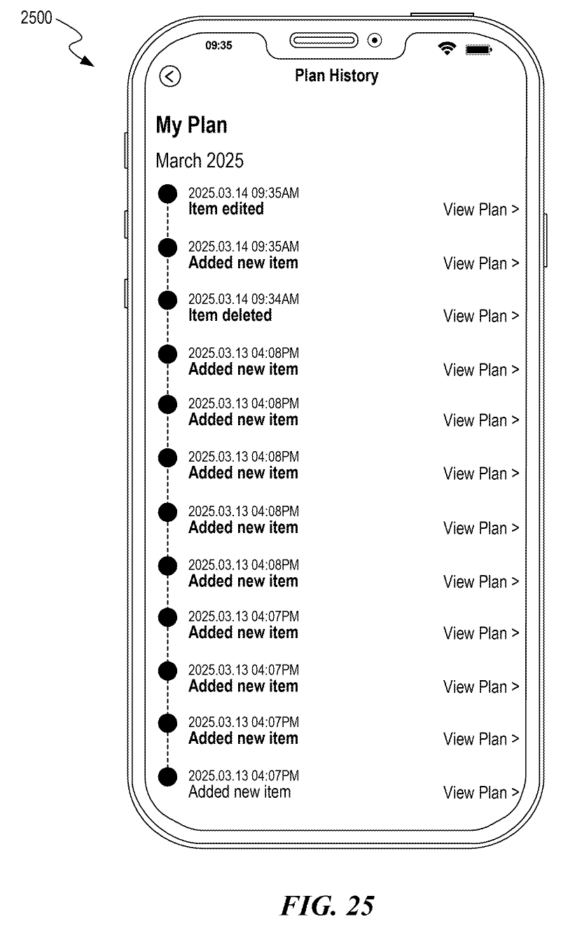

FIG. 25 illustrates a user interface 2500 for tracking the history of estate plan modifications within a secure data storage system. The user interface 2500 displays a plan history, providing estate plan owners and authorized representatives with a chronological record of all changes (e.g., edited, added, and deleted items) made to estate planning documents and asset information. For example, the timeline view shows entries with specific dates and actions such as "Item edited," "Added new item," and "Item deleted," which may represent modifications to wills, updates to beneficiary designations, changes in asset valuations, or revisions to executor instructions. Each historical entry includes a "View Plan >" link that may allow users to access the specific version of estate documents as they existed at that point in time, which can be valuable for legal proceedings, probate court requirements, or resolving disputes among beneficiaries. The user interface 2500 may track changes to trust provisions, updates to charitable bequests, modifications to guardian appointments for minor children, or adjustments to asset distribution percentages. The version control system may maintain records of who made each change and when, providing an audit trail that may be required by probate courts or estate attorneys. The timeline visualization may help executors and beneficiaries understand the evolution of the estate plan and ensure that the most current version of documents reflects the deceased's final intentions.

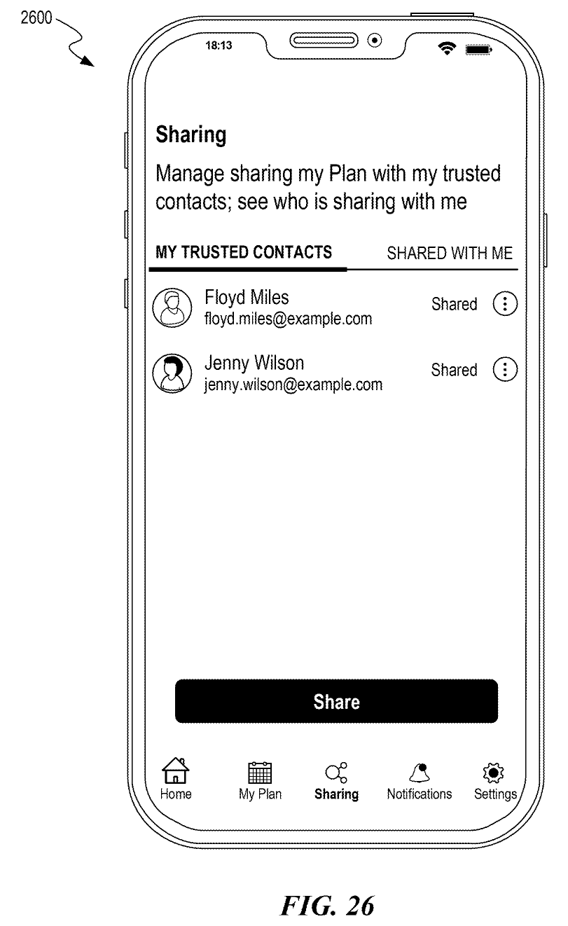

FIG. 26 illustrates a user interface 2600 for managing estate plan sharing and beneficiary access within a secure data storage system. The user interface 2600 displays explanatory text about managing access to estate planning documents with trusted contacts and viewing shared estate information. The interface may facilitate collaboration between estate plan owners, beneficiaries, executors, and legal representatives. The interface can display trusted contacts which may include individuals that have been approved and/or granted access to specific estate documents, asset information, or inheritance details based on their roles as beneficiaries, executors, or trustees. The sharing functionality may allow estate plan owners to grant different levels of access to various parties, such as providing executors with full access to all documents while limiting beneficiaries to information about their specific inheritances. The interface may enable users to invite additional trusted contacts such as attorneys, financial advisors, or family members who need access to estate planning information. The sharing system may implement role-based permissions that automatically adjust access rights based on trigger events such as incapacitation or death, ensuring that executors can access necessary documents for probate proceedings while maintaining privacy during the estate owner's lifetime. The interface may also track sharing status and notify users when documents have been accessed by authorized parties.

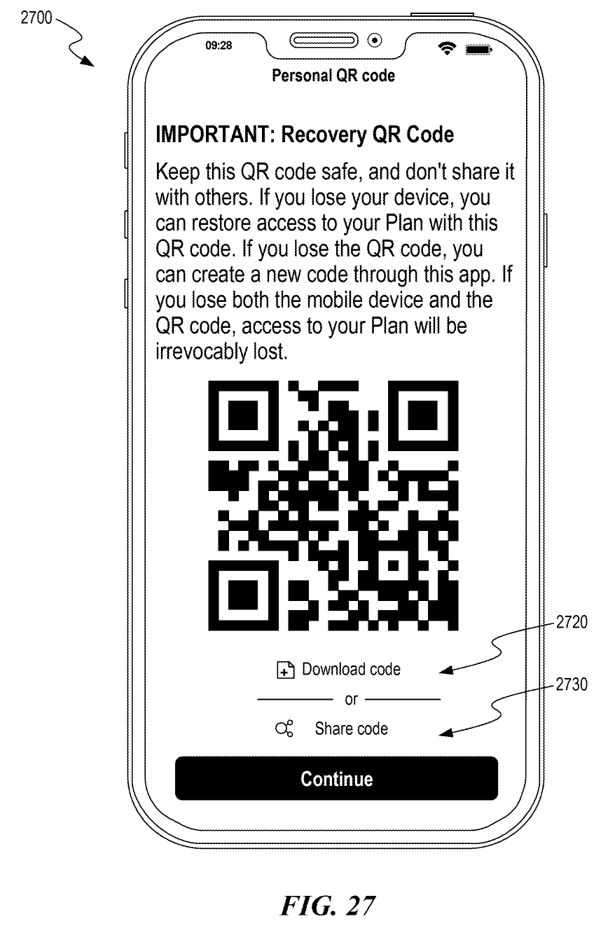

FIG. 27 illustrates a user interface 2700 for displaying a recovery code (e.g., QR code) that serves as a backup access mechanism for estate planning documents within a secure data storage system. The user interface 2700 instructional text explaining the importance of safeguarding the recovery code and warns users about the consequences of losing both their mobile device and the recovery code, which may result in permanent loss of access to estate planning documents, asset information, and beneficiary instructions. The recovery code may serve as a secure backup method that executors, trustees, or designated family members can use to access estate documents if the primary account holder becomes incapacitated or deceased and their devices are unavailable. Example recovery codes, recovery actions, token platforms, and related technologies are disclosed in U.S. Provisional Application No. 63/779,826, which is incorporated by reference in its entirety.

The user can print, download using download link 2720, and/or share the recovery code using a share link 2730. This capability may allow estate plan owners to provide secure access methods to trusted individuals such as executors or attorneys who may need to access estate documents during probate proceedings or emergency situations. The recovery mechanism may be particularly valuable for estate planning scenarios where immediate access to wills, trust documents, asset inventories, or beneficiary contact information is required for legal proceedings or asset distribution. The recovery code system may implement additional security measures such as multi-factor authentication or time-limited access to ensure that estate documents remain protected while providing necessary access during legitimate estate administration activities. Those skilled in the art will appreciate that the components, features, methods, and technology illustrated in FIGS. 20-22 described above, and in each of the flow diagrams, interfaces, and systems, may be altered in a variety of ways. For example, the order of the logic may be rearranged, substeps may be performed in parallel, illustrated logic may be omitted, other logic may be included, etc. In some implementations, one or more of the components described above can execute one or more of the processes described below. User interfaces can include inputs (e.g., buttons, links, etc.) for inputting information, downloading, sharing, select permission, etc.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., "non-transitory" media) and computer-readable transmission media.

Reference in this specification to "implementations" (e.g. "some implementations," "various implementations," “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase "selecting a fast connection" can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

What is claimed is:

1. A zero-trust estate planning method comprising:
generating, via a zero-trust computer system, a public key for a zero-trust digital repository configured to be unlocked by the public key only, wherein the zero-trust computer system is configured to allow an owner of the zero-trust digital repository to link the zero-trust digital repository to one or more authorized users;
storing one or more encrypted data objects of the owner for estate planning in the zero-trust digital repository, wherein the zero-trust digital repository prevents non-authorized user access to the one or more encrypted data objects;
receiving the public key from at least one authorized user of the one or more authorized users; and
authorizing, based on the public key, the at least one authorized user to access the one or more encrypted data objects from the owner stored by the zero-trust digital repository.

2. The method of claim 1, further comprising displaying an estate planning menu for receiving data objects from the owner for identifying an asset for estate planning.

3. The method of claim 1, wherein the zero-trust digital repository includes a set of digital binders, wherein each binder includes at least one encrypted data object for one or more types of assets of the owner and linkable to the one or more authorized users such that the linked one or more authorized users can access asset information, wherein the one or more encrypted data objects include asset information.

4. The method of claim 1, further comprising
causing display of types of assets;
in response to the owner selecting one of the types of assets, displaying fields of information for receiving input from the owner for an asset; and
linking the asset to the one or more authorized users, wherein the information is accessible to the one or more authorized users upon submission of the public key by the one or more authorized users.

5. The method of claim 1, further comprising causing an image of a private key to be stored in an image gallery on an electronic device of the owner.

6. The method of claim 5, wherein the private key is a two-dimensional barcode.

7. The method of claim 1, wherein the zero-trust digital repository includes a plurality of individually linkable digital binders each configured to store owner-managed asset information for a type of asset.

8. The method of claim 7, wherein the type of asset includes one of automobiles, electronic devices, and real estate assets.

9. The method of claim 1, wherein the zero-trust digital repository includes a digital binder configured to store a notify list of individuals to be notified upon a death of the owner.

10. The method of claim 1, wherein the zero-trust digital repository is stored by a database, wherein the zero-trust digital repository is configured to prevent any administrator with administer privileges to the database from accessing the one or more encrypted data objects.

11. The method of claim 1, wherein the zero-trust digital repository is configured to provide a response to a key replacement request from the owner.

12. A system comprising:
one or more processors; and
one or more memories storing instructions that, when executed by the one or more processors, cause the system to perform a process for zero-trust estate planning, the process comprising:
generating, via a zero-trust computer system, a public key for a zero-trust digital repository configured to be unlocked by the public key only, wherein the zero-trust computer system is configured to allow an owner of the zero-trust digital repository to link the zero-trust digital repository to one or more authorized users;
storing one or more encrypted data objects of the owner for estate planning in the zero-trust digital repository, wherein the zero-trust digital repository prevents non-authorized user access to the one or more encrypted data objects;
receiving the public key from at least one authorized user of the one or more authorized users; and
authorizing, based on the public key, the at least one authorized user to access the one or more encrypted data objects from the owner stored by the zero-trust digital repository.

13. The system of claim 12, wherein the process further comprises:
displaying an estate planning menu for receiving data objects from the owner for identifying an asset for estate planning.

14. The system of claim 12, wherein the zero-trust digital repository includes a set of digital binders, wherein each binder includes at least one encrypted data object for one or more types of assets of the owner and linkable to the one or more authorized users such that the linked one or more authorized users can access asset information, wherein the one or more encrypted data objects include asset information.

15. The system of claim 12, wherein the process further comprises:
causing display of types of assets;
in response to the owner selecting one of the types of assets, displaying fields of information for receiving input from the owner for an asset; and
linking the asset to the one or more authorized users, wherein the information is accessible to the one or more authorized users upon submission of the public key by the one or more authorized users.

16. The system of claim 12, wherein the process further comprises:
causing an image of a private key to be stored in an image gallery on an electronic device of the owner,
wherein the private key is a two-dimensional barcode,
wherein the zero-trust digital repository includes a plurality of individually linkable digital binders each configured to store owner-managed asset information for a type of asset,
wherein the type of asset includes one of automobiles, electronic devices, and real estate assets,
wherein the zero-trust digital repository is stored by a database, wherein the zero-trust digital repository is configured to prevent any administrator with administer privileges to the database from accessing the one or more encrypted data objects, and
wherein the zero-trust digital repository is configured to provide a response to a key replacement request from the owner.

17. A non-transitory computer-readable medium storing instructions that, when executed by a computing system, cause the computing system to perform operations for zero-trust estate planning, the operations comprising:
generating, via a zero-trust computer system, a zero-trust digital repository encrypted with a public key and configured to be unlocked by a private key only, wherein the zero-trust computer system is configured to allow an owner of the zero-trust digital repository to link the zero-trust digital repository to one or more authorized users;
storing one or more encrypted data objects of the owner for estate planning in the zero-trust digital repository, wherein the zero-trust digital repository prevents non-authorized user access to the one or more encrypted data objects;
receiving the public key from at least one authorized user of the one or more authorized users; and
authorizing, based on the public key, the at least one authorized user to access the one or more encrypted data objects from the owner stored by the zero-trust digital repository.

18. The non-transitory computer-readable medium of claim 17, wherein the operations further comprise:
displaying an estate planning menu for receiving data objects from the owner for identifying an asset for estate planning, wherein the zero-trust digital repository includes a set of digital binders, wherein each binder includes at least one encrypted data object for one or more types of assets of the owner and linkable to the one or more authorized users such that the linked one or more authorized users can access asset information, wherein the one or more encrypted data objects include asset information.

19. The non-transitory computer-readable medium of claim 17, wherein the operations further comprise:
causing display of types of assets;
in response to the owner selecting one of the types of assets, displaying fields of information for receiving input from the owner for an asset; and
linking the asset to the one or more authorized users, wherein the information is accessible to the one or more authorized users upon submission of the public key by the one or more authorized users.

20. The non-transitory computer-readable medium of claim 17, wherein the operations further comprise:
causing an image of the private key to be stored in an image gallery on an electronic device of the owner,
wherein the private key is a two-dimensional barcode,
wherein the zero-trust digital repository includes a plurality of individually linkable digital binders each configured to store owner-managed asset information for a type of asset,
wherein the type of asset includes one of personal property assets, electronic devices, and real property assets,
wherein the zero-trust digital repository is stored by a database, wherein the zero-trust digital repository is configured to prevent any administrator with administer privileges to the database from accessing the one or more encrypted data objects, and
wherein the zero-trust digital repository is configured to provide a response to a key replacement request from the owner.

21. The method of claim 1, further comprising:
associating the one or more encrypted data objects with a dedicated access control object that stores a symmetric encryption key and access permissions, wherein the one or more encrypted data objects include blobs and trees, wherein each of the one or more encrypted data objects is encrypted with a unique encryption key; and
linking entries within tree objects to corresponding access control objects through hash pointers, wherein the linking enables fine-grain access control to the one or more encrypted data objects.

22. The method of claim 21, further comprising:
generating a unique access control object for each of the one or more encrypted data objects when stored, wherein each access control object includes a list of users authorized to access a data object and the symmetric encryption key of the data object, encrypted individually for each user using their asymmetric encryption keys.

23. The method of claim 22, further comprising:
storing a hash pointer to the unique access control object of each data object in an above level in a storage directory hierarchy.

24. A system comprising:
one or more processors; and
a memory storing instructions that, when executed by the one or more processors, cause the system to perform a process for implementing fine-grain access control within a secure version control environment, the process comprising
encrypting and storing one or more data objects within a repository;
creating and managing access control objects that specify access permissions for each encrypted data object of the one or more data objects; and
associating tree objects with access control objects via hash pointers to enable dynamic and granular access control.

25. The system of claim 24, wherein managing access permissions includes:
encrypting a symmetric key within an access control object of the access control objects using a public key of an authorized user, enabling only users to decrypt the symmetric key with a private key; and
dynamically updating access permissions by modifying a list of authorized users within the access control object.

26. A computer-implemented method for sharing encrypted data objects in a version control system with fine-grain access control, comprising:
encrypting data objects to create blobs and trees, wherein each of the blobs and trees is encrypted with a unique symmetric encryption key;
generating access control objects for each encrypted data object, wherein each access control object stores the unique symmetric encryption key encrypted for each authorized user; and
using tree objects to organize a data structure of a repository, where each entry in a tree object links to an access control object through a hash pointer, enabling control of access permissions at a level of individual data objects.

27. The method of claim 26, further comprising:
altering the access permissions by updating one or more access control objects associated with one or more encrypted data objects, enabling or revoking user access without altering the one or more encrypted data objects.

28. A method comprising:
encrypting one or more data objects within a repository using symmetric encryption with unique encryption keys for each data object of the one or more data objects;
generating one or more access control objects for the one or more encrypted data objects, wherein each access control object stores a symmetric encryption key encrypted with a public key of an authorized user;
enabling one or more authorized users to access the one or more encrypted data objects by navigating directory structures through tree objects and following hash pointers; and
dynamically updating access permissions within the one or more encrypted data objects by adding or removing encrypted versions of symmetric keys based on public keys of authorized users.

29. The method of claim 28, wherein the one or more data objects comprise blobs and tree objects, wherein the blobs comprise text files or binary files, wherein the tree objects organize repositories hierarchically.

30. The method of claim 28, further comprising:
implementing a dual-state approach where data stored on remote servers is encrypted to secure sensitive private data against unauthorized access, while local versions of the data remain decrypted.

31. The method of claim 28, further comprising managing encryption and decryption processes that occur when the data is transferred between local and remote storage locations.

32. The method of claim 28, wherein enabling the one or more authorized users to access the one or more encrypted data objects comprises:
placing hash pointers to relevant access control objects within the tree objects;
allowing users to navigate through directory structures by following the hash pointers from tree objects to access control objects; and
enabling users to decrypt symmetric keys stored within the one or more access control objects using their private keys.

33. The method of claim 28, wherein dynamically updating the access permissions comprises modifying access control objects without requiring re-encryption of the one or more data objects.
